(19) United States
(12) Patent Application Publication
(10) Pub. No.: US 2026/0061717 A1
(43) Pub. Date: Mar. 5, 2026

(54) Method and Apparatus for Controlling a Mini-Tablet Manufacturing Machine Incorporating Content Uniformity Testing Requirements

(71) Applicant: Merck Sharp & Dohme LLC, Rahway, NJ (US)

(72) Inventor: Brandon GERBERICH, Rahway, NJ (US)

(73) Assignee: Merck Sharp & Dohme LLC, Rahway, NJ (US)

(21) Appl. No.: 19/104,561

(22) PCT Filed: Nov. 17, 2023
(86) PCT No.: PCT/US2023/080271

§ 371 Date: Feb. 18, 2025

Related U.S. Application Data
(60) Provisional application No. 63/426,493, filed on Nov. 18, 2022.
(60) Provisional application No. 63/440,228, filed on Jan. 20, 2023.

(51) Int. Cl. B30B 15/26; B30B 11/00; G05B 19/042

(52) U.S. Cl. CPC B30B 15/26; B30B 11/005; G05B 19/042; G05B 2219/25252

(57) ABSTRACT

The present invention relating to a mini-tablet manufacturing machine, such as a mini-tablet sachet filler or mini-tablet press, includes a computer system and equipment control driver that automatically adjust the current operating parameters of the mini-tablet manufacturing machine. This adjustment ensures that the mini-tablets are produced within a system-generated recommended weight variance, thereby reducing the risk that batches of mini-tablets failing to meet regulatory testing standards. The apparatus and methods of the present invention use Monte Carlo simulations to calculate, for a batch of mini-tablets, the probability of failure for every combination of values for the key variables. It builds a multi-dimensional matrix of values for key variables and stores the matrix in a memory on the computer system.

### FIELD OF THE INVENTION

The present invention relates generally to the fields of manufacturing and testing of mini-tablet pharmaceutical products in accordance with regulatory testing requirements for content uniformity, and more particularly to systems and methods for manufacturing and testing batches of mini-tablets for compliance with the regulatory guidelines.

### RELATED ART

Pediatric formulation development is undergoing a significant transformation due to recent changes in regulatory policies promoting advances in producing and testing age-appropriate medicines for pediatric care. To meet the increased emphasis on producing and testing age-appropriate medicines, pharmaceutical companies, researchers and developers are increasingly trying to develop more flexible dosage forms for children. One particular dosage form allowing for more flexible dosing is mini-tablets. Mini-tablets that have average diameters of less than 2.5 mm are classified as oral granules by the Food and Drug Administration (FDA). As such, multiple mini-tablets may be combined in a single dosage unit, such as a sachet or capsule, to achieve the desired dose in terms of drug weight and drug potency.

To ensure consistent dosages, mini-tablets manufactured and sold in the United States must meet certain content uniformity (CU) testing guidelines set forth by the United States Pharmacopeial Convention. One such guideline is referred to as USP <905, which specifies a test for determining whether a batch of mini-tablets meets certain CU or weight requirements. Under USP <905>, batches of mini-tablets with significant variance in drug content (a function of potency and weight) must be rejected if the batches fail to pass certain tests, the specific rules for which are determined by the dosage form, potency, and drug load of the solid dosage form in question. Mini-tablet unit doses with ≥25% drug load and >25 mg potency are subject to weight variation testing, while mini-tablets with <25% drug load or <25 mg potency are subject to CU testing. When a batch of mini-tablets is rejected under USP <905>, the batch cannot be put into circulation and must be discarded, which can amount to a substantial loss for the manufacturer, in terms of both time and money, especially when the batch is large or when a large number of batches fail the testing. In order to avoid, or at least reduce, such losses, drug manufacturers increasingly need to develop more reliable ways of measuring and controlling the weights and potencies of mini-tablets during manufacturing, and thereby drive down the risk that a particular batch of mini-tablets will fail USP <905> content uniformity testing requirements.

Due to their relatively small sizes, it is sometimes very difficult, if not impossible, to precisely measure and control the weight and potency of individual mini-tablets inside a sachet or capsule containing multiple mini-tablets. Therefore, when multiple mini-tablets are manufactured and put into the same sachet or capsule to form dosage units, there are always going to be slight variances in potency and weight between the dosage units. These unavoidable variances in potency and weight tend to increase the risk that a batch of mini-tablets will fail regulatory content uniformity (CU) testing requirements under USP <905>.

This risk of failure due to small potency and weight variations is compounded by the potential for fill count errors and miscounts while filling small dosage (low fill count) sachets or capsules with multiple mini-tablets. Fill count errors occur when too many or too few mini-tablets are put into a single sachet or capsule. Miscounts can occur, for example, when an equipment sensor fails to detect the fact that two mini-tablets passed into the sachet or capsule, instead of one, resulting in an overfill situation, or when an equipment sensor erroneously determines that two mini-tablet passed into a sachet or capsule, when in reality only one mini-tablet went into the sachet or capsule, resulting in a false positive (i.e., an underfill), situation. Such fill count errors that occur during packaging may lead to large variations in dosage among a batch of sachets or capsules. Every time an individual mini-tablet is inserted into a sachet or capsule, it is an independent opportunity for a fill count error to occur. Unfortunately, fill count errors frequently go undetected by weight-checking equipment because (1) sachet and capsule weight variance can, and often does, exceed the weight of a single mini-tablet, and (2) the weight of a single mini-tablet is frequently less than the weight-checking equipment's lower limit of detection. In low fill count products, a single error results in an average dose deviation equal to the inverse of fill count.

Moreover, the probability of a fill count error occurring on a particular filling machine depends on a host of other factors associated with the machine, such as the brand, maintenance history, setup, and product specifications and limitations. Common causes of fill count errors include suboptimal settings of the mini-tablet dosing mechanism, buildup/blockage of mini-tablets in the feeding chute, poorly tuned sensor sensitivity, and dust accumulation on sensors. Because low-frequency errors are difficult to detect, there is a significant need to understand their impact on drug content uniformity.

Due to these issues, mini-tablet sampling and testing requirements, as well as strategies for reducing the risk of failing the testing requirements, have become very important issues in the pharmaceutical industry, and much research has gone into trying to achieve a clearer understanding and appreciation of dose variation risks, with consideration for the required regulatory testing. However, the key factors that impact the probability of failing USP<905> specification compliance have heretofore been extremely difficult to identify and characterize with any reliability or precision. Indeed, prior to the present invention, assessing and analyzing the risks of CU regulatory testing failures for mini-tablet manufacturing has largely been a matter of guesswork, trial and error.

Failing the USP <905> regulatory testing requirement can cause significant waste time, money and resources, and higher manufacturing costs overall. Accordingly, there is considerable need in the pharmaceutical manufacturing industry for a reliable system and method for reducing the risk that a batch of mini-tablets will fail CU testing requirements under the USP<905> specification.

### SUMMARY

In one embodiment, the present invention addresses the above-described need by providing apparatus and methods for controlling a mini-tablet manufacturing machine, such as a mini-tablet sachet filler or mini-tablet press, wherein the control system will automatically adjust the current operating parameters of the mini-tablet manufacturing machine to reduce the risk that the mini-tablets currently being produced by the machine will fail the requirements of a regulatory testing standard. More particularly, the control system may be configured to automatically set or adjust equipment operating parameters to achieve for a batch of mini-tablets an optimal weight variance, fill count or fill speed for the mini-tablet manufacturing machine based on values associated with minimum risk data generated by program instructions in the controller and stored in a memory device associated with the controller. So, for example, the control system in certain embodiments of the present invention may be configured to set or modify current fill count and filling speed settings for a sachet filler, or configured to set or modify current turret speed, feeder speed, compression dept and compression force settings for a mini-tablet pressing machines. Exemplary architectures for physical and logical components, as well as exemplary data flows for mini-tablet manufacturing control systems configured to carry out these functions in accordance with embodiments of the present invention are described in more below with reference to the figures.

In another embodiment, there is provided a method for determining the probability that a batch of min-tablets will fail CU testing requirements under the USP<905> specification based on a known (measured) weight variance, a known potency variance, a known fill error probability and a given fill count error rate for a batch of mini-tablets.

In yet another embodiment, the present invention provides a process for determining an optimal fill count for a batch of mini-tablets based on a known fill error probability, a known weight variance, a known potency variance, a known fill error probability and a desired probability of failing CU testing under the USP <905> specification.

In still another embodiment, there is provided a method for determining a maximum acceptable weight variance for a batch of mini-tablets to ensure a specified maximum risk of CU testing failure based on a known potency variance and a known fill error probability.

In still another embodiment, the present invention provides a method for predicting the expected acceptance value from an experimentally measured potency variance and an experimentally measured weight variance prior to receiving experimental CU testing results for a batch of mini-tablets based on a known fill error probability and a known fill count.

And in still another embodiment, the present invention provides a method for determining the maximum acceptable fill error probability during a sachet filling process to achieve a desired target CU failure risk based on a known (measured) weight variance, a known potency variance and a known fill count.

Embodiments of the present invention also may be adapted to adjust the operating parameters of mini-tablet manufacturing machines when the expected error rates of drug doses exceed a specified maximum acceptable dose error rate and magnitude.

The systems and methods provided by embodiments of the present invention and described herein may be utilized by researchers, analysts and pharmaceutical companies to reliably determine, control and/or manage the probability that a batch of mini-tablets will fail regulatory testing for content uniformity. As such, implementations and embodiments of the present invention, as described herein, may be considered to be an indispensable tool in drug development, drug testing and drug manufacturing operations.

### BRIEF DESCRIPTION OF THE DRAWINGS

FIG. 1 shows a high-level block diagram illustrating by way of example a computer architecture for a mini-tablet manufacturing control system configured to operate in accordance with an embodiment of the present invention.

FIGS. 2A-2F show exemplary variable data that may be stored in the secondary memory storage area by operation of the console input module in accordance with one embodiment of the present invention.

FIG. 3 shows a high-level flow diagram illustrating, by way of example, the overall flow of program instructions and data in a mini-tablet manufacturing control system configured to operate according to one computer-implemented embodiment of the present invention.

FIG. 4 shows a high-level flow diagram illustrating, by way of example, an algorithm executed by the main program of the controller app 140 in FIG. 1 (or controller app in FIG. 3) in a mini-tablet manufacturing control system configured to operate in accordance with one embodiment of the present invention to control the operation of a tablet press machine.

FIG. 5 shows a high-level flow diagram illustrating, by way of example, an algorithm executed by the 5D matrix generator to build the 5D matrix database in accordance with an embodiment of the present invention to control a tablet press machine.

FIG. 6 shows a high-level flow diagram illustrating, by way of example, an algorithm executed by an equipment parameter setting routine configured to operate in accordance with an embodiment of the present invention to calculate the probability of failing the USP <905> content uniformity testing requirements for every row in the 5D matrix database based on the row's combination of values for fill count, fill count error rate, weight RSD and potency RSD.

FIG. 7 shows a high-level flow diagram illustrating, by way of example, an algorithm executed by the equipment parameter setting subroutine configured to operate in accordance with one embodiment of the present invention to control a tablet press.

FIG. 8 shows a high-level flow diagram illustrating, by way of example, an algorithm executed by the main program of the controller app in FIG. 1 (or controller app in FIG. 3) in a mini-tablet manufacturing control system configured to operate in accordance with one embodiment of the present invention to control the operation of a sachet filling machine.

FIG. 9 shows a high-level flow diagram illustrating, by way of example, an algorithm executed by an equipment parameter setting routine configured to operate in accordance with an embodiment of the present invention to control a mini-tablet sachet filler machine.

FIG. 10 shows a flow diagram illustrating the steps required by the USP <905> specification for CU assessment.

FIG. 11 shows a contour plot illustrating the probability of stage 2 failure as a function of potency RSD, weight RSD and composite RSD.

FIG. 12 shows sixteen visualizations (in the form of contour plots) illustrating the probability of stage 1 and stage 2 content uniformity batch failure and acceptance values for 0% fill error probability represented as a function of modeled bulk mini-tablet weight RSD (vertical axes), bulk mini-tablet potency RSD (horizontal axes), and sachet fill count (rows).

FIG. 13 shows a set of thirty contour plots illustrating the probability of stage 1 and stage 2 content uniformity batch failure and acceptance values (AV) modeled as a function of sachet fill count (horizontal axes), composite RSD of bulk mini-tablets (vertical axes), and fill error probability per mini-tablet filled (rows).

FIG. 14 shows a set of twenty-four contour plots illustrating the probability of stage 1 and stage 2 content uniformity batch failure and acceptance values (AV) modeled as a function of sachet fill count (horizontal axes), fill error probability per mini-tablet filled (vertical axes), and composite RSD (rows).

FIG. 15 shows a plot of the probability of stage 1 or stage 2 CU failure for an example product having 2% composite RSD and 1% fill error probability.

FIG. 16 shows the contour plot (selected from FIG. 12) corresponding to the calculated composite RSD of 7.1% (on the vertical axis) and a fill count of 4 (on the horizontal axis).

FIG. 17 shows a contour plot of failure probabilities in stage 2 as a function of composite RSD and fill count.

FIG. 18 shows another contour plot of failure probabilities in stage 2 as a function of composite RSD and fill count.

FIGS. 19A and 19B show the relevant contour plots selected from FIG. 12 to find a solution for Use Case No. 4.

FIG. 20 shows a contour plot of probability of Stage 2 failure as a function of the log-transformed fill error rate vs. fill count.

FIG. 21 shows a schematic diagram illustrating by way of example an algorithmic generation of sachets containing mini-tablets.

FIG. 22 shows a schematic diagram illustrating by way of example some of the values that may be stored in some of the records of the 5D matrix.

FIG. 23 shows a graph illustrating weight and potency variances for a single simulated mini-tablet plotted with respect weight and potency value

FIGS. 24-27 contain schematic diagrams illustrating the various scenarios and results associated with incurring one, two or three fill count errors in three fill events, wherein the goal (or target) is to fill sachets with three mini-tablets.

FIG. 28 contains a table illustrating, by way of example, the inputs and outputs for an N-dimensional matrix generator according to an embodiment of the invention configured to calculate and use the probabilities of occurrence for a list of specified dose error rates and specified dose error magnitudes.

### DETAILED DESCRIPTION OF EXAMPLE EMBODIMENTS

Reference will now be made in detail to exemplary embodiments of the invention, examples of which are illustrated in the accompanying drawings. Notably, the present invention may be implemented using software, hardware or any combination thereof, as would be apparent to those of skill in the art, and the figures and examples below are not meant to limit the scope of the present invention or its embodiments or equivalents.

### Overview

Embodiments of the present invention provide a computer-implemented apparatus and a computer-implemented method for automatically controlling the operating parameters of a mini-tablet manufacturing machine to increase the probability that mini-tablets made on the machine will pass regulatory content uniformity (CU) testing requirements. Other embodiments provide a research and development tool for mini-tablet manufacturers wanting to better understand the relationships between key manufacturing machine settings and the risk of failing content uniformity testing requirements. To provide these functions and benefits, embodiments of the invention first generate and store in a secondary memory storage area a collection of interrelated data values that together can be used to predict the probability of USP <905> stage 1 and stage 2 batch failure based on measured or observed inputs of weight relative standard deviation (RSD), potency RSD, sachet fill count, and fill error probability (on a per-mini-tablet basis).

Thus, embodiments create a data structure in the secondary memory storage area of the computer system that is suitable for holding a plurality of records, each record comprising at least five fields for storing the predicted probability, weight RSD, potency RSD, sachet fill count and fill error rate. The data structure, which may comprise hundreds, thousands or even millions of records (depending on user-specified ranges and intervals) is referred to in this disclosure as a five-dimensional (‘5D’) matrix due to the fact that each record in the data structure contains at least five fields for storing five key variables associated with the failure risk profile for the batch of mini-tablets currently being manufactured by a machine controller or researched by a scientist or drug developer. A variety of different computer data structures known in the computer field may be used to hold the 5D matrix data, including without limitation, databases, tables, single- and multi-dimensional arrays, cells, dictionaries, linked lists, graphs, queues, binary search trees, hash maps and stacks. The records and data stored in the data structure comprising the 5D matrix may also be represented in a variety of different tangible forms, such as printed or displayed tables, contour plots, heat maps and lists.

As will be explained in greater detail below, some of the data populating the 5D matrix are generated by using a Monte Carlo simulation to calculate the probability of batch failure, according to USP <905> CU specifications, based on a set of measured or observed inputs. These data are useful for: 1) risk quantification in research and development, 2) making a data-driven decision for fill count selection in early product development, 3) determining formulation specifications and control limits for weight and potency variance, and 4) determining maximum acceptable fill error probability for equipment qualification or process control limits. Two sources of variance are included in the generation of the data populating the 5D matrix. The first source is a normally distributed assay of individual mini-tablets due to weight or potency heterogeneity. The second source is a binomially-distributed discrete fill errors that occur during the sachet filling process resulting in some sachets with unintended fill counts.

The system and methods described herein also provide a model for calculating the probability of failing CU testing as a function of weight RSD, potency RSD, fill error probability, and fill count. Key product parameters of the model therefore include 1) weight variance, 2) potency variance, 3) sachet fill count, and 4) fill error probability. Of particular interest is the impact of fill error probability on content uniformity. In one embodiment, the results of the model provided by the system and methods described herein may be plotted to create visualizations of relevant portions of the data produced by the model. These visualizations may then be used by a researcher or developer to inform pediatric mini-tablet product development decisions. In another embodiment, the model results are used by a computer-implemented logic controller to maintain optimal operating parameters for tablet-making machines, such as sachet filling machines, tablet presses, blenders, and the like, as will be described in more detail below.

To create the 5D matrix, a collection of sachets are grouped into sets of 30 from which USP <905> parameters, including assays, are calculated to derive acceptance values (AV). This includes an initial subset of 10 sachets for stage 1 calculations and a total of 30 sachets for stage 2 calculations. AVs are checked against the USP <905> criteria in silico to determine passage or failure of each simulated set of sachets. Probability of failure is calculated as the frequency of failures divided by the number of sets of sachets simulated. USP <905> criteria for CU, rather than weight variation, may be used because at low fill counts, doses commonly fall under 25 mg or 25% drug load threshold specified in USP <905>.

Embodiments of the present invention may be implemented in any one of a variety of different programming languages and programing platforms. MATLAB 2019b (Natick, Massachusetts: The MathWorks Inc) is but one example of a suitable programming language and platform that could be used to implement one embodiment of the present invention. Other programming languages and programming platforms may be used, depending on the particular requirements and objectives of the chosen implementation.

Potency RSD is defined as the RSD of active drug substance content in a mini-tablet normalized by mini-tablet weight and may be described as “blend uniformity.” Fill error probability is defined as the probability of a single miscount error occurring for each mini-tablet filled into a sachet (not the probability that any given sachet would have a miscount error). Multiple miscounts are allowed per mini-tablet according to the Bernoulli distribution.

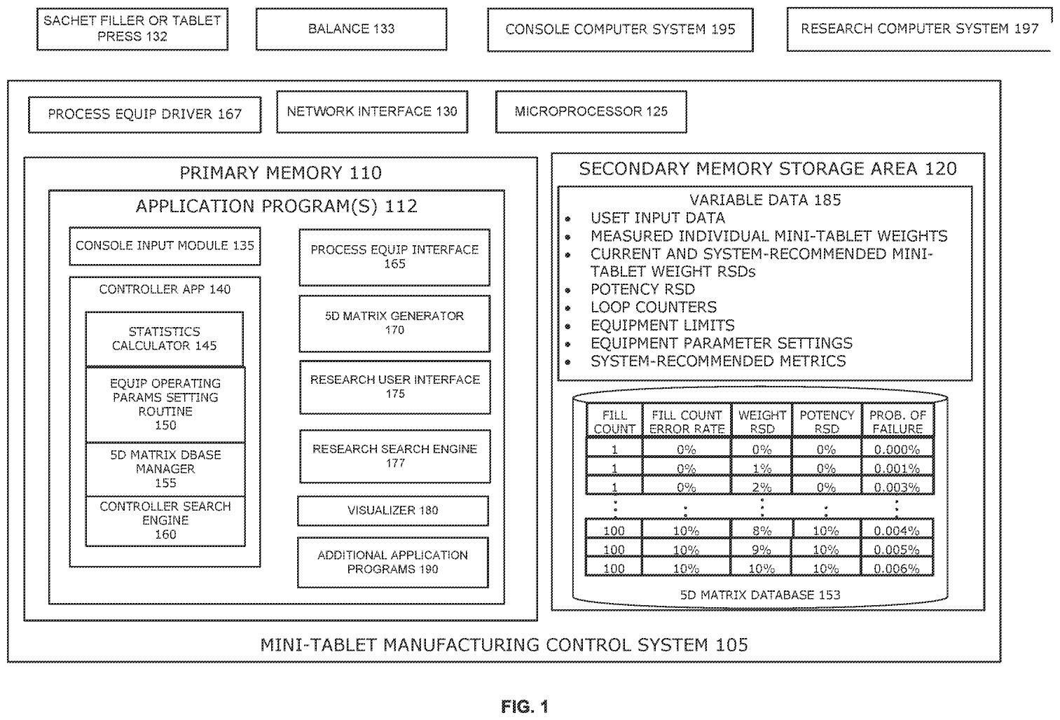

In an exemplary embodiment, the present invention provides a mini-tablet manufacturing control system for a mini-tablet manufacturing machine, such as a tablet press or sachet filler. FIG. 1 shows a high-level block diagram illustrating by way of example a computer architecture for a mini-tablet manufacturing control system 105 configured to operate in accordance with an embodiment of the present invention. The mini-tablet manufacturing control system 105 may be implemented on a general purpose or a specialized computer system, including, for example, a personal computer system, a notebook computer, a laptop, tablet or handheld computer system, an Internet-enabled smart phone or personal digital assistant computing device, or any combination of one or more thereof. Typically, the mini-tablet manufacturing control system 105 includes microprocessor 125 (aka, a “central processing unit” or “CPU”), a primary memory 110 (also called random access memory (or RAM)), and a non-volatile secondary memory storage area 120 (e.g., a hard disk drive (HHD), a solid-state drive (SSD), a flash or thumb drive, or a CD-ROM drive).

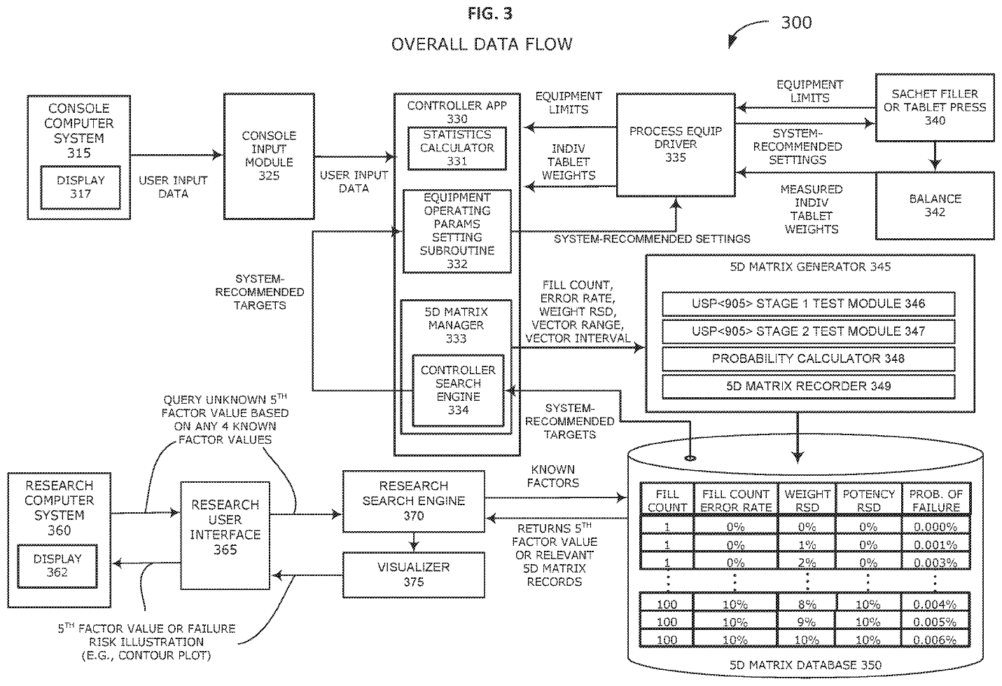

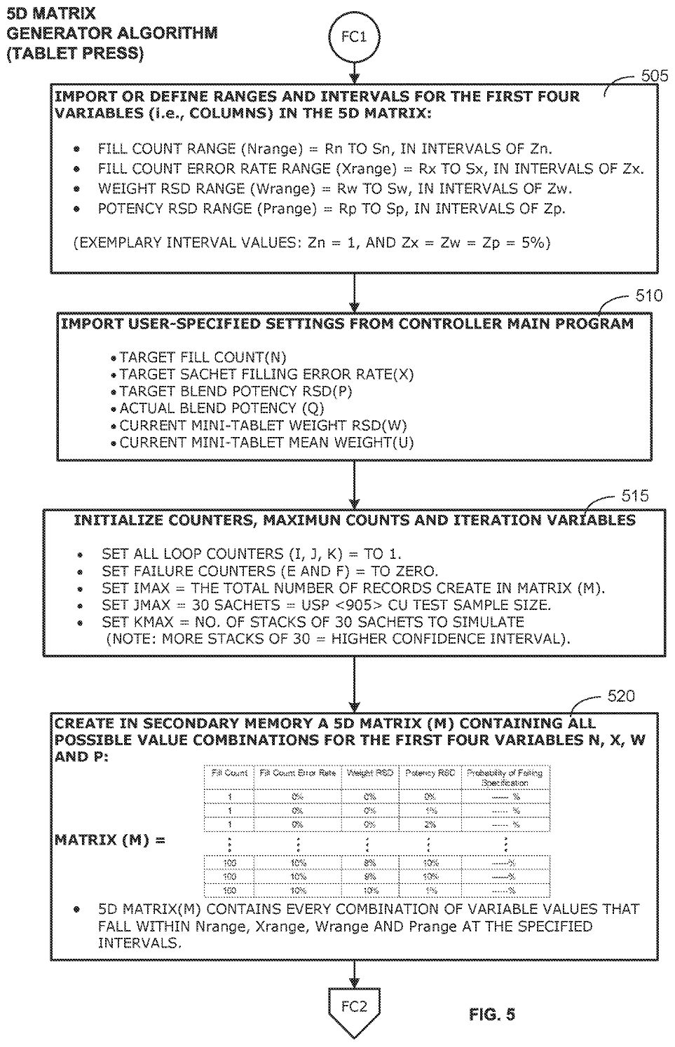

Notably, embodiments and implementations of the present invention are configured to produce, in real time, a comprehensive failure-risk profile for batches of mini-tablets during manufacture. The risk profile is embodied in a multi-dimensional matrix of related data values that the system creates and stores in the secondary memory storage area 120. Typically, although not necessarily, the multi-dimensional matrix exists as a computer-implemented data structure (e.g., a database, a table, an array, a linked list, etc.) stored in the secondary memory storage area 120. In some embodiments, the matrix of related data values has five dimensions. Thus the matrix may be created and stored in a five-dimensional (5D) data structure, an example of which is shown as 5D matrix database 153 in FIG. 1 and 5D matrix database 320 in FIG. 3. In other embodiments, the matrix may comprise more than five dimensions. Potentially, the matrix may even comprise hundreds or thousands of dimensions, in which case the data structure used to store the multi-dimensional database will be referred to as an “N-Dimensional” or “ND” matrix data structure (or database).

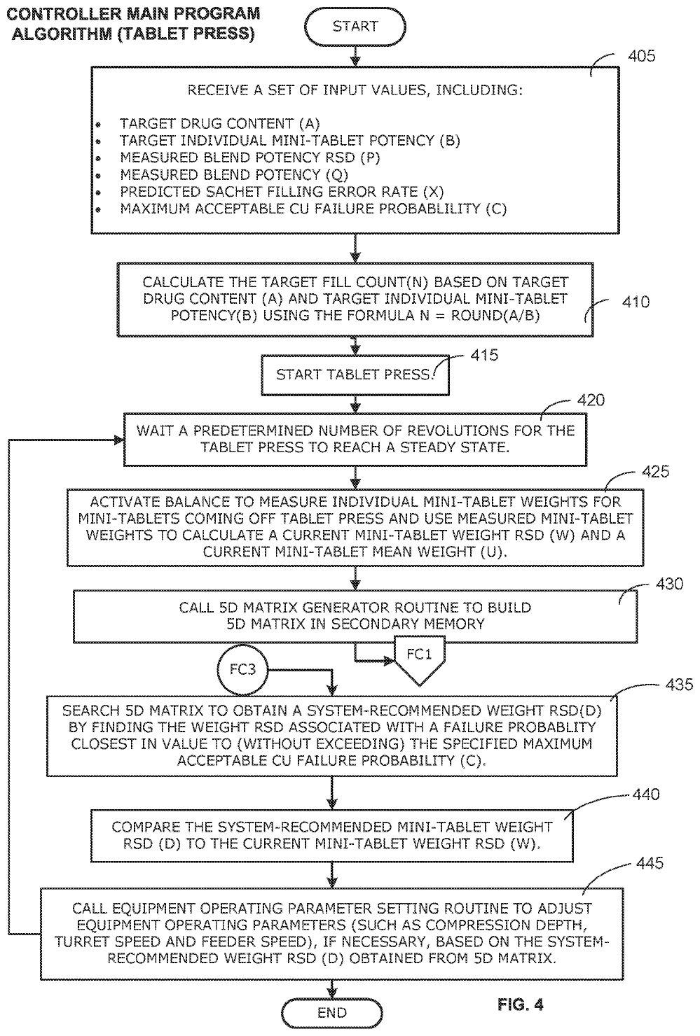

When the matrix comprises five dimensions, the 5D matrix contains records and fields that are populated with the four key variables. These key variables, which make up four dimensions of the 5D matrix, include the fill count, fill count error rate, weight variance and potency variance of the mini-tablets being tested for regulatory compliance, may be used by the system to determine the probability (i.e., the risk) that the batch of mini-tablets will fail CU testing requirements under the USP<905> specification. Each record in the 5D matrix database has at least five fields. The control system of the present invention is configured to first populate four of these fields with the fill count, fill count error rate, weight variance and potency variance of the mini-tablets being tested. Then, for every record in the 5D matrix database, the control system of the present invention uses the values in these four fields to compute the probability of failing the USP<905> CU testing specification and stores the result in the fifth field, as will be described in more detail below in connection with the algorithms shown in FIGS. 4-9.

Typically, the 5D matrix is created in the computer memory and populated with relevant data in real time as mini-tablets are manufactured and/or automatically inserted into single-dose sachets. Upon creation, these data may be utilized by researchers, analysts and pharmaceutical companies to reliably determine the current probability that a batch of mini-tablets will fail regulatory testing for content uniformity. Furthermore, the data may be used by an automated mini-tablet manufacturing controller, as will be described in more detail below, to automatically adjust the operating parameters of mini-tablet pressing and sachet filling machines, thereby changing the properties (e.g., the current weight and potency variances) of the mini-tablets so as to drive down the risk that the batch of mini-tablets currently being manufactured will fail CU testing requirements.

As shown in FIG. 1, the mini-tablet manufacturing control system 105 may also include a network interface 130, such as, for example, a wired Ethernet local area network adaptor, an 802.11 a/g/n Wi-Fi adaptor, a universal serial bus (USB) adaptor, and/or a Bluetooth wireless data communications adaptor, to provide a data communications link with other computer systems, peripherals such as printers, and/or data communications networks (not shown in FIG. 1). Program code, such as the code comprising one or more application program(s) 112, and program data, such as variable data 185, can be loaded into the primary memory 110 (i.e., loaded into RAM) from the secondary storage area 120 and loaded into the microprocessor 125 for execution. Operating under the control of the application program(s) 112, the microprocessor 125 can generate and store results in the secondary memory storage area 120 for subsequent access, display, output and/or transmission to other computer systems, other computer programs and/or other data communication networks.

The results of the programmed instructions carried out by the microprocessor 125 under the control of the software modules in the application program(s) 112 are stored in the secondary memory storage area 120, so that those results can be retrieved, displayed, printed, navigated and/or modified, as required, by a human user interacting with the mini-tablet manufacturing control system 105 via a console computer system 195 or a research computer system 197 (both of which may comprise, for example, variety of different input and output devices, such as a display device, a keyboard, mouse, stylus, touchscreen, printer, etc.) operating under the control of a console input module 135 and/or a research user interface 175 in the application program(s) 112. The secondary memory storage area 120, and the data it contains, may be integrated into the same physical machine as the microprocessor 125, the primary memory 110, the application program(s) 112 and the software modules 135, 140, 145, 150, 155, 160, 165, 170, 175, 177, 180 and 190, as shown in FIG. 1. However, some or all of the data and/or the 5D matrix 153 shown in the secondary memory storage area 120 may also reside on one or more separate (remote) computer systems in a distributed arrangement without departing from the scope of the claimed invention.

The network interface 130, operating in conjunction with process equipment driver 167, may be employed to establish a communicative connection to network-enabled manufacturing and measuring machines (e.g., sachet filler or tablet press 132 and balance 133) for manufacturing mini-tablets or for generating additional input data (such as mini-tablet weights) to be processed and used by the mini-tablet manufacturing control system 105. The network interface 130 may also be employed to establish a communicative connection to remote servers containing a multiplicity of electronic files and documents deemed useful or necessary for carrying out certain operations or processes on the mini-tablet manufacturing control system 105. The network interface 130 may also provide connectivity to other remote computer systems and devices (not shown) operated by other human users who wish to access and use the mini-tablet manufacturing control system 105 of the present 5 invention for doing research, creating reports, providing additional input data for calculations, or other purposes.

The primary memory 110 may comprise without limitation one or more local or remote, fixed or removable, permanent or temporary, magnetic or optical, random access memory (RAM) areas, cache memory areas, or disk drives, as well as a plurality of programming modules and libraries for controlling the functions of the microprocessor 125 to perform the methods described herein for creating, storing and populating the 5D matrix 153 and calculating probabilities of failure of the USP<905> CU testing specification. Each one of these modules may comprise a computer software program, procedure, or process written as source code in a conventional programming language, compiled into object code or byte code, and/or presented for execution by the microprocessor 125. The various implementations of the source code and object and byte codes can be stored on a computer-readable storage medium (such as a hard disk drive (HDD), DVD ROM, CDROM, floppy disk or memory card) or embodied on a transmission medium or carrier wave.

The application program(s) 112 comprises a collection of computer software program modules 135, 140, 145, 150, 155, 160, 165, 170, 175, 177, 180 and 190, discussed below, each containing program instructions that cause the microprocessor 125 to perform a variety of specific tasks, as necessary, to receive various types of input data (such as variable data 185), and to execute the below-described algorithms to generate, store, transmit and display the fill counts, fill count error rates, weight RSD, potency RSD, probabilities of failure, contour graphs, line graphs, heat maps, subgraphs, and other visualizations that may be associated with the drug manufacturing and sachet-filling control and research processes described herein. These software modules are flexible, and may be configured to receive, process and output a large variety of different types of inputs and outputs, including without limitation, plots, images and other electronic documents, graphs, layouts and schemas. The purpose and function of each one of the computer software modules 135, 140, 145, 150, 155, 160, 165, 170, 175, 177, 180 and 190 in the application program(s) 112 will now be described in more detail below.

The application program(s) 112 includes a console input module 135, a controller application 140, a statistics calculator 145, an equipment operating parameter setting routine 150, a 5D matrix manager 155, a controller search engine 160, a process equipment interface 165, a 5D matrix generator 170, a research user interface 175, a research search engine 177, a visualizer module 180, and one or more additional application programs 190. The console input module 135 comprises program instructions that, when executed by the microprocessor 125, causes the microprocessor 125 to receive and store in the secondary memory storage area 120 variable data 185. The variable data 185 may comprise different categories of input variable data necessary or desirable for execution of the algorithms described below, including, for example, target data, individual tablet weights, weight RSD, potency RSD, loop counters, equipment limits, equipment parameter settings and minimum risk data. The console input module 135 may also include program instructions that, when executed by the microprocessor 125, causes the microprocessor 125 to receive, scan, parse and/or store data stored in a spreadsheet, comma separated values (CSV) file or list file and store that data in the secondary memory storage area 120 as variable data 185.

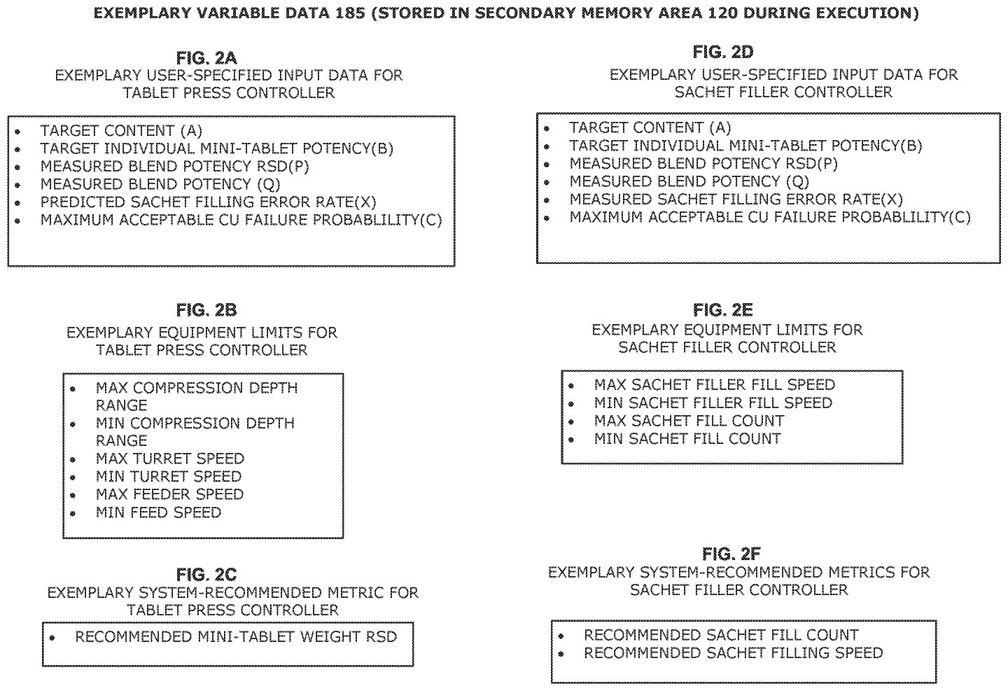

FIGS. 2A-2F show exemplary variable data 185 that may be stored in the secondary memory storage area 120 by operation of the console input module 135 in accordance with one embodiment of the present invention. As shown in FIGS. 2A, 2B and 2C, the variable data 185 stored in the secondary memory storage area 120 for a tablet press machine controller may include, without limitation, user-specified input data for a tablet press controller (FIG. 2A), equipment limits for a tablet press controller (FIG. 2B) and system-recommended metric data for a tablet press controller, such as a recommended weight RSD (FIG. 2C). As shown in FIGS. 2D, 2E and 2F, the variable data 185 stored in the secondary memory storage area 120 for a sachet filler machine controller may include, without limitation, user-specified input data for a sachet filler controller (FIG. 2A), equipment limits for a sachet filler controller (FIG. 2B) and system-recommended metric data for a sachet filler controller, such as a recommended sachet fill count or a recommended sachet filling speed (FIG. 2C). These data are used by the microprocessor 125 to execute the steps of the algorithms illustrated by the flow diagrams depicted in FIGS. 4-9 described herein below.

Returning to FIG. 1, the controller application 140 comprises program instructions that, when executed by the microprocessor 125, causes the microprocessor 125 to create, populate, store and search the 5D matrix 153. The controller application 140 also comprises program instructions that, when executed by the microprocessor 125, causes the microprocessor 125 to generate and transmit instructions that cause the process equipment driver 167 to adjust the current operating parameter settings on the sachet filler or tablet press 132 based on the variable data 185, calculations performed by the statistics calculator 145 and search results obtained from the 5D matrix 153. Typically, an equipment operating parameter setting routine 150 inside or associated with the controller application 140 comprises program instructions that, when executed by the microprocessor 125, causes the microprocessor 125 to determine which operating parameters, if any, need to be adjusted to reduce the probability of failure of the USP<905> CU testing specification, and then transmits instructions to adjust the current operating parameter settings to the sachet filler or tablet press 132 via a process equipment interface 165 (e.g., an application programming interface (API) or library of defined function and subroutine calls). The process equipment interface 165 comprises program instructions that, when executed by the microprocessor 125, causes the microprocessor 125 to communicate the instructions to the process equipment driver 167, which generates and sends the appropriate electronic signals to the sachet filler and/or tablet press 132 to change their current operating parameters.

The 5D matrix manager 155 comprises program instructions that, when executed by the microprocessor 125, causes the microprocessor 125 to jump to and execute programming instructions in the 5D matrix generator 165, which in turn causes the microprocessor 125 to create, populate and store records in the 5D matrix 153 in the secondary memory storage area 120. The controller search engine 160 comprises program instructions that, when executed by the microprocessor 125, causes the microprocessor 125 to search the 5D matrix 153 to retrieve values stored in the records of the 5D matrix 153, such as the weight RSD associated with the lowest probability of failure, and transmit the retrieved values to the equipment operating parameter setting routine 150.

The research search engine 177 module, operating under the control of the research user interface 175 permits a research user to query the 5D matrix 153 to solve certain problems associated with various factors impacting pass/fail probabilities. Examples of such problems and solutions, and how the system can be used to address these problems and solutions, are described in more detail below under the subheading “Use Cases Illustrated as Scenarios Encountered in Mini-tablet Drug Product Development.”

Generally, after the 5D matrix 153 is built by a first user supplying variable data 185, a second user (or the first user) may operate one or more of any end user input devices to activate the research user interface 175 to search the 5D matrix 153 based on a given set of input factors, such as weight RSD, potency RSD, fill error probability, fill count, probability of failing CU and/or expected acceptance values. The input factors are passed to the research search engine 177, which causes the system to retrieve from the 5D matrix 153 one or more values associated with an unknown factor. Accordingly, the research user interface module 175 and the research search engine module 177 together comprise program instructions that, when executed by the microprocessor 125, will cause the microprocessor 125 to: (i) receive a given set of factors from the end user, (ii) search the 5D matrix 153 based on the given set of factors to identify a record in the 5D matrix 153 having values that match (or are close to matching) the given set of factors, and (iii) transmit back to the end user via the research user interface one or more unknown values stored in the 5D matrix 153. The transmitted unknown factors may be configured for presentation on a research computer system 197 (e.g., a display monitor) operated by the end user. The visualizer module 180 includes program instructions that, when executed by the microprocessor 125, will cause the microprocessor 125 to use the values retrieved from the 5D matrix 153 to generate a graphical representation of the values, which is transmitted via the research user interface 175 to the research computer system 197 operated by the second user for display on a monitor.

The additional data processing modules 190 may include, for example, a database management library or API (not shown) that creates, organizes and facilitates storing and retrieving records to and from the 5D matrix 153. Any type of database can be utilized, including a flat file system, hierarchical database, relational database, or distributed database, such as those provided by Oracle Corporation, of Redwood Shores, California.

In some embodiments, the mini-tablet manufacturing control system 105 is capable of acting as a server configured for communicating with client computing devices using a standard web browser, such as Internet Explorer, over a data communications network (not shown), which may comprise the Internet and the World Wide Web. In such embodiments, the mini-tablet manufacturing control system 105 may be implemented using any one of a number of available web server applications or programs, including, for example, Internet Information Services (IIS), available from Microsoft Corporation, of Redmond, Washington.

FIG. 3 shows a high-level flow diagram illustrating, by way of example, the overall flow of program instructions and data in a mini-tablet manufacturing control system 300 configured to operate according to one computer-implemented embodiment of the present invention. As shown in FIG. 3, the mini-tablet manufacturing control system 300 comprises a console computer system 315 with a display 317, a console input module 325, a controller application 330 (hereinafter referred to as controller app 330), a process equipment driver 335, a 5D matrix generator 345 a 5D matrix database 350, a research search engine 370, a visualizer 375, a research user interface 365 and a research computer system 360 with a display 362. The controller app 330 comprises several subroutines, or sub applications, namely a statistics calculator 331, an equipment operating parameter setting subroutine 332, a 5D matrix manager 333 and a controller search engine 334. Suitably, the mini-tablet manufacturing control system 300 is typically communicatively linked to a sachet filler or tablet press 340 and a balance 342.

The console input module 325 comprises microprocessor-executable program instructions that, when executed by a microprocessor (not shown in FIG. 3) on the mini-tablet manufacturing control system 300, will cause the console input module 325 to receive certain user input data from the console computer system 315 and transfer the user input data to the controller app 330. The user data input may include, for example, target data, measured data and predicted data generated by a human user of the system, an automated measuring device, or both. The controller app 330 may also receive equipment limits and individual tablet weights from the process equipment driver 335, which is configured to constantly receive updated equipment limits and current weight measurements from the sachet filler or tablet press 340 and the balance 342, respectively, and pass these data points to the controller app 330. Thus, the target data may include, for example, a target drug content and a target mini-tablet individual potency for a batch of mini-tablets being made on the sachet filler or tablet press 340, and the measured data may include, for example, the current weight variance (weight RSD) of the current batch of mini-tablets and, if the machine is a sachet-filling machine, the sachet filling error rate. But if the machine is a tablet press, then the sachet filling error rate is a prediction, i.e., a form of predicted data.

The 5D matrix manager 333 in the controller app 330 includes program instructions that, when executed by the microprocessor, will cause the microprocessor to use the above-described inputs to generate and send to the 5D matrix generator fill count, error rate, vector range and vector interval data. The 5D matrix generator 345 includes several modules, including a USP <905> stage 1 test module 346, a USP <905> test module 347, a probability calculator 348 and a 5D matrix recorder 349, all of which include program instructions that together cause the microprocessor to create and store on a memory device associated with the system a five-dimensional (5D) matrix database 350 containing records and fields that are populated with data values representing certain properties of the current batch of mini-tablets that are being made by the sachet filler or tablet press 340. These properties make up the first four dimensions of the 5D matrix, and will typically include a specified fill count, a specified fill count error rate, a measured weight variance (weight RSD), and a measured potency variance (potency RSD). In some embodiments, the number of records in the 5D matrix database 350 will be limited by certain specified ranges and certain specified intervals in order to reduce the computational resources and power needed to create and populate all the records and data fields in the 5D matrix, which is why the 5D matrix manager 333 supplies the vector range and vector interval data to the 5D matrix generator 345. In other embodiments, depending on the application and the availability of computational power and memory resources, such range and interval limits on the size of the 5D matrix may not be strictly necessary or desirable, which could result in the microprocessor creating in memory a 5D matrix containing thousands, millions, hundreds of millions, or even billions of records.

Using the data in the first four dimensions of the 5D matrix database 350 (i.e., the fill count, fill count error rate, weight RSD and potency RSD), additional program instructions in the 5D matrix generator 345 are executed by the microprocessor to cause the microprocessor to carry out a Monte Carlo simulation on the data to calculate and store, for each record in the 5D matrix, a probability of failing the USP<905> CU testing requirements (see column 5 of 5D matrix database 350). After all the probabilities for all of the records in the 5D matrix have been calculated and stored, the data in the 5D matrix database 350 may be automatically searched by the controller search engine 334 of the controller app 330 and the values in the fields and records of the 5D matrix database 350 may be retrieved in order to do further research and development, to set system-recommended targets for the current operating parameters of the connected sachet filler or tablet press 340, or both. Then the equipment operating parameter setting subroutine 332 calculates new system-recommended settings necessary to achieve the system-recommended targets, and sends the system-recommended settings to the sachet filler or tablet press 340 via the process equipment driver 335. Setting, adjusting and controlling tablet presses and sachet filling machines using computer-implemented embodiments of the present invention permit drug manufacturers to reduce the risk of failing regulatory testing requirements to acceptably low levels, and thereby generates considerable savings in time and resources. Beneficially, the 5D matrix may be generated in real time.

Exemplary implementations and embodiments of the present invention may be configured to operate in several different modes. For instance, when the system is carrying out the steps described above for receiving input data, calculating probabilities, creating the 5D matrix database 350, the system may be considered to be operating in a matrix generation mode. However, when the system is constantly calculating system-recommended targets for the mini-tablets and setting and resetting the current operating parameters for the sachet filler or tablet press 340 to reduce the risk of failing CU testing requirements, the system may be considered to be operating in a machine controller mode. Embodiments of the invention may also be configured to operate in a research and development mode. In the research and development mode, program instructions in the research user interface 365, research search engine 370 and visualizer 375 may be invoked from the research computer system 360 to cause the microprocessor to retrieve data from the now populated 5D matrix database 350, plot the data in a graph or contour map, and display the plot on the display 362 of the research computer system 360. Alternatively, the research user interface 365 also may contain program instructions that, when executed by the microprocessor, will cause the microprocessor to transmit the search results obtained from the 5D matrix database 350 to another computer system or network for further use or processing. The above-referenced several operating modes of embodiments of the present invention will now be described in somewhat more detail.

In the database generation mode of operation, a human user operates the console computer system 315 to activate an console input module 325 running on a computer system to input user-specified target data for a mini-tablet manufacturing process that includes a sachet filler or tablet press 340, the inputted target data including, for instance, a target weight variance (expressed as target weight relative standard deviation, or target weight RSD), a target potency RSD, a sachet filling error rate, a maximum acceptable CU failure rate, a target individual tablet weight, a target individual tablet potency and a target blend potency. The controller app 330 running on the computer system then uses the user-specified target data to calculate a target fill count based on the target content and the target potency, and then calls and executes a 5D matrix generator 345 on the computer system (or on a connected computer system) to create and populate in real time a 5D matrix database 350 based on the target fill count, sachet fill error rate, mini-tablet weight RSD and the mini-table potency RSD. To accomplish this step, the 5D matrix generator 345 may use a Monte Carlo simulation, in conjunction with USP<905> stage 1 and stage 2 testing criteria, to generate a multiplicity of assays, as will be explained in more detail below, and use the results of the Monte Carlo simulation to calculate a probability of failing the USP<905> simulation. These probabilities are then stored in the appropriate records in the 5D matrix database 350.

After it is populated, the 5D matrix database 350 comprises a multiplicity of records (that could number in the thousands, tens of thousands, or millions of records) that define relationships between fill count, fill count error rate, weight variance, potency variance and probability of CU testing failure for a predetermined range of weight RSDs. Each record in the 5D matrix database 350 has a fill count field, a fill count error rate field, a weight variance field, a potency variance field and a probability of CU testing failure field. Notably, the 5D matrix database 350 may comprise any one of a number of different types of databases, including without limitation, a hierarchical database, a relational database or an object-oriented database, as are well known in the computer arts. The 5D matrix and all of its records are stored in a secondary memory located on, or associated with, the computer system and controller application that received the target data from the user.

In the machine controller mode of operation, the control app 330 may call or invoke the controller search engine 334 to search the 5D matrix database 330 to identify a record in the 5D matrix database 350 containing a value in the probability of CU testing failure field that is closest to a maximum acceptable CU failure risk value inputted by the user via the console input module 325. The controller search engine 334 then examines the weight RSD field in that record to identify and return the weight RSD value in that same record. Various known techniques may be used to efficiently search the records of the 5D matrix database 350 for the probability of CU testing failure value closest to the inputted maximum acceptable CU failure risk value, including without limitation, a linear search, a binary search, a jump search, an interpolation search, an exponential search, a sub list search (searching a linked list nested inside another linked list) and a Fibonacci search. The returned weight RSD value then becomes the new system-recommended “target” weight RSD value for the tablet press machine.

The controller app 330 then compares the returned target weight RSD value to the target weight variance entered by the user. Depending on whether the returned target weight RSD is less than, equal to, or greater than the target weight RSD entered by the user, the controller app 330 (or a subroutine associated with the controller app 330) may be configured to call the equipment operating parameters routine 332, which invokes the process equipment driver 335 to automatically adjust current operating parameter settings on the tablet press, such as the range of the compression depth setting, the turret speed setting or the feeder speed setting, so that the tablet press will start producing mini-tablets having the new target weight RSD. The batch of mini-tablets produced with the new target weight RSD are more likely to pass (less likely to fail) the regulatory CU testing requirements. Preferably, the controller app 330 is communicatively coupled to the process equipment driver 335, which in turn is communicatively connected to the tablet press 340 and a balance 342. The process equipment driver 335 may be configured to convert parameter setting instructions received from the equipment operating parameter setting subroutine 332 of the controller app 330 in digital form into electric signals that activate physical actuators in the sachet or tablet press 340 so as to set or adjust the tablet press' current operating parameter settings. The balance 342 is configured to measure individual tablet weights of the mini-tablets coming out of the tablet press and transmit those measurements back to the controller app 330 via the process equipment driver 335 so that the weights of the newly produced mini-tablets and the current weight RSD can be recalculated and monitored.

As another option, the system may also be configured to operate in a research and development mode, during which the system receives through the research user interface 365 a set of four probability factors from a second user (who may or may not be the same person as the first user) operating the research computer system 360. The set of four probability factors comprise four of the five factors stored in each record of the 5D matrix database 350 previously created by the 5D matrix generator 345. Using the set of four input factors, the research search engine 370 searches the records that are stored in the 5D matrix database 350 to find a record that has the same or similar values, and if found, retrieves, displays, prints or transmits information about a fifth factor in the retrieved record. on a device monitor accessible by the research user. Optionally, the research user interface 350 may be connected to a visualizer application 375 configured to display, print or transmit a graphical representation, such as a contour plot, of the data in the relevant records retrieved from the 5D matrix database 350.

Thus, based on the above-described architecture and the above-described data and instruction flows, one embodiment of the present invention provides a control system for a mini-tablet manufacturing machine, comprising a) a microprocessor, b) a primary memory, c) a secondary memory storage area, d) a controller application in the primary memory, e) an input module for communication with a console computer system operated by an end user, and f) a process equipment driver communicatively coupled to a mini-tablet pressing machine. The controller application program comprises program instructions that, when executed by the microprocessor, will cause the microprocessor to (i) receive and store in the secondary memory storage area target data representing (A) a target drug content. (B) a sachet filling error rate, (C) a maximum acceptable CU failure rate, (D) a target tablet individual weight, (E) a target tablet individual potency, (F) a target blend potency RSD, and (G) a tablet weight RSD; (ii) based on the target data, create and store in the secondary memory storage area a data structure comprising one or more records that define relationships between fill count, fill count error rate, weight RSD, potency RSD and probability of failing the USP<905> content uniformity specification; (iii) search the 5D matrix to retrieve an optimal weight RSD value associated with a minimum probability value in one or more of said records in the 5D matrix; and (iv) based on the optimal weight RSD value, transmit an instruction to the process equipment driver that will cause the process equipment driver to generate and send an electronic signal to the mini-tablet press machine that changes a current operating parameter setting on the mini-tablet pressing machine.

An additional feature of the controller in this embodiment may comprise a process equipment driver that is communicatively coupled to a balance configured to measure individual weights of mini-tablets produced by the mini-tablet press machine, and the process equipment driver is further configured to transmit the measured individual weights to the controller application, which in turn is configured to store the measured weights in the secondary memory.

Additional optional features of this embodiment include a research user interface and a research search engine. The research user interface comprises program instructions that, when executed by the microprocessor, will cause the microprocessor to (i) receive probability factor data values from a research user; (ii) search the 5D matrix based on the probability factor data values to identify one or more records in the 5D matrix having the same or similar values, (iii) retrieve a probability of failing the USP<905> CU testing specification from said one or more records, (iv) transmit the probability of failing to the research user interface for presentation on a display device operated by the research user.

Yet another optional feature of this embodiment is a visualizer program having program instructions that, when executed by the microprocessor, will cause the microprocessor to a) use values in said one or more records to produce in the secondary memory storage area a graphical representation of said one or more records; and (b) transmit the graphical representation to the display device operated by the research user.

Still another optional feature in this embodiment comprises program instructions in the controller application that, when executed by the microprocessor, causes the microprocessor to a) receive a specified range for the weight RSD, and b) use the specified range to generate the 5D matrix having only weight RSD values that fall within the specified range.

In another embodiment of the present invention, there is provided a computer-implemented method for controlling a mini-tablet press machine or mini-tablet sachet filling machine comprising the steps of (i) receiving and storing in a secondary memory storage area target data representing (A) a target drug content, (B) a sachet filling error rate, (C) a maximum acceptable CU failure rate, (D) a target tablet individual weight, (E) a target tablet individual potency. (F) a target blend potency RSD, and (G) a tablet weight RSD; (ii) based on the target data, creating and storing in the secondary memory storage area a 5D matrix database comprising one or more records that define relationships between fill count, fill count error rate, weight RSD, potency RSD and probability of failing the USP<905> content uniformity specification; (iii) searching the 5D matrix to retrieve an optimal weight RSD value associated with a minimum probability value in one or more of said records in the 5D matrix; and (iv) based on the optimal weight RSD value, transmitting an instruction to the process equipment driver that will cause the process equipment driver to generate and send an electronic signal to the mini-tablet press machine that changes a current operating parameter setting on the mini-tablet pressing machine.

Though the exemplary embodiments of the invention described herein are explained in terms of both potency and weight variation, it should be noted that these embodiments may also be used for CU testing mini-tablets batches where only the weight varies because testing of such batches represents the simplified scenario where potency variation is assumed to be zero.

Referring now to the flow diagrams depicted in FIGS. 4 through 9, examples of the algorithms that may be executed by embodiments of the present invention to generate the 5D matrix database 350, to set and reset the current operating parameters of sachet filling machines and tablet presses will now be described in some detail.

FIG. 4 shows a high-level flow diagram illustrating, by way of example, an algorithm executed by the main program of the controller app 140 in FIG. 1 (or controller app 330 in FIG. 3) in a mini-tablet manufacturing control system configured to operate in accordance with one embodiment of the present invention to control the operation of a tablet press machine. As shown at step 405 in FIG. 4, the first step performed by the system is receiving a set of input values, including without limitation, a target drug content, i.e., drug dose (represented by variable “A”), a target individual mini-tablet potency (variable B), a measured blend potency RSD (P), a measured blend potency (Q), a predicted sachet filling error rate (X) and a maximum acceptable cu failure probability (C). Next, in step 410, the system calculates a target fill count (N) based on the target dose (A) and target individual mini-tablet potency (B) using the formula N=Round (A/B). Next, in steps 415 and 420, the system starts the tablet press and waits a predetermined number of revolutions to reach a steady state. Then the system activates a connected balance to measure individual mini-tablet weights for mini-tablets coming off tablet press and use measured mini-tablet weights to calculate a current mini-tablet weight RSD (W) and a current mini-tablet mean weight (U). See step 425. At step 430, the system calls the 5D matrix generator routine to build a 5D matrix database in a secondary memory storage area associated with the system. Processing then continues at step 505 of FIG. 5 by way of flow chart connector FC1.

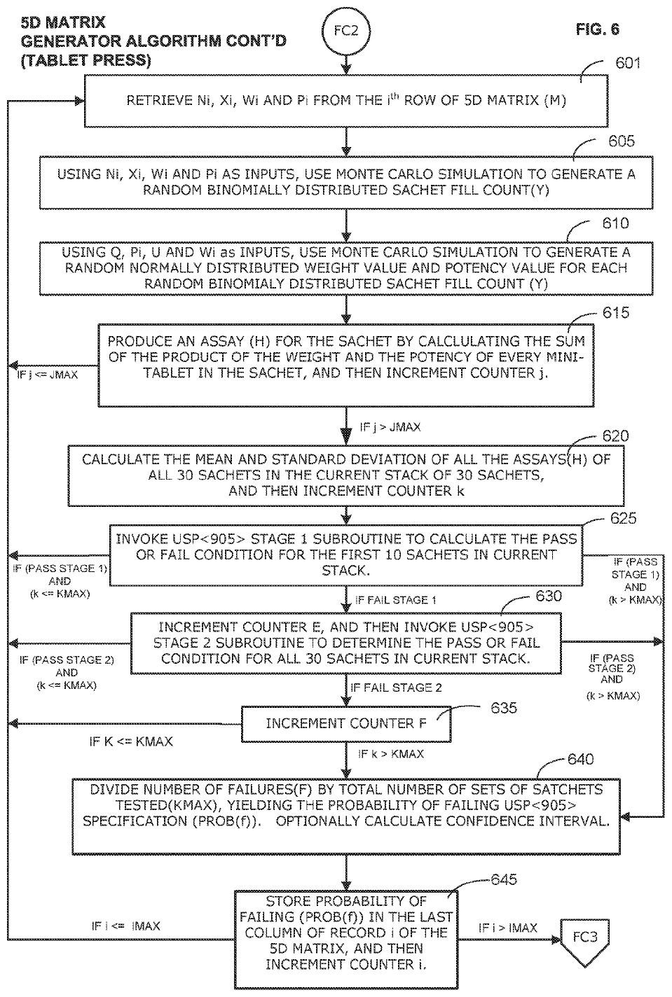

FIG. 5 shows a high-level flow diagram illustrating, by way of example, an algorithm executed by the 5D matrix generator to build the 5D matrix database in accordance with an embodiment of the present invention to control a tablet press machine. As shown in steps 505, 510 and 515 of FIG. 5, respectively, the 5D matrix generator imports or defines a set of ranges and intervals for the first four variables (i.e., columns) in the 5D matrix, imports user-specified settings from the main program, initializes certain counters, maximum counts and iteration variables. Then, in step 520, the 5D matrix generator creates in secondary memory a 5D matrix database (M) containing all possible value combinations for the first four variables, so that the 5D matrix in the secondary memory contains every combination of values for the first four variables that fall within ranges imported or defined in step 505, and for the intervals defined in step 505. At this point, only the first four columns of the 5D matrix database in the secondary memory have been populated. Next, processing continues at step 601 of FIG. 6 by way of flow chart connector FC2, where the 5D matrix generator starts to calculate and populate the fifth column of the 5D matrix database, for every row in the 5D matrix database, with values representing the probability of failing the USP <905> testing requirement for every combination of the first four variables (fill count, fill count error rate, weight RSD and potency RSD) in the 5D matrix database.

FIG. 6 shows a high-level flow diagram illustrating, by way of example, an algorithm executed by an equipment parameter setting routine 150 configured to operate in accordance with an embodiment of the present invention to calculate the probability of failing the USP <905> content uniformity testing requirements for every row in the 5D matrix database based on the row's combination of values for fill count, fill count error rate, weight RSD and potency RSD. At steps 601 through 645 of FIG. 6, and using the variable “i” as an index for the rows of the 5D matrix and known Monte Carlo simulations, the 5D matrix generator calculates and stores in the fifth column of the 5D matrix the probability of failing stage 1 and stage 2 of USP <905> for each combination of variables in the first four columns of each row of the 5D matrix. After all five columns of the 5D matrix have been populated by the 5D matrix generator in accordance with algorithms illustrated by the flow diagrams shown in FIGS. 5 and 6, processing returns to step 435 of FIG. 4 by way of flow chart connector FC3, wherein the main program searches the 5D matrix database to obtain a system-recommended weight RSD associated with a failure probability closest in value to (without exceeding) the specified maximum acceptable CU failure probability (C) (step 435). Then the controller main program compares the system-recommended weight RSD to the current weight RSD of the mini-tablets in the tablet press machine (step 440), and, if necessary, and calls the equipment parameter setting routine to adjust the equipment operating parameters (such as compression depth, turret speed and/or feeder speed) of the tablet press based on the system-recommended weight RSD obtained from the 5D matrix database (step 445).

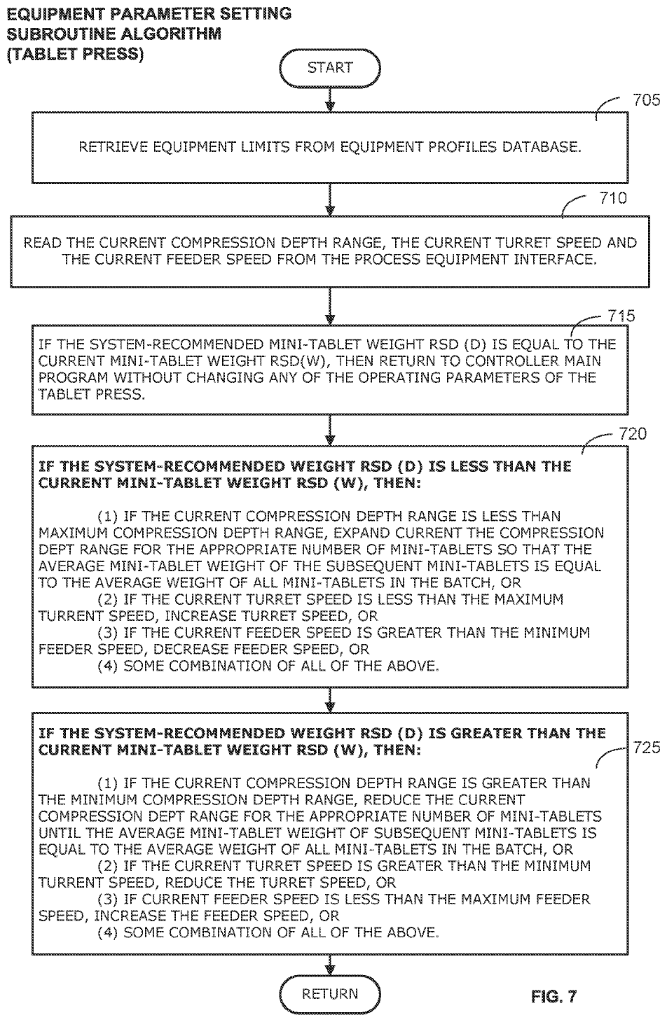

FIG. 7 shows a high-level flow diagram illustrating, by way of example, an algorithm executed by the equipment parameter setting subroutine configured to operate in accordance with one embodiment of the present invention to control a tablet press. Basically, as shown in FIG. 7, the equipment parameter setting routine retrieves equipment limits for the tablet press (step 705), reads the current operating parameters for the tablet press, as provided by the process equipment interface (step 710), and then adjusts the current operating parameters, if necessary, based on a comparison of the system-recommended weight RSD to the current mini-tablet weight RSD for the mini-tablets currently being produced by the tablet press (steps 715, 720 and 725). Thus, as illustrated in the detail of FIG. 7, the equipment parameter setting subroutine may change the current compression depth, the current turret speed, the current feeder speed, or all of them, in order to eventually achieve the system recommended RSD for mini-tablets produced by the tablet press. After these adjustments have been made, execution of the equipment parameter setting subroutine is finished and control returns back to the main program illustrated in FIG. 4.

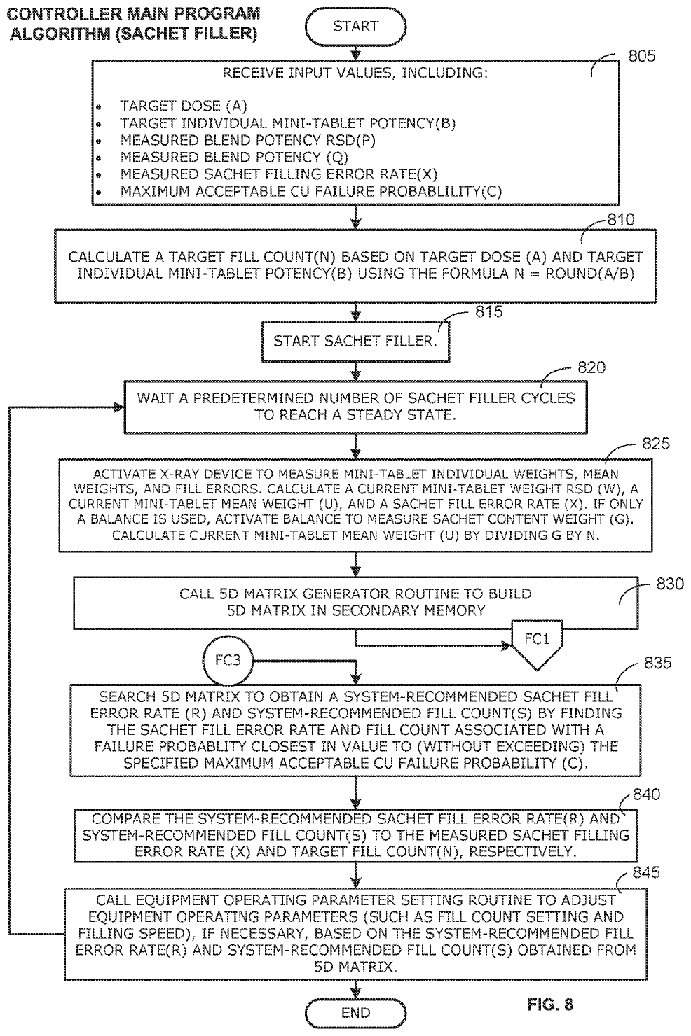

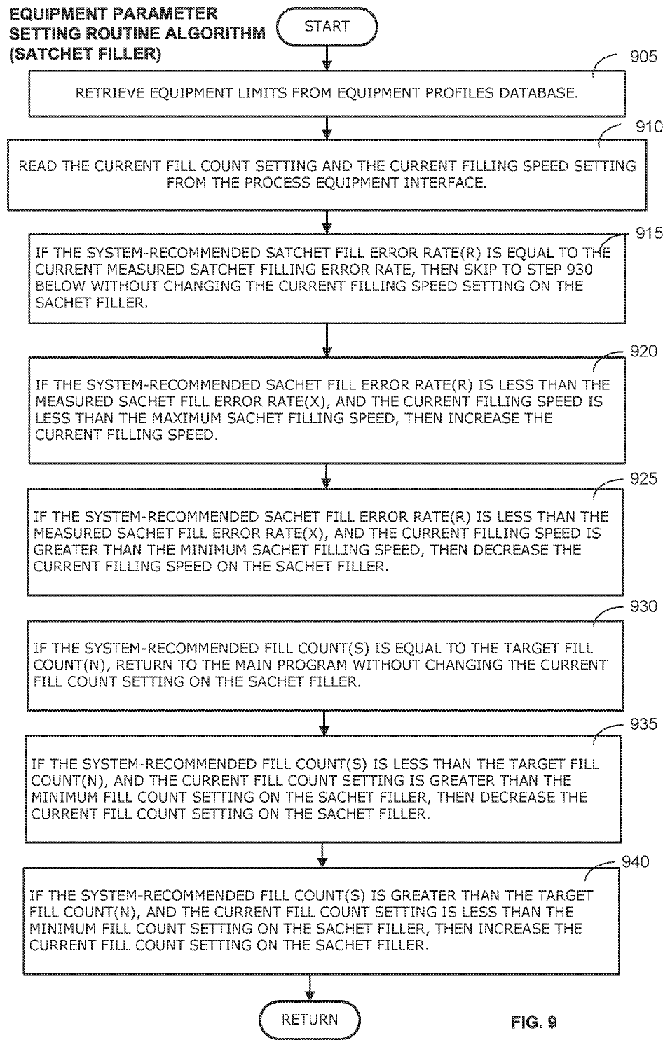

FIG. 8 shows a high-level flow diagram illustrating, by way of example, an algorithm executed by the main program of the controller app 140 in FIG. 1 (or controller app 330 in FIG. 3) in a mini-tablet manufacturing control system configured to operate in accordance with one embodiment of the present invention to control the operation of a sachet filling machine. FIG. 9 shows a high-level flow diagram illustrating, by way of example, an algorithm executed by an equipment parameter setting routine 150 configured to operate in accordance with an embodiment of the present invention to control a mini-tablet sachet filler machine. However, instead of receiving and using input variables and equipment limits associated with a tablet press machine to find a system-recommended weight RSD for the mini-tablets based on a calculated probability of failing USP <905> testing requirements, the main program for the sachet filling machine receives and uses a different set of input variables (see step 805 in FIG. 8) and equipment limits (see step 905 of FIG. 9) associated with a sachet filling machine to determine the system-recommended sachet fill error rate and the system recommended fill count based on the calculated probability of failure (as shown in step 835). The algorithm executed by the equipment operating parameter setting subroutine (illustrated by FIG. 9) then changes one or more of the current operating parameters of the sachet filling machine (such as the current filling speed or the current fill count), if necessary, to achieve the target filling speed and target fill count (steps 915 through 940).

Notably, the USP <905> Specification Batch Testing Criteria for mini-tablets is incorporated into the above-described exemplary embodiments of the invention. It is understood, however, that other USP specifications may be incorporated or substituted into embodiments of the invention with departing from the intended scope of the claims.

Passage or failure of USP <905> is determined in two stages of testing. In Stage 1, a sample of 10 sachets is selected and the contents of each are separately tested for weight and assay. From these an Acceptance Value (AV) derived from the USP <905> criteria is calculated and compared against a predetermined Acceptance Value Threshold (AVT). The predetermined AVT may be set, for example, at ≤15%). Failure to meet the AVT in stage 1 triggers a second stage (Stage 2) of testing, which includes sampling of 20 sachets in addition to the original 10. A second AV value is calculated for Stage 2 and compared to the AVT. Additionally, during Stage 2 testing only, all individual doses must be within 25% of the target content for the batch to pass. Failure to meet any of these criteria results in Stage 2 failure, which means the batch cannot be released and must be discarded.

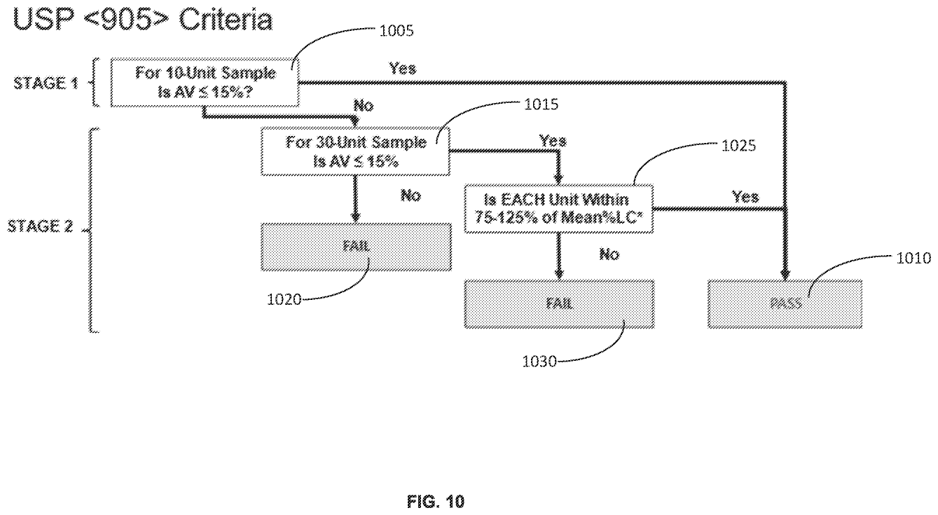

FIG. 10 shows a flow diagram illustrating the steps required by the USP <905> specification for CU assessment. As shown in step 105 of FIG. 10, there are two stages of assessment, Stage 1 assessment and Stage 2 assessment. In Stage 1 assessment, the contents of 10 individual sachets are assayed to calculate an acceptance value (AV). If the calculated AV is less than a predetermined threshold (AVT) of 15%, then the batch passes CU assessment under USP<905> (passing the assessment is represented by status box 1010 in FIG. 10). However, if it is determined in step 1005 that the calculated AV is greater than or equal to the AVT (e.g., 15%), then Stage 2 assessment is required.

In Stage 2 assessment, the contents of an additional 20 sachets are assayed and the data are aggregated with the data collected for the initial 10 sachets during the Stage 1 assessment. As in Stage 1, an AV is calculated and compared to the threshold AVT (15%) (see step 1015 in FIG. 10). If it is determined in step 1015 that the calculated AV is greater than the AVT, then the batch fails CU assessment under USP<905> (see status box 1020 in FIG. 10). If, on the other hand, it is determined in step 1015 that the calculated AV is less than or equal to the AVT (i.e., 15%), then an additional criterion is required for contents of individual sachets. The additional criterion is that the content in each one of all 30 sachets must be within 25% of the target content for the batch. Note, this criterion represents the case where mean % LC is 98.5-101.5% of target. The criterion can vary slightly if the mean % LC is outside this range. For example, the criterion may be as low as 73.875-123.125% and as high as 76.125-126.875% (not shown in FIG. 10). Accordingly, in step 1025, the contents of each sachet is examined to confirm whether or not the contents are within plus/minus 25% of the target label claim. If the actual contents of one or more sachets falls outside the range of plus/minus 25% of the target content, then the batch fails the CU assessment (status box 1030) and must be discarded. On the other hand, ff the actual contents of all sachets fall within the range of plus/minus 25% of the target content, then the batch passes the CU assessment (status box 1010) and the batch can be released for commercial use.

### Simplification of Weight and Potency RSD Parameters

To reduce the number of parameters simulated, the weight and potency variances may be combined into a single variance parameter referred to as the “Composite RSD”:

$$Composite RSD = √ ( ( Weight RSD ) \hat{} 2 + ( Potency RSD ) \hat{} 2 ) \qquad Eq . 1$$

where “Weight RSD” is the relative standard deviation of bulk mini-tablet weights and “Potency RSD” is the relative standard deviation of bulk mini-tablet potency (normalized by weight).

The composite RSD is therefore a property of bulk mini-tablets rather than of sachets. This simplification is supported mathematically and qualitatively by the observation that potency and weight RSDs contribute equally to CU failure probability. Reduction of weight RSD and potency RSD to a single composite RSD facilitated simulation/visualization of fill count and fill error probability as contour plots. These contour plots were modeled with ranges of 0-15% for composite RSD, 1 to 10 for fill count, and 0% to 0.1% fill error probability. However, an unlimited number of other ranges may be modeled and used, depending on the situation and/or application.

### Contour Plot Visualizations

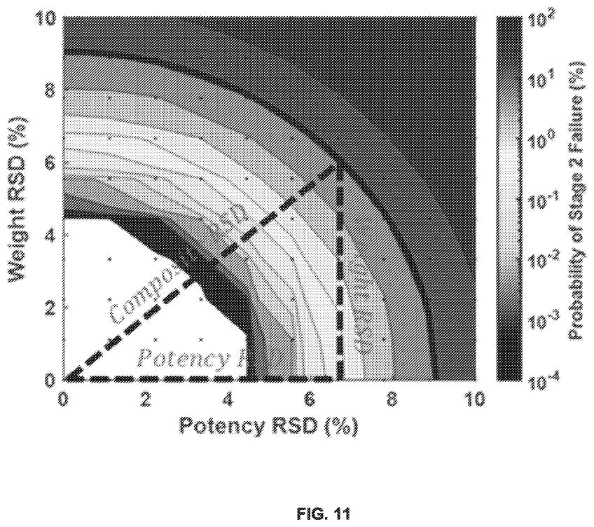

Contour plots can provide a very effective way of visualizing and accessing relevant portions of the data produced by the Monte Carlo simulation. In the contour plots shown in FIGS. 11-14, the probability of CU failure or acceptance values (shading and patterns on the contour plots) are logarithmically and linearly spaced, respectively. Composite RSD refers to the content of bulk mini-tablets rather than to content of sachets. Fill error probability is the probability of a single error occurring for each mini-tablet inserted into a sachet (i.e. it is not the probability that a sachet would have an error). Grid points represent the points at which model calculations were performed. The white space in a contour plot indicates values falling below the model calculation threshold of 0.0001% ( 1/1,000,000).

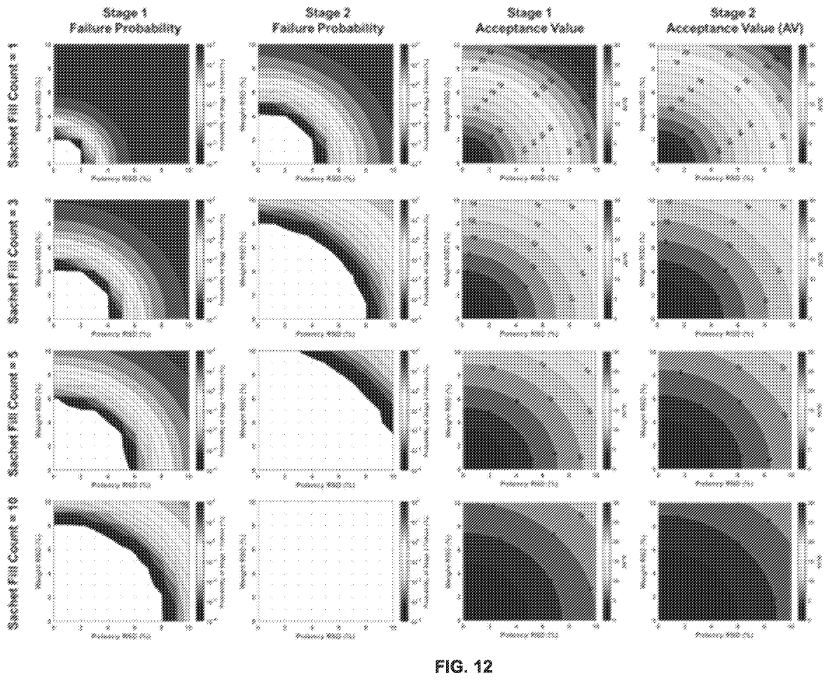

FIG. 11 shows a contour plot illustrating the probability of stage 2 failure as a function of potency RSD, weight RSD and composite RSD. As shown in FIG. 11, the probability of failing CU requirements was found to be qualitatively proportional to the root sum of squares of bulk mini-tablet weight RSD and potency RSD (Equation 1, above). The composite RSD (bold solid line in FIG. 11) is overlaid on the simulated probability of stage 2 failure with fill count equal to 1 and fill count probability equal to 0%. A similar trend is observed for other fill counts (as illustrated, for example, in the contour plots shown in FIG. 12, discussed in detail below).

### Model Results

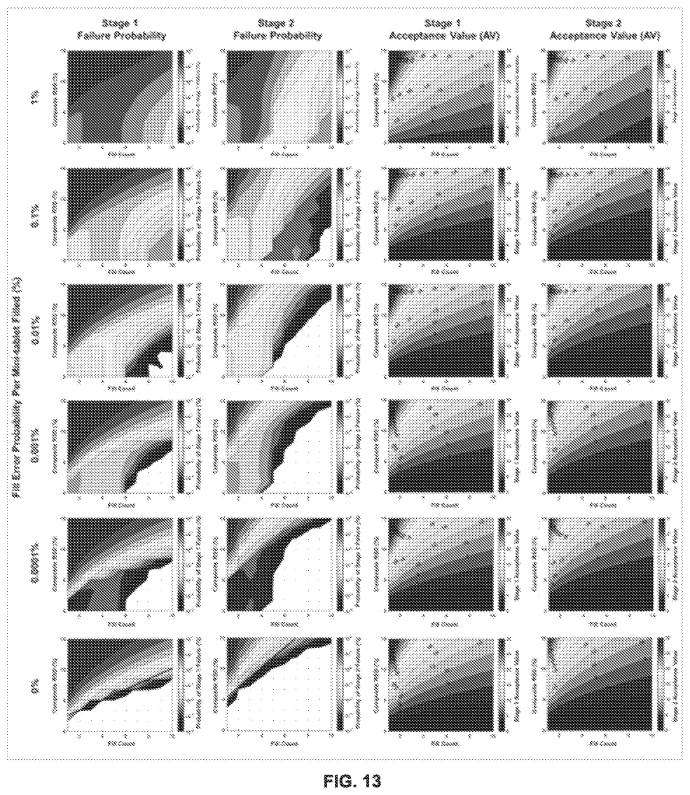

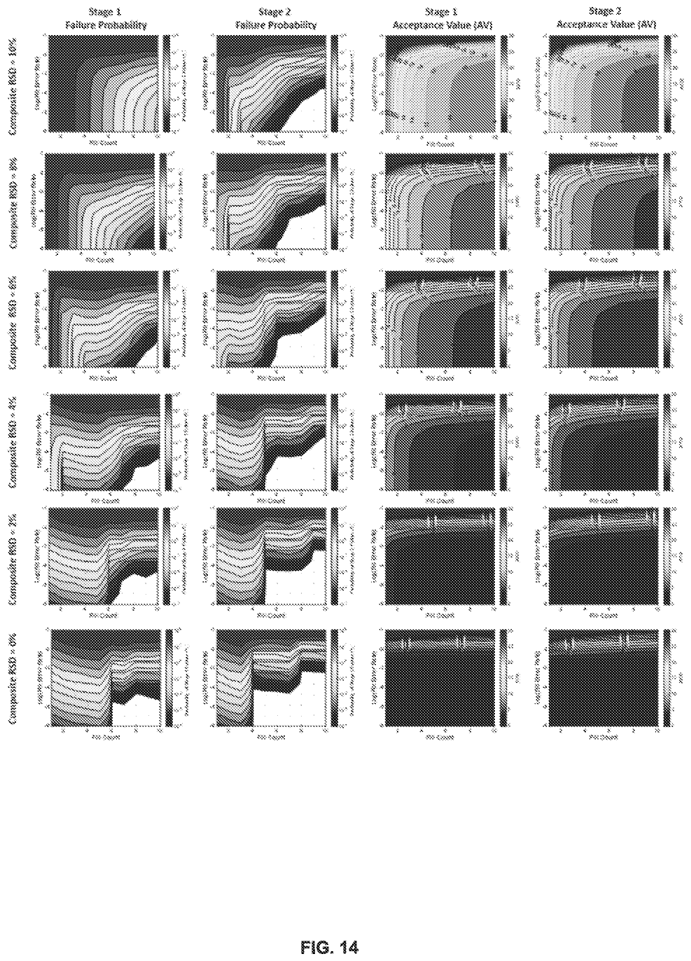

The probability of failing CU testing was modeled as a function of weight RSD, potency RSD, fill error probability, and fill count. Weight and potency RSD impacted CU outcomes similarly and proportionally to the root sum of their squares (FIGS. 11 and 12). Fill count and fill error probability were found to impact CU over a range of composite RSDs (FIGS. 13 and 14). Tabulated values for FIGS. 12, 13 and 14 are found in the tables of Sections 2.1, 2.2 and 2.3, respectively, of the Supplementary Information below.

Parameter ranges modeled included 1-10 fill count, 0-10% weight RSD and potency RSD (0-15% composite RSD), and 0-10% fill error probability per mini-tablet. Over these ranges, probability of stage 1 and stage 2 CU failure was observed from <1×10-4% to nearly 97.6% (FIG. 13). However, for fill counts of at least 5 mini-tablets per sachet, the maximum observed failure probability was lower at 15.9%.

Considering the effect of fill count on a representative product having 5% weight RSD and potency RSD, and 0.1% fill error probability per mini-tablet, it may be observed that the maximum CU failure probability for this product was 8.23% for fill counts of 1-4 but was 0.283% for fill counts of 5-10. For a well-controlled product with 2% weight RSD and potency RSD, and <0.1% fill error probability per mini-tablet, maximum CU failure probability was 0.497% for fill counts of 1-4 but was 0.00435% fill counts of 5-10.

The effect of fill error probability is likewise pronounced. For the same representative product above having a greater fill error probability per mini-tablet of 1%, rather than 0.1%, the CU failure probability is 22.2% for fill counts 1-4 and 3.96% for fill counts 5-10. Assuming a smaller fill error probability per mini-tablet of 0.01%, the CU failure probability is 6.64% for fill counts 1-4 and 0.0264% for fill counts 5-10.

In the absence of fill errors, increasing potency RSD and weight RSD adversely impacted CU stage 1 and stage 2 failure probabilities and AV values ranging from 1% to 10% (FIG. 12). At a 10-count target fill, the probability of stage 2 failure was below the model threshold of detection (<0.0001%) for all combinations of potency RSD and weight RSD simulated (0 through 10%). Stage 1 failure probability is always greater than stage 2 failure probability as the former always precedes the latter.

FIG. 12 shows sixteen visualizations (in the form of contour plots) illustrating the probability of stage 1 and stage 2 content uniformity batch failure and acceptance values for 0% fill error probability represented as a function of modeled bulk mini-tablet weight RSD (vertical axes), bulk mini-tablet potency RSD (horizontal axes), and sachet fill count (rows). These contour plots, which were created from the results of the Monte Carlo simulation, inform users of the system on the impact of weight RSD and potency RSD independent of fill errors. Tabulated values for the contour plots shown in FIG. 12 may be found in the tables of Section 2.1 of the Supplementary Information below.

### CU Failure Probability and Acceptance Values (AV) as a Function of Fill Count, Composite RSD, and Fill Error Probability

The CU failure probability contour plots tend to have two distinct regions: 1) a region of high failure probabilities corresponding with large composite RSD values, and 2) a region of lower failure probabilities sensitive to fill errors, corresponding with lower composite RSD values. Contour plots for 0% fill error probability provide an important control illustrating this demarcation (increasing concave downward contours). The low composite RSD region changes with fill error probability, while the high composite RSD region does not. This suggests that composite RSD dominates CU failure predictably in a manner dependent on fill count. CU failure probability was sensitive to changes in fill count, composite RSD, and fill error probability. Generally, increases in fill count resulted in lower probability of CU failure, while increases in composite RSD and fill error probability resulted in increased probability of failure.

FIG. 13 shows a set of 30 contour plots illustrating the probability of stage 1 and stage 2 content uniformity batch failure and acceptance values (AV) modeled as a function of sachet fill count (horizontal axes), composite RSD of bulk mini-tablets (vertical axes), and fill error probability per mini-tablet filled (rows). As shown in FIG. 13, at relatively low fill error probability, probability of CU failure increases with an increase in each of the three parameters modeled. At relatively high fill error probabilities, probability of failure may increase or decrease with increasing fill count. This phenomenon may be explained by the fact that increasing the fill count not only decreases the assay variance relative to the assay mean, but it also increases the probability of fill errors occurring. As in the other figures containing contour plots, the probability of CU failure (colormap and contours) is logarithmically spaced. Composite RSD refers to the content of bulk mini-tablets rather than to content of sachets. Fill error probability is the probability of a single error occurring for each mini-tablet filled into a sachet (i.e. it is not the probability that a sachet would have an error). Tabulated values for the contour plots shown in FIG. 13 may be found in Section 2.2 of the Supplementary Information below.

Notably, a significant decrease in stage 2 failure probability (>100-fold) was found at the transitions between n=4 and n=5 count and n=8 to n=9 count for low composite RSDs (<5%). This phenomenon is an artifact resulting from application of the USP <905> specification's anticipation of Gaussian content variance to a drug product with non-Gaussian variance arising from discrete fill errors. Interestingly, increasing fill count sometimes adversely impacted CU failure probability. For example, in the cases of 0.01% and 0.1% fill error probabilities and low composite RSDs (0%-3%), increasing fill count from n=1 to n=3 or from n=5 to n=7 increased CU failure probability slightly.

While CU failure probability was sensitive to all parameters modeled, AV values varied little across fill error probabilities. Similarity in AV values across fill error probabilities from 0% to 0.1% suggests that fill errors in this range would not likely be reflected in AV values experimentally even if large sample sizes were used.

FIG. 14 shows a set of twenty-four contour plots illustrating the probability of stage 1 and stage 2 content uniformity batch failure and acceptance values (AV) modeled as a function of sachet fill count (horizontal axes), fill error probability per mini-tablet filled (vertical axes), and composite RSD (rows). Tabulated values for the contour plot shown in FIG. 14 may be found in the tables of Section 2.3 of the Supplementary Information below.

### Explanation of Unintuitive Impact on CU Failure

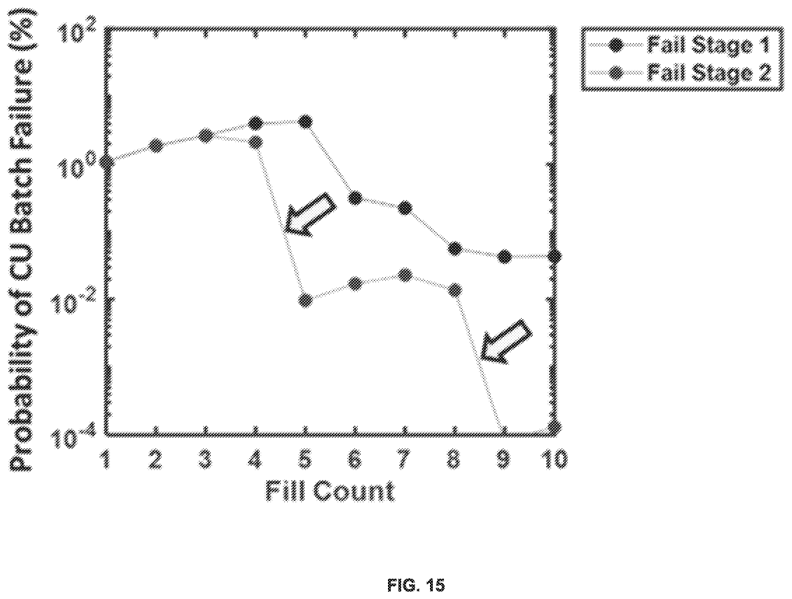

Embodiments of the present Invention may be used to inform fill count selection in mini-tablet manufacturing due to the fact that greater sachet fill counts generally lead to lower probabilities of failing CU. Two unintuitive observations are worth noting. First, CU failure probability decreases sharply when transitioning from 4 to 5 count and from 8 to 9 count at low root square RSDs (see FIG. 15, discussed below). Second, increasing fill count may sometimes worsen CU failure probability (As shown in FIG. 12, discussed above). Note the increase in failure probability at fill count of 2-4 compared to fill count of 1 while holding composite RSD constant between 0% and 5% for fill error probabilities >0.001%.

To the first point, FIG. 15 shows a plot of the probability of stage 1 or stage 2 CU failure for an example product having 2% composite RSD and 1% fill error probability. Note, these data are the same data plotted in FIGS. 12 and 13, but the data are represented in two dimensions for ease of visualization. Importantly, there are very sharp probability transitions (indicated by the two arrows in the plot of FIG. 15) occurring between sachet fill counts of 4 to 5 mini-tablets and 8 to 9 mini-tablets. More specifically, a sharp transition exists at low standard deviations where probability of CU failure is as much as 100-fold lower for a 5-count compared to 4-count fill. This sharp transition is an artifact of non-Gaussian content variance due to fill count errors. Typically, the variance of sachet contents should decrease proportionally to the reciprocal of fill count, as sachet content is the sum of individual mini-tablet contents (normal random variables). However, due to fill count errors: 1) CU failure is driven by miscounts rather than weight or potency variation at low standard deviations, and 2) failure occurs when one or more unit label claim is outside of ±25% of the mean. A single miscount for a target 4-count fill results in a ±25% dosage error on average (triggering batch failure according to USP <905> criteria), while for a 5-count it would result in a ±20% dosage error, which is below the critical USP <905> threshold. Careful observation at high fill error probability shows a similar transition between 8-count and 9-count fill targets for the same reasons. An 8-count product may fail when two miscounts occur (2 in 8, also ±25%). However, 2 miscounts would not cause failure of a 9-count product (2 in 9, 22%). The probability of observing two miscounts is much lower than for 1 miscount and only appreciably occurs at large fill error probabilities.

To the second point, CU failure probability occasionally increases with increasing fill count, as in the case of moving from 1-count to 4-count. This is observed for non-zero fill error probability and low standard deviation (See FIG. 14). One might have contrarily expected that greater fill counts result in lower CU failure probability as assay variance should decrease. However, fill errors (rather than product weight or potency variance) drive failure in the low standard deviation regime. Consider fill counts ranging from 1 to 4. A single fill error will cause batch failure in CU testing for any of these, as assay would deviate by more than ±25%. The probability of observing just one fill error is proportional to the number of chances for a fill error to occur. Since each mini-tablet independently carries a miscount probability, larger fill counts carry increased risk of observing a single error. Roughly, the probability of a single miscount for a 4-count fill is 4 times that of a 1-count fill, thus explaining the unintuitive increase in CU failure probability on that range.

### Unexpected Results

Surprisingly, AV values alone are imperfect indicators of CU failure probability. As shown in FIG. 14, mean AV values were nearly identical for all fill error probabilities modeled, despite marked differences in CU failure probabilities across these fill error probabilities. Therefore, AV values are not, on average, sensitive to fill errors and are poor indicators of product CU risk. It should be cautioned against using AV values alone for risk assessments or comparison of product dosage uniformity. To illustrate this point, it is noted that a 4-count product with 5% composite RSD will, on average, have the same AV value (AV=6%) across all fill error probabilities modeled, yet the probability of failing CU across these error probabilities ranges from <0.0001% at 0% fill error probability to 1% at 0.1% fill error probability. Failure to consider insensitivity of AV values to fill errors may result in false confidence in product risk analyses. This insensitivity may be explained by the fact that mean AV values are weakly affected by low-frequency failure events. Though occurring at low enough frequency as to be unresolved by AV values, a 1% CU failure probability, for example, is meaningful to product developers.

### Use Cases Illustrated as Scenarios Encountered in Mini-tablet Drug Product Development

Use cases are presented below to illustrate how model results may inform product development. Generally, these examples are concerned with stage 2 failure probabilities, though the same principles apply to stage 1 failure probabilities—the appropriate plot need simply be used from FIGS. 13 and 14. Caution is recommended when interpreting mean AV values, as they were found to be insensitive to fill error probability in some cases. They may be used to predict the expected value which would be observed experimentally, but should not be used to predict fill error probabilities.

### Use Case No. 1

A scientist is developing a new 4-tablet per mini-tablet product, and the weight RSD, potency RSD and fill error probability of the process were measured experimentally. The scientist needs to determine the probability of failing the CU testing requirements for the 4-tablet per sachet mini-tablet product based on the experimental measurements. Thus, the input parameters are as follows:

$$\begin{matrix}Weight RSD = 5. \% \\ Potency RSD = 5. \% \\ Fill error probability = 0.001 \% \\ Fill count = 4\end{matrix}$$

Solution Step 1: Calculate composite RSD:

$$Composite RSD = \sqrt{{( Weight RSD )}^{2} + {( Potency RSD )}^{2}} \\ Composite RSD = \sqrt{5. {\%}^{2} + 5. {\%}^{2}} = 7.1 \%$$

Solution Step 2: Use the model results (shown in the contour plots of FIG. 12) and the calculated composite RSD above (7.1%) to determine the probability of stage 2 failure.

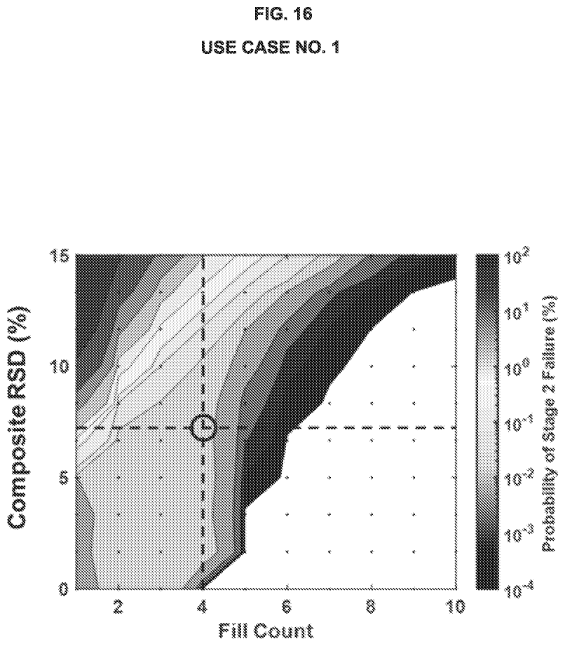

Conclusion: FIG. 16 shows the contour plot (selected from FIG. 12) corresponding to the calculated composite RSD of 7.1% (on the vertical axis) and a fill count of 4 (on the horizontal axis). Because the intersection of the dotted lines in FIG. 16 falls within the band representing approximately 0.01% probability, the probability of failing CU for the specified product configuration is approximately 0.01%.

### Use Case No. 2

A scientist is developing a new mini-tablet product, and the weight RSD and potency RSD of the process were measured experimentally. They wish to calculate the fill counts for which the probability of failing CU is less than 0.01%, given the following known parameters:

$$\begin{matrix}Weight RSD = 2. \% \\ Potency RSD = 1. \% \\ Fill error probability = 0.01 \% \\ Fill count = ? \\ Probability of failing CU = < 0.01 \%\end{matrix}$$

Solution Step 1: Calculate the composite RSD:

$$Composite RSD = \sqrt{{( Weight RSD )}^{2} + {( Potency RSD )}^{2}} \\ Composite RSD = \sqrt{1. {\%}^{2} + 2. {\%}^{2}} = 2.2 \%$$

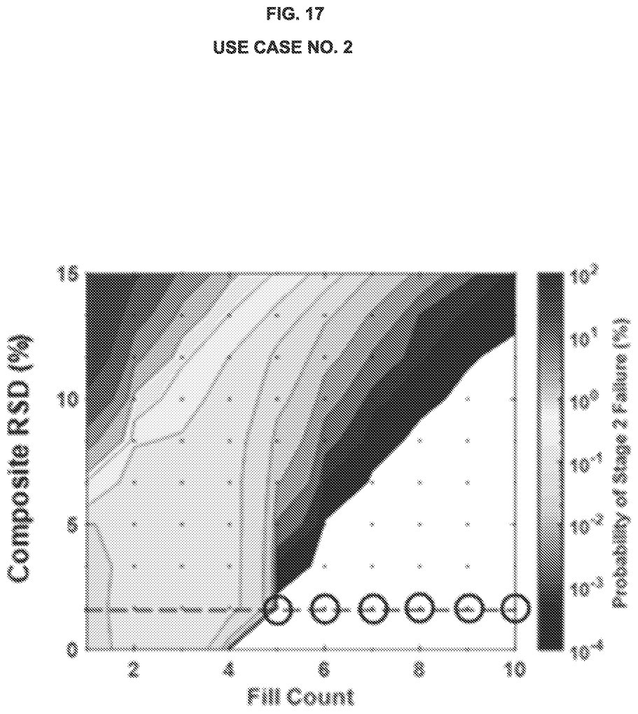

Solution Step 2: FIG. 17 shows a contour plot of failure probabilities in stage 2 as a function of composite RSD and fill count. Determine the fill counts for which the probability of failing CU is less than 0.01% at 2.2% composite RSD using FIG. 17:

Conclusion: According to the plot shown in FIG. 17, for a composite RSD of 2.2% (indicated by the horizontal dotted line in FIG. 17), the fill counts for which the probability of failure would be less than 0.01% for the given process parameters are 5, 6, 7, 8, 9, and 10-counts (and likely >10 count as well).

### Use Case No. 3

A scientist wishes to know the maximum acceptable weight RSD allowed to ensure that the probability of CU failure will be below 0.0001% for a product having a fill count of 10 mini-tablets. The fill error probability is estimated to be 0.1% experimentally and potency RSD is measured experimentally to be 5.0%. The input parameters are as follows:

$$\begin{matrix}Weight RSD = ? \\ Potency RSD = 5. \% \\ Fill error probability = 0.1 \% \\ Fill count = 10 \\ Probability of failing CU = < 0. 001 \%\end{matrix}$$

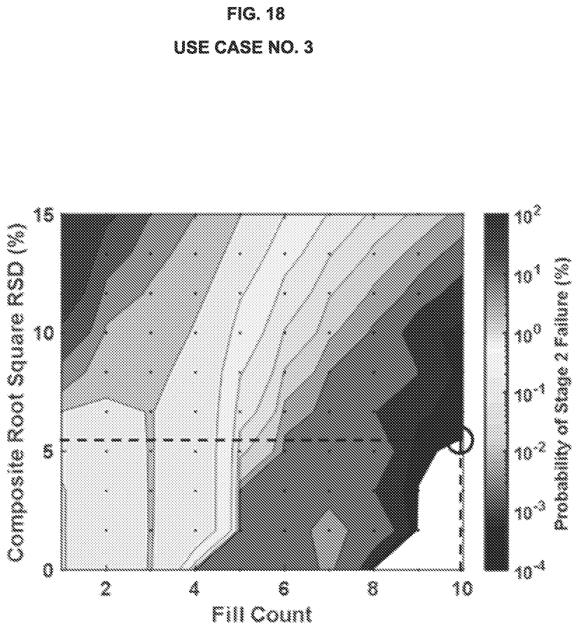

Solution Step 1: FIG. 18 shows another contour plot of failure probabilities in stage 2 as a function of composite RSD and fill count. Using the contour plot of FIG. 18, determine composite RSD corresponding to 0.0001% probability of failing CU for a 10-count product using the model prediction for 0.1% fill error probability. Follow the horizontal axis to the desired fill count of 10, and trace a line up to the point where the probability of failing CU is 0.0001% (the boundary between the dark 10⁻⁴ region and the white region). Then trace a line to the vertical axis to read the composite RSD value (approximately 5.1%) corresponding to this point.

Solution Step 2: Calculate the maximum acceptable weight RSD by rearranging the equation for composite RSD:

$$Composite RSD = \sqrt{{( Weight RSD )}^{2} + {( Potency RSD )}^{2}}$$

After rearranging for Weight RSD:

$$Weight RSD = \sqrt{{( Composite RSD )}^{2} + {( Potency RSD )}^{2}} \\ Weight RSD = \sqrt{5.1 {\%}^{2} + 5. {\%}^{2}} = 1. \%$$

Conclusion: The maximum acceptable weight RSD is 1.0%. Assuming the weight is reasonably controlled for this product, the risk of failing CU is low.

### Use Case No. 4

A scientist wishes to predict the expected AV from experimentally measured potency RSD and weight RSD prior to receiving experimental CU results for a recently manufactured batch, since the results may take some time to arrive. The fill error probability is 0%, since the batch was hand-filled with double visual inspection. The product uses a fill count of 1. The input parameters are as follows:

$$\begin{matrix}Weight RSD = 5. \% \\ Potency RSD = 2.5 \% \\ Fill error probability = 0 \% \\ Fill count = 1 \\ Expected AV value = ?\end{matrix}$$

Solution Step 1: Determine the AV for a 1-count fill with weight RSD of 5.0% and potency RSD of 2.5% from FIG. 12. Draw a vertical line intersecting the horizontal axis at potency RSD equal to 2.5% and a horizontal line intersecting the vertical axis at potency RSD equal to 5.0%. Read the color bar at the intersection of these lines to determine AV value.

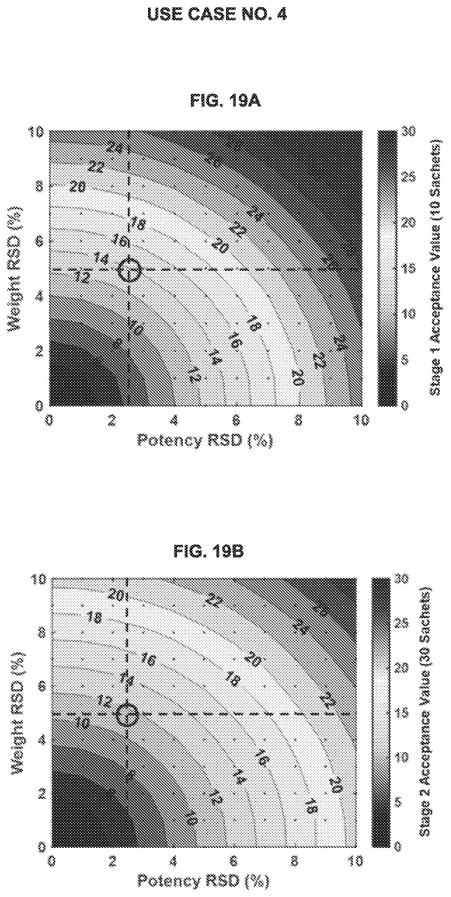

Conclusion: FIGS. 19A and 19B show a closer view of two relevant contour plots in FIG. 12 corresponding to the mean stage 1 and stage 2 acceptance values for weight and potency RSDs ranging from 0 to 10. Each one of the curved bands in these plots represents a different acceptance value based on the location of the intersections of the horizontal and the vertical dotted lines, the plots in FIGS. 19A and 19B show that the mean stage 1 AV is 14 and the mean stage 2 AV is approximately 12. Note, the plots for a 1-count product are applicable to adult tablets as well since the computations are identical.

### Use Case No. 5

A scientist wishes to know the maximum acceptable fill error probability during the sachet filling process to achieve a desired target CU failure risk. The scientist would like to communicate this specification to the process engineer's operating equipment.

Problem: Determine the maximum allowable fill error probability for a product with the following specifications:

$$\begin{matrix}Weight RSD = 3. \% \\ Potency RSD = 3. \% \\ Fill error probability = ? \\ Fill count = 6 \\ Allowed probability of failing CU = 0.01 \%\end{matrix}$$

Solution Step 1: Calculate the composite RSD:

$$Composite RSD = \sqrt{{( Weight RSD )}^{2} + {( Potency RSD )}^{2}} \\ Composite RSD = \sqrt{3. {\%}^{2} + 3. {\%}^{2}} = 4.2 \%$$

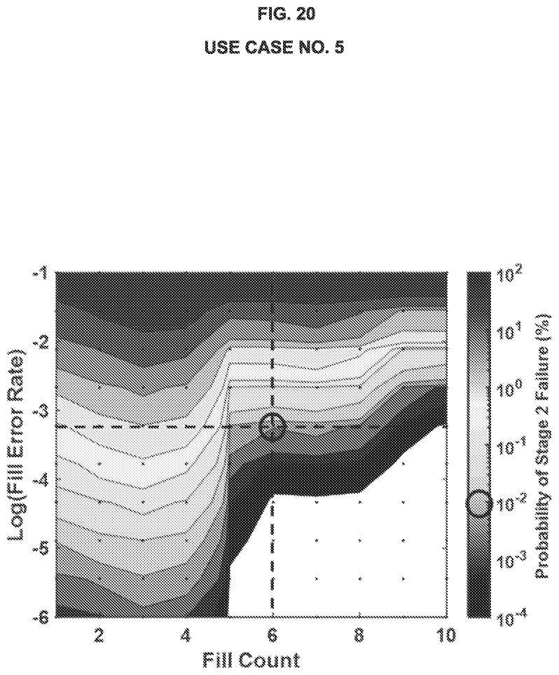

Solution Step 2: Determine the maximum allowable fill error probability using the plot from FIG. 15 for a 4% composite RSD product with a 6-count sachet fill and acceptable content uniformity failure probability of 0.01%: FIG. 20 shows a contour plot of probability of Stage 2 failure as a function of the log-transformed fill error rate vs. fill count. From the plot shown in FIG. 20, the log-transformed fill error probability corresponding to a 0.01% maximum content uniformity failure probability is approximately −0.8. This results in a log fill error probability of −0.8 which equals a fill error probability of approximately 10-0.8=0.16% probability per mini-tablet.

Conclusion: The maximum acceptable fill error probability corresponding to the desired content uniformity failure probability of 0.01% is approximately 0.16% (16 errors per 10,000 mini-tablets filled). On average this equates to 16 defective sachets allowed per 1,667 produced (since 10,000 granules will fill 1,667 sachets in this case).

### Exemplary Algorithm for Calculating Probability of Batch Failure and USP <905> Acceptance Values

The following algorithm illustrates how to calculate probability of batch failure and USP <905> acceptance values according to one example of the present invention. This algorithm may be programmed and executed in a MATLAB script, for example, or any other suitable programming language or platform, depending on the circumstances and resources available.

### Beginning of Algorithm

1. Clear all variables.
2. Define and initialize variables.
a. Random Number Generator—set to ‘simdTwister’ (one example of a number of random number generator algorithms available in MATLAB). The simdTwister random number generator may be preferred because it typically reduces computation time compared to other random number generators.
b. Sample Size—number of sets of sachets (‘N’) to be generated.
c. Precision—desired certainty of probability of failure estimate. Sets the bounds within which the 95% confidence interval must lie to accept the estimated probability of batch failure. For example, if precision is set to 1.2, the 95% confidence interval must lie within 1.2 times the calculated mean.
d. Limit of Detection—sets the minimum value for which the algorithm will pursue the desired precision. For example, if set to 1×10-6, the model will discontinue further calculations if the upper 95% confidence interval is less than 1×10-6.
e. Potency RSD—defines the relative standard deviation (RSD) used to generate random mini-tablet potencies.
f. Weight RSD—defines the relative standard deviation (RSD) used to generate random mini-tablet weights.
g. Fill Count—sets the target number of mini-tablets in each sachet.
h. Target Potency—sets the intended potency of mini-tablets.
i. Batch Average Potency—defines batch average potency used to generate random mini-tablet potencies.
j. Batch Potency RSD—sets batch relative standard deviation (RSD) of mean mini-tablet potency.
k. Target Weight—sets the intended weight of mini-tablet.
l. Batch Average Weight—defines batch average weight used to generate random mini-tablet potencies.
m. Batch Weight RSD—sets batch relative standard deviation (RSD) of mean mini-tablet weight.
3. Generate ‘N’ sets of 30 random sachet assays.
a. Generate random sachet fill counts according to Bernoulli distribution.
b. Generate random batch mean mini-tablet weight and potency according to normal distribution (normalized by target weight and potency). These values serve as inputs for the normal distribution calculation in the following step.
c. Generate random mini-tablet weight and potency according to normal distribution (normalized by target weight and potency).
d. Calculate individual mini-tablet assays by multiplying mini-tablet weight and potency.
e. Calculate individual sachet assays by summing the mini-tablet assays within each sachet.
4. Apply USP criteria to determine batch failure rate and acceptance values.
a. Apply USP stage 1 criteria to calculated sets of sachet assays grouped in sets of 10 including calculation of acceptance values.
b. If a group of sachets fails stage 1 criteria, include an additional 20 sachets and apply the USP stage 2 criteria including calculation of acceptance values.
c. Count number of sets which fail USP <905> criteria and add to previous iteration count if applicable.
d. Divide failed trial count by total trial count to obtain percentage rate of failure.
e. Take average of acceptance values.
5. Determine if desired precision has been achieved by calculating 95% confidence interval and comparing to precision criteria. If not achieved, go to step 3.
6. Repeat steps 2 through 5 for desired combinations of input variable values.
7. Plot values in a contour map.

### End of Algorithm

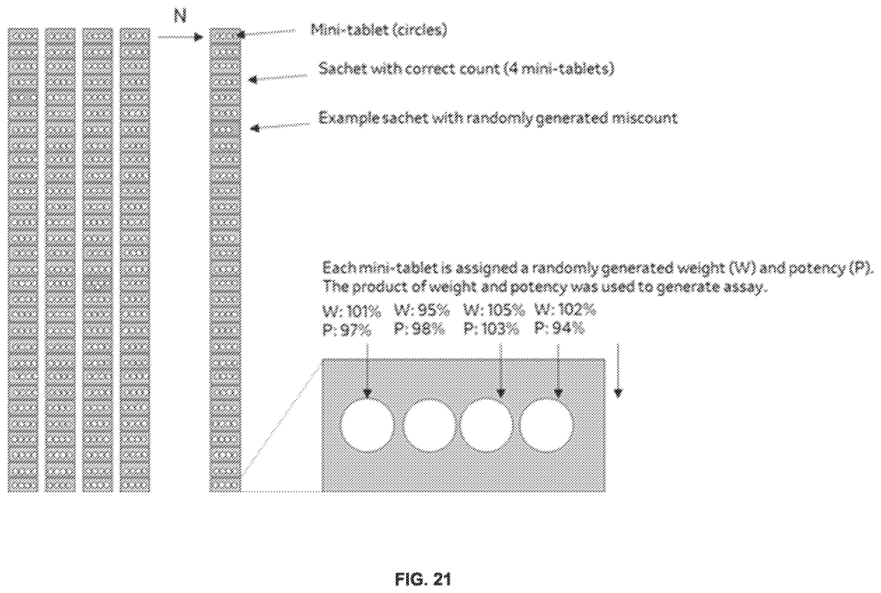

FIG. 21 shows a schematic diagram illustrating by way of example an algorithmic generation of sachets containing mini-tablets. As shown in FIG. 21, N sets of 30 sachets each are generated with random Bernoulli distributed fill errors and randomly distributed weights and potencies for each mini-tablet within each sachet. Each mini-tablet is assigned a randomly generated weight (W) and potency (P). Then, the product of (W) and (P) are used to generate the assay. Each set of sachets represents a trial against which USP <905> content uniformity specification is tested.

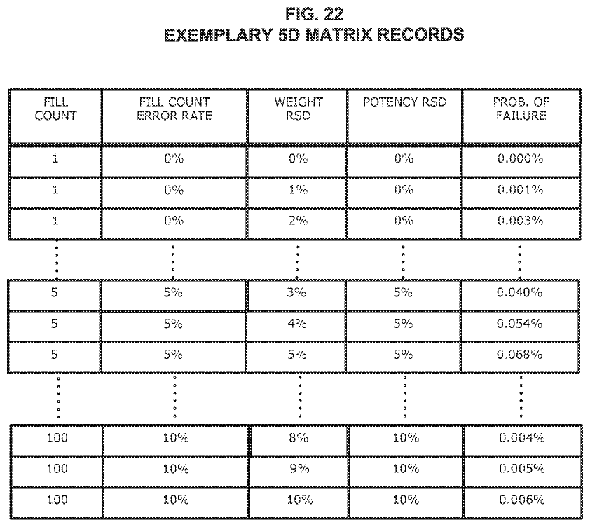

FIG. 22 shows a schematic diagram illustrating by way of example some of the values that may be stored in some of the records of the 5D matrix. Although the number of records shown in FIG. 22 is greater than the number of records shown in FIGS. 1 and 2, it will be noted that, for the sake of brevity, not all of the records of the 5D matrix are shown, as the database could have many dozens, many hundreds, or even many thousands of records, depending on the ranges of weight RSDs and sachet fill errors specified by the end user, and the values shown in the fields of the records in FIG. 22 are merely representative.

### Supplementary Information Section 1-Methods

### A. Calculation of Normalized Sachet Content

Normalized sachet content (χ) was modeled as the product of normally distributed random individual mini-tablet weights (w), and potency values (A) normalized by the target weight (w_{Target}) and assay (A_{Target}) values:

$$w = \frac{N ( {μ}_{w} , {σ}_{w}^{2} )}{{w}_{Target}} \qquad S1$$

$$A = \frac{N ( {μ}_{A} , {σ}_{A}^{2} )}{{A}_{Target}} \qquad S2$$

$$χ = w \times A \qquad S3$$

where the notation N(x, y) indicates a random normal variable with mean x and variance y, μ_{w} is the observed mean weight of individual mini-tablets, σ_{w}² is the observed variance of individual mini-tablets, μ_{A} is the observed mean assay of individual mini-tablets, and σ²_{A} is the observed assay variance of individual mini-tablets. In this study, we represent variance as relative standard deviation (RSD), as is common practice in the field, which is simply the standard deviation divided by the mean:

$$Weight RSD = \frac{{σ}_{w}}{{μ}_{w}} \qquad S4$$

$$Potency RSD = \frac{{σ}_{A}}{{μ}_{A}} \qquad S5$$

Experimentally, sachet content and potency are often measured by liquid chromatography techniques to calculate content uniformity. It is worth noting that additional variance theoretically results from experimental measurement but was not accounted for in this model.

### B. Normalization of Individual Mini-Tablet Weight and Weight-Correction of Potency

Individual granule weights were normalized by the intended target weight. For example, a mini-tablet weighing 11 mg with intended target 10 mg weight would have a normalized weight of 1.1 (110%). Therefore, the model results do not change for various target weights or potencies. Furthermore, individual mini-tablet potencies were weight-normalized so that the normalized potency may be interpreted as blend uniformity, or in other words, the superpotency or subpotency of the individual mini-tablet irrespective of its weight.

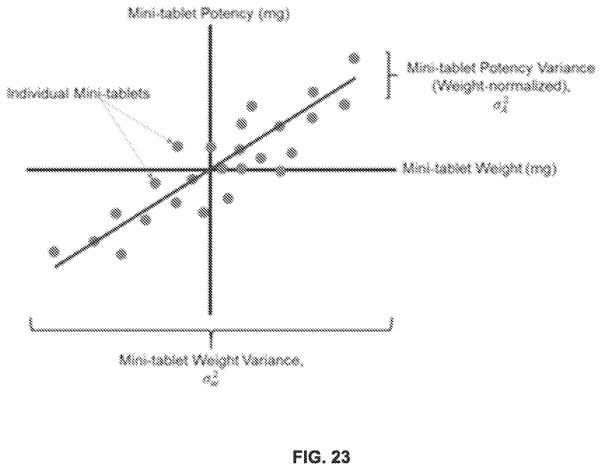

To help illustrate this point, FIG. 23 shows graphically the weight and potency variances. Users intending to use the model results to predict CU outcomes should record experimentally the weight RSD for a sample of mini-tablets and calculate the potency RSD as a weight-normalized value. Each point in the graph of FIG. 23 represents a single simulated mini-tablet plotted with respect to weight and potency value (note, data for illustration only, not simulated). The weight variance is measured from the distribution of weights. The potency variance is the variance of the residuals of the regression of potency against weight (i.e., the weight normalized potency).

### C. Fill Errors Modeled Using Binomial Distribution

Weight and potency are continuous variables and assumed to be normally distributed. In contrast, fill count errors were assumed to be discrete and thus Binomial distributed (1). Probability, P_{k miscounts}, of encountering ‘k’ miscounts in ‘n’ filled mini-tablets was calculated using the Binomial probability:

$${P}_{k miscounts} = {}_{n} {C}_{k} \times {( 1 - p )}^{( n - k )} \times {p}^{k} \qquad S6$$

where p is the fill error probability represented as the probability of a miscount per mini-tablet filled into a sachet. Implicitly, this distribution assumes independence of miscount events and accounts for the possibility of multiple miscounts per sachet.

The following example illustrates implementation of Equation S6 in the model. Assume a product is manufactured with target count of 3 mini-tablets per sachet. Assume the probability of a miscount for each individual mini-tablet being filled is 1 in 100 (1%)

$$n = 3 p = 0.01$$

k is any number from 0 to 3
Pk miscounts is the probability of observing a fill count of ‘k’
By iterating through values of k from 0 to 3, the probability of observing k miscounts is calculated using Equation S6:

$${P}_{0 miscounts} = {}_{3} {C}_{0} \times {( 1 - 0.01 )}^{3} \times {0.01}^{0} = 0.9 \; 70299 \qquad S6 \text{.1}$$

$${P}_{1 miscounts} = {}_{3} {C}_{1} \times {( 1 - 0.01 )}^{2} \times 0.0 {1}^{1} = 0.029 \; 403 \qquad S6 \text{.2}$$

$${P}_{2 miscounts} = {}_{3} {C}_{2} \times {( 1 - 0.01 )}^{1} \times 0.0 {1}^{2} = 0.000297 \qquad S6 \text{.3}$$

$${P}_{3 miscounts} = {}_{3} {C}_{3} \times {( 1 - 0.01 )}^{0} \times {0.01}^{3} = 0.000001 \qquad S6 \text{.4}$$

1) The above probabilities may be used to randomly generate the number of miscounts (in this case, a number 0 to 3) assuming the errors are all in the same direction. The above equation indicates the number of errors in a sachet but not the “direction” of the errors (i.e. overfill versus underfill). It is important to account for the net effect of errors in both directions (the difference between the overfills and underfills) because they may cancel each other out, resulting in a sachet fill count error which is less than the total number of fill errors.
2) To account for the possibility that the fill count errors are not in the same direction, the algorithm of the present invention then assigns a +1 or −1 value randomly with 50% probability for each error indicating an overfill (+1) or underfill (−1). The sum of under and over-fills is calculated and added to the target to arrive at the randomly generated sachet fill count. For example, if 3 errors were randomly generated using Equation S6, and these were assigned values of +1, −1, and +1, respectively, then the sachet would be assigned a fill count of 4 since for 3 fill events, because two of the errors resulted in an extra mini-tablet and one of the errors resulted in a missing mini-tablet.

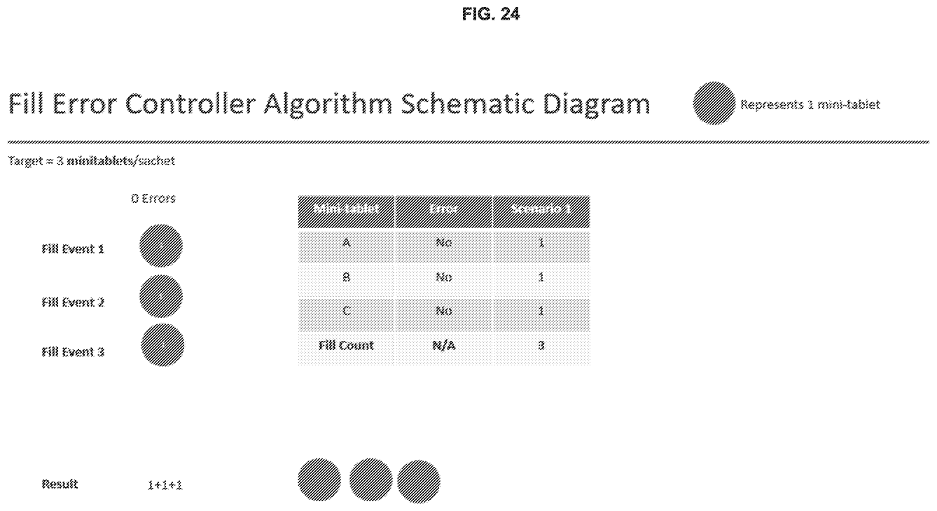

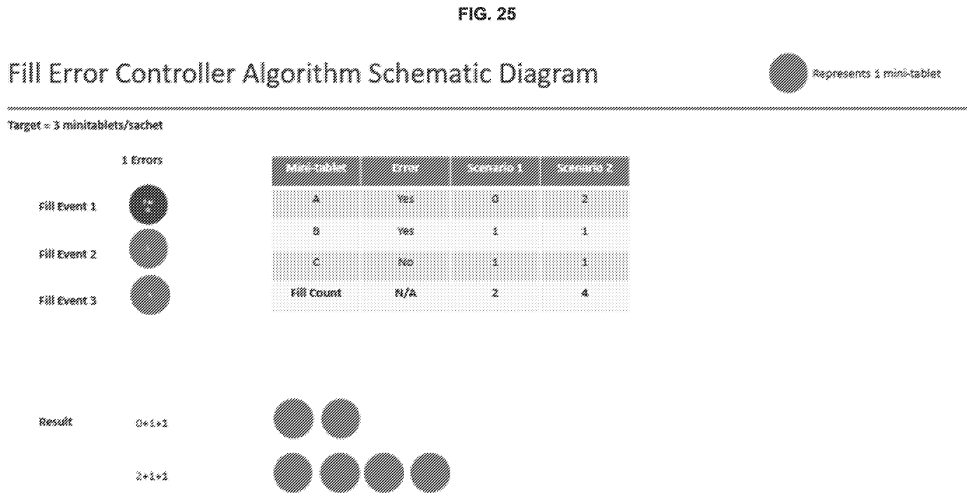

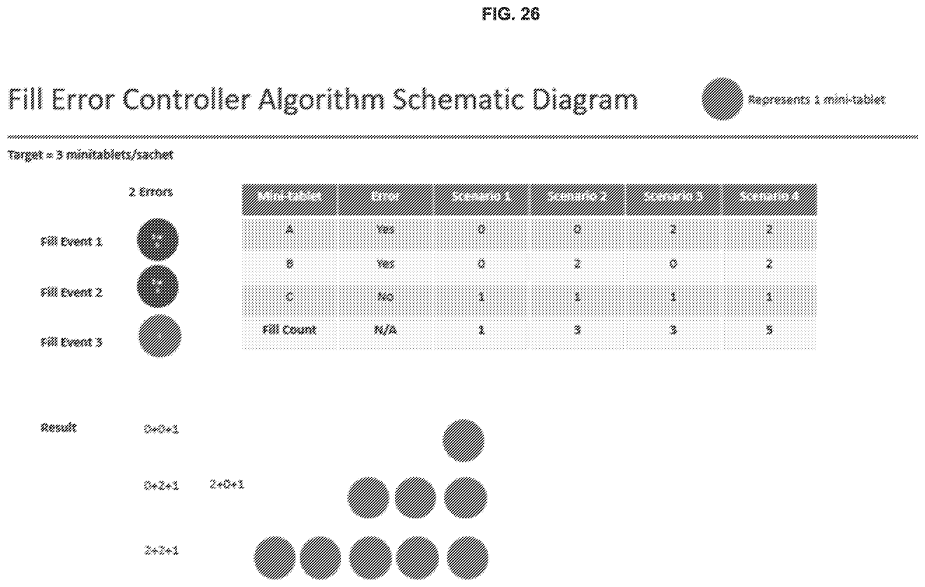

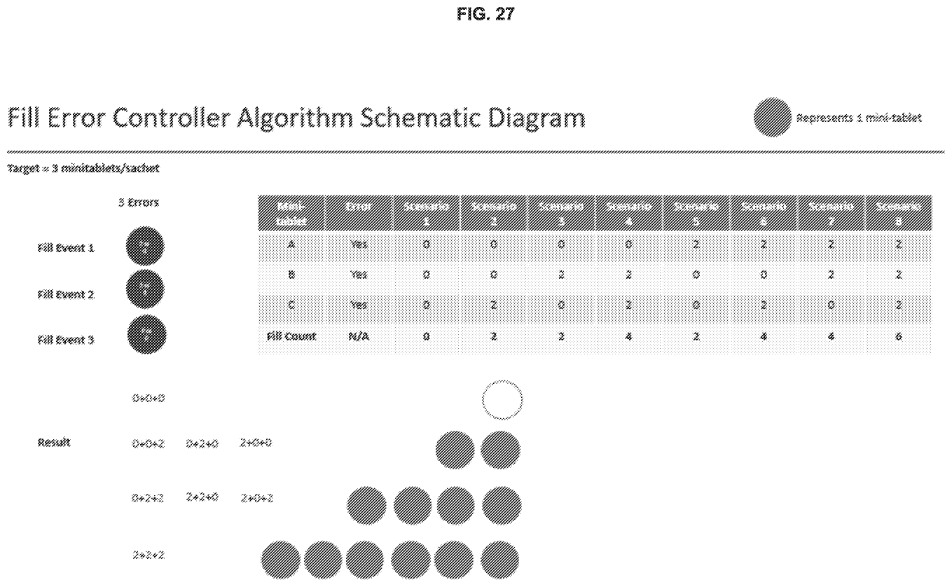

FIGS. 24-27 contain schematic diagrams illustrating the various scenarios and results associated with incurring one, two or three fill count errors in three fill events, wherein the goal (or target) is to fill sachets with three mini-tablets. FIG. 24 shows that, when there are no fill count errors in three fill events, there is only one possible outcome scenario and only one potential result under the algorithm described above, that result being a sachet that contains exactly three mini-tablets. FIG. 25 shows that, when there is one fill count error in three fill events, there are two possible outcome scenarios and two potential results under the algorithm described above, the first potential result being a sachet that contains two min-tablets instead of the target three mini-tablets, and the second potential result being a sachet that contains four mini-tablets instead of the target three-mini-tablets. FIG. 26 shows that, when there are two fill count errors in three fill events, there are four possible outcome scenarios and three potential results under the algorithm described above, those three potential results being a sachet that contains one, three or five mini-tablets, respectively. FIG. 27 shows that, when there are three fill count errors in three fill events, there are eight possible outcome scenarios and four potential results under the algorithm described above, those four potential results being a sachet that contains zero, two, four or six mini-tablets, respectively.

Mean of individual contents, X̅, was calculated as the arithmetic mean of individual sachet contents, ‘χ’ for each set of sachets, and an acceptance value was calculated according to USP <905> specifications:

$$AV = \vert M - \overline{X} \vert + ks \qquad S7$$

where AV is the acceptance value, ‘M’ is a reference value (Table 1, with criteria reproduced from USP <905>), ‘k’ is the acceptability constant, and ‘s’ is the sample standard deviation of individual contents. The acceptance value was used to determine batch passage or failure according to USP <905> criteria as follows and outlined diagrammatically in FIG. 2.

TABLE 1
Conditions for determining USP <905> parameter,
M, used in the calculation of acceptance value (AV).

| | Conditions | Value |
|---|---|---|
| If target content | If 98.5% ≤ X̅ ≤ | M = X̅ (AV = ks) |
| is ≤101.5%, i.e., if | 101.5%, then | |
| batch target content | If X̅ ≤ 98.5%, | M = 98.5% |
| is equal to the target | then | (AV = 98.5 − X̅ + ks) |
| value of 100% (as was | If X̅ ≥ 101.5%, | M = 101.5% |
| assumed in this study) | then | (AV = X̅ − 101.5 + ks) |

### Stage 1 Passing Criteria:

$$AV < L 1 \qquad S8$$

where L1 equals 15%. Stage 2 passing criteria:

$$AV < L 2 \qquad S9$$

where L1=25%. To pass Stage 2, all individual contents must also meet the following criteria:

$$χ > ( 1 - ( 0.01 ) ( L 2 ) ) M \qquad S10$$

$$χ < ( 1 + ( 0.01 ) ( L 2 ) ) M \qquad S11$$

Finally, the probability of failing either stage 1 or stage 2 was calculated as the number of failed batches divided by the number of simulated batches:

$${p}_{failure} = \frac{\# failed batches}{\# simulations} \times 100 \% \qquad S12$$

The model simulated trials successively until the 95% confidence intervals of failure probability were within 2-fold multiples of the mean. For example, if after 1,000,000 simulations, the failure probability was calculated to be 5×10⁻³% with 95% confidence intervals of 2×10⁻³% and 12×10⁻³%, the model would continue increasing the number of iterations until the 95% confidence intervals fell within 2.5×10⁻³% and 10×10⁻⁵%. Failure probabilities with upper 95% confidence interval converging below 1×10⁻⁴% were recorded as below limit of detection and appear as white space on the figure contour maps.

### D. Simplification of Weight and Potency RSD Parameters

In a study, the inventor of the present invention calculated an assay as the product of normally distributed mini-tablet weight and normally distributed mini-tablet potency. Weight and potency were each normalized by target weight and potency, respectively, so that the expected value of the means was equal to 1. Here the simplification of weight RSD and potency RSD into a single parameter, composite RSD, is justified mathematically. The composite RSD is justified mathematically since it is a simplification of the product of two random normal variables (as is present in this study). As defined in the main text, composite RSD is:

$$Composite RSD = \sqrt{{( Weight RSD )}^{2} + {( Potency RSD )}^{2}} \qquad S13$$

The notation may be generalized for any two random normal variables having means μ_{w} and μ_{A} and variances σ_{w}² and σₚ², respectively as in Section S1.1. The composite mean and variance will be defined as μ_{C} and σ_{C}²:

$$\frac{{σ}_{C}}{{μ}_{C}} = \sqrt{{( \frac{{σ}_{w}}{{μ}_{w}} )}^{2} + {( \frac{{σ}_{A}}{{μ}_{A}} )}^{2}} \qquad S14$$

In this study, mean mini-tablet weight and potency were equal to 1 since they were normalized by target weight and potency. Therefore, the relative standard deviations (defined as standard deviation divided by mean) are equivalent to the standard deviations:

$${σ}_{C} = \sqrt{{σ}_{w}^{2} + {σ}_{A}^{2}} \qquad S15$$

It has been shown previously that the variance of the product of two random normal variables is as follows (2):

$${σ}^{2} = {μ}_{1}^{2} {σ}_{1}^{2} + {μ}_{2}^{2} {σ}_{2}^{2} + {σ}_{1}^{2} {σ}_{2}^{2} \qquad S16$$

Where σ² is the variance of the product of random normal variables, μ₁ and μ₂ are the means of the first and second random normal variables, respectively, and σ₁² and σ₂² are the variances of the first and second random normal variables respectively. Since means were equal to 1 in the present study, equation S16 simplifies to:

$${σ}^{2} = {σ}_{1}^{2} + {σ}_{2}^{2} + {σ}_{1}^{2} {σ}_{2}^{2} \qquad S17$$

If the standard deviations of each random normal variable are small (for example ≤0.15 as in this study), then their product, σ₁²σ₂², is much smaller than their sum, σ₁²+σ₂²:

$${σ}_{1}^{2} {σ}_{2}^{2} = {( 0.15 )}^{2} {( 0.15 )}^{2} = 0.0005 \; 01625 \qquad S18$$

$${σ}_{1}^{2} + {σ}_{2}^{2} = {( 0.15 )}^{2} + {( 0.15 )}^{2} = 0.045 \qquad S19$$

The product may be assumed negligible compared to the sum in this study, and therefore the approximation for variance of the product of two random normal variables in Equation S17 further simplifies to:

$${σ}^{2} = {σ}_{1}^{2} + {σ}_{2}^{2} \qquad S20$$

Final rearrangement to calculate standard deviation yields:

$$σ = \sqrt{{σ}_{1}^{2} + {σ}_{2}^{2}} \qquad S21$$

Which is identical to Equation S15 and therefore identical to the composite RSD. Thus, it is shown that for the values of mean and variance used in this study, the composite RSD is a reasonable approximation for the RSD of the product of two random normal variables.

### Supplementary Information Section 2

The tables below contain values calculated by the model and used to generate the contour maps in FIGS. 12 through 14.

### Supplementary Information Section 2.1—Tables of Calculated Values Corresponding to FIG. 12

Stage 1 Failure Probability (%)
Fill Count = 1

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Com- | 15.00 | 96.6 | 96.7 | 97.1 | 97.7 | 98.2 | 98.8 | 99.2 | 99.4 | 99.7 | 99.8 |
| posite | 13.33 | 92.4 | 92.7 | 93.8 | 95.1 | 96.4 | 97.6 | 98.4 | 99.1 | 99.4 | 99.6 |
| RSD | 11.67 | 83.2 | 84.1 | 86.5 | 89.6 | 92.8 | 95.3 | 97.2 | 98.3 | 99.0 | 99.5 |
| (%) | 10.00 | 64.2 | 66.3 | 71.6 | 78.8 | 85.7 | 91.2 | 94.9 | 97.1 | 98.5 | 99.2 |
| | 8.33 | 33.8 | 37.1 | 46.5 | 59.7 | 73.3 | 84.1 | 91.2 | 95.3 | 97.6 | 98.8 |
| | 6.67 | 6.63 | 8.89 | 17.3 | 33.8 | 54.9 | 73.3 | 85.8 | 92.8 | 96.5 | 98.2 |
| | 5.00 | 0.0772 | 0.229 | 1.94 | 11.5 | 33.8 | 59.7 | 78.7 | 89.7 | 95.1 | 97.7 |
| | 3.33 | <1.00E−04 | <1.00E−04 | 0.0199 | 1.95 | 17.4 | 46.5 | 71.7 | 86.4 | 93.8 | 97.2 |
| | 1.67 | <1.00E−04 | <1.00E−04 | <1.00E−04 | 0.223 | 8.89 | 37.1 | 66.2 | 84.1 | 92.8 | 96.8 |
| | 0.00 | <1.00E−04 | <1.00E−04 | <1.00E−04 | 0.0752 | 6.61 | 33.7 | 64.2 | 83.0 | 92.4 | 96.6 |

Stage 2 Failure Probability (%)
Fill Count = 1

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Com- | 15.00 | 29.5 | 30.8 | 34.5 | 40.8 | 49.6 | 60.0 | 71.0 | 80.9 | 88.6 | 93.9 |
| posite | 13.33 | 12.0 | 12.9 | 15.6 | 20.8 | 28.7 | 39.8 | 53.3 | 67.1 | 79.6 | 88.6 |
| RSD | 11.67 | 3.03 | 3.42 | 4.82 | 7.79 | 13.2 | 22.1 | 34.9 | 50.9 | 67.2 | 80.8 |
| (%) | 10.00 | 0.351 | 0.425 | 0.830 | 1.91 | 4.58 | 10.1 | 20.0 | 34.9 | 53.3 | 70.9 |
| | 8.33 | 0.00900 | 0.0140 | 0.0558 | 0.255 | 1.09 | 3.73 | 10.1 | 22.1 | 39.9 | 60.0 |
| | 6.67 | <1.00E−04 | <1.00E−04 | 0.000746 | 0.0130 | 0.167 | 1.09 | 4.54 | 13.3 | 28.9 | 49.6 |
| | 5.00 | <1.00E−04 | <1.00E−04 | <1.00E−04 | 0.000288 | 0.0155 | 0.264 | 1.92 | 7.83 | 20.8 | 40.8 |
| | 3.33 | <1.00E−04 | <1.00E−04 | <1.00E−04 | <1.00E−04 | 0.000794 | 0.0527 | 0.818 | 4.84 | 15.7 | 34.7 |
| | 1.67 | <1.00E−04 | <1.00E−04 | <1.00E−04 | <1.00E−04 | <1.00E−04 | 0.0153 | 0.430 | 3.45 | 12.9 | 31.0 |
| | 0.00 | <1.00E−04 | <1.00E−04 | <1.00E−04 | <1.00E−04 | <1.00E−04 | 0.00950 | 0.343 | 3.04 | 12.0 | 29.5 |

Stage 1 Acceptance Value (%)
Fill Count = 1

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Com- | 15.00 | 25 | 25 | 26 | 26 | 27 | 29 | 30 | 32 | 34 | 36 |
| posite | 13.33 | 22 | 22 | 23 | 24 | 25 | 26 | 28 | 30 | 32 | 34 |
| RSD | 11.67 | 19 | 20 | 20 | 21 | 22 | 24 | 26 | 27 | 30 | 32 |
| (%) | 10.00 | 17 | 17 | 17 | 18 | 20 | 22 | 23 | 26 | 28 | 30 |
| | 8.33 | 14 | 14 | 15 | 16 | 18 | 20 | 22 | 24 | 26 | 29 |
| | 6.67 | 11 | 11 | 12 | 14 | 16 | 18 | 20 | 22 | 25 | 27 |
| | 5.00 | 8.4 | 8.8 | 10 | 12 | 14 | 16 | 18 | 21 | 24 | 26 |
| | 3.33 | 5.7 | 6.3 | 7.9 | 10 | 12 | 15 | 17 | 20 | 23 | 26 |
| | 1.67 | 2.9 | 4.1 | 6.3 | 8.8 | 11 | 14 | 17 | 20 | 22 | 25 |
| | 0.00 | 0 | 2.9 | 5.7 | 8.4 | 11 | 14 | 17 | 19 | 22 | 25 |

Stage 2 Acceptance Value (%)
Fill Count = 1

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Com- | 15.00 | 21 | 21 | 21 | 22 | 23 | 24 | 25 | 26 | 28 | 29 |
| posite | 13.33 | 18 | 19 | 19 | 20 | 21 | 22 | 23 | 24 | 26 | 28 |
| RSD | 11.67 | 16 | 16 | 17 | 18 | 19 | 20 | 21 | 23 | 24 | 26 |
| (%) | 10.00 | 14 | 14 | 15 | 15 | 17 | 18 | 20 | 21 | 23 | 25 |
| | 8.33 | 12 | 12 | 12 | 13 | 15 | 16 | 18 | 20 | 22 | 24 |
| | 6.67 | 9.4 | 9.6 | 10 | 12 | 13 | 15 | 17 | 19 | 21 | 23 |
| | 5.00 | 7.1 | 7.5 | 8.5 | 9.9 | 12 | 13 | 15 | 18 | 20 | 22 |
| | 3.33 | 4.7 | 5.3 | 6.7 | 8.5 | 10 | 12 | 15 | 17 | 19 | 21 |
| | 1.67 | 2.4 | 3.3 | 5.3 | 7.5 | 9.6 | 12 | 14 | 16 | 19 | 21 |
| | 0.00 | 0 | 2.4 | 4.7 | 7.1 | 9.4 | 12 | 14 | 16 | 18 | 21 |

Stage 1 Failure Probability (%)
Fill Count = 3
Fill Count

| | | 1 | 2 | 3 | 4 | 5 | 6 | 7 | 8 | 9 | 10 |
|---|---|---|---|---|---|---|---|---|---|---|---|
| Composite | 15.00 | 40.3 | 41.3 | 44.4 | 49.5 | 55.8 | 62.8 | 70.0 | 76.8 | 82.6 | 87.3 |
| RSD (%) | 13.33 | 21.5 | 22.7 | 26.1 | 31.7 | 39.3 | 48.5 | 58.3 | 67.6 | 75.9 | 82.6 |
| | 11.67 | 7.34 | 8.12 | 10.6 | 15.4 | 22.8 | 32.8 | 44.7 | 56.6 | 67.6 | 76.8 |
| | 10.00 | 1.08 | 1.33 | 2.30 | 4.73 | 9.79 | 18.5 | 30.6 | 44.6 | 58.3 | 70.1 |
| | 8.33 | 0.0330 | 0.0472 | 0.162 | 0.693 | 2.73 | 8.16 | 18.5 | 32.8 | 48.5 | 62.9 |
| | 6.67 | <1.00E−04 | <1.00E−04 | 0.00132 | 0.0314 | 0.418 | 2.73 | 9.78 | 22.8 | 39.3 | 55.8 |
| | 5.00 | <1.00E−04 | <1.00E−04 | <1.00E−04 | 0.000125 | 0.0321 | 0.693 | 4.71 | 15.3 | 31.6 | 49.4 |
| | 3.33 | <1.00E−04 | <1.00E−04 | <1.00E−04 | <1.00E−04 | 0.00145 | 0.162 | 2.30 | 10.6 | 26.1 | 44.5 |
| | 1.67 | <1.00E−04 | <1.00E−04 | <1.00E−04 | <1.00E−04 | <1.00E−04 | 0.0509 | 1.33 | 8.09 | 22.7 | 41.4 |
| | 0.00 | <1.00E−04 | <1.00E−04 | <1.00E−04 | <1.00E−04 | <1.00E−04 | 0.0302 | 1.10 | 7.31 | 21.6 | 40.4 |

Stage 2 Failure Probability (%)
Fill Count = 3
Fill Count

| | | 1 | 2 | 3 | 4 | 5 | 6 | 7 | 8 | 9 | 10 |
|---|---|---|---|---|---|---|---|---|---|---|---|
| Com- | 15.00 | 0.0240 | 0.0277 | 0.0405 | 0.0725 | 0.157 | 0.341 | 0.756 | 1.59 | 3.15 | 5.72 |
| posite | 13.33 | 0.00106 | 0.00158 | 0.00326 | 0.00791 | 0.0246 | 0.0766 | 0.231 | 0.603 | 1.46 | 3.13 |
| RSD | 11.67 | <1.00E−04 | <1.00E−04 | 0.000114 | 0.000597 | 0.00287 | 0.0129 | 0.0510 | 0.198 | 0.603 | 1.62 |
| (%) | 10.00 | <1.00E−04 | <1.00E−04 | <1.00E−04 | <1.00E−04 | 0.0002 | 0.00113 | 0.0106 | 0.0572 | 0.223 | 0.764 |
| | 8.33 | <1.00E−04 | <1.00E−04 | <1.00E−04 | <1.00E−04 | <1.00E−04 | <1.00E−04 | 0.00138 | 0.0120 | 0.0787 | 0.346 |
| | 6.67 | <1.00E−04 | <1.00E−04 | <1.00E−04 | <1.00E−04 | <1.00E−04 | <1.00E−04 | 0.000160 | 0.00247 | 0.0254 | 0.156 |
| | 5.00 | <1.00E−04 | <1.00E−04 | <1.00E−04 | <1.00E−04 | <1.00E−04 | <1.00E−04 | <1.00E−04 | 0.000432 | 0.00841 | 0.0698 |
| | 3.33 | <1.00E−04 | <1.00E−04 | <1.00E−04 | <1.00E−04 | <1.00E−04 | <1.00E−04 | <1.00E−04 | 0.000150 | 0.00257 | 0.0397 |
| | 1.67 | <1.00E−04 | <1.00E−04 | <1.00E−04 | <1.00E−04 | <1.00E−04 | <1.00E−04 | <1.00E−04 | <1.00E−04 | 0.00208 | 0.0254 |
| | 0.00 | <1.00E−04 | <1.00E−04 | <1.00E−04 | <1.00E−04 | <1.00E−04 | <1.00E−04 | <1.00E−04 | <1.00E−04 | 0.00158 | 0.0217 |

Stage 1 Acceptance Value (%)
Fill Count = 3
Fill Count

| | | 1 | 2 | 3 | 4 | 5 | 6 | 7 | 8 | 9 | 10 |
|---|---|---|---|---|---|---|---|---|---|---|---|
| Composite | 15.00 | 14 | 14 | 15 | 15 | 16 | 16 | 17 | 18 | 19 | 20 |
| RSD (%) | 13.33 | 13 | 13 | 13 | 14 | 14 | 15 | 16 | 17 | 18 | 19 |
| | 11.67 | 11 | 11 | 12 | 12 | 13 | 14 | 15 | 16 | 17 | 18 |
| | 10.00 | 9.6 | 9.8 | 10 | 11 | 12 | 12 | 14 | 15 | 16 | 17 |
| | 8.33 | 8.1 | 8.2 | 8.7 | 9.4 | 10 | 11 | 12 | 14 | 15 | 16 |
| | 6.67 | 6.5 | 6.7 | 7.3 | 8.1 | 9.1 | 10 | 12 | 13 | 14 | 16 |
| | 5.00 | 5.0 | 5.2 | 5.9 | 6.9 | 8.1 | 9.4 | 11 | 12 | 14 | 15 |
| | 3.33 | 3.3 | 3.7 | 4.7 | 5.9 | 7.3 | 8.7 | 10 | 12 | 13 | 15 |
| | 1.67 | 1.7 | 2.3 | 3.7 | 5.2 | 6.7 | 8.2 | 9.8 | 11 | 13 | 14 |
| | 0.00 | 0 | 1.7 | 3.3 | 5.0 | 6.5 | 8.1 | 9.6 | 11 | 13 | 14 |

Stage 2 Acceptance Value (%)
Fill Count = 3
Fill Count

| | | 1 | 2 | 3 | 4 | 5 | 6 | 7 | 8 | 9 | 10 |
|---|---|---|---|---|---|---|---|---|---|---|---|
| Composite | 15.00 | 12 | 12 | 12 | 13 | 13 | 14 | 14 | 15 | 16 | 17 |
| RSD (%) | 13.33 | 11 | 11 | 11 | 11 | 12 | 13 | 13 | 14 | 15 | 16 |
| | 11.67 | 9.5 | 9.6 | 9.8 | 10 | 11 | 12 | 12 | 13 | 14 | 15 |
| | 10.00 | 8.1 | 8.3 | 8.6 | 9.1 | 9.7 | 11 | 11 | 12 | 13 | 14 |
| | 8.33 | 6.8 | 6.9 | 7.3 | 7.9 | 8.7 | 9.6 | 11 | 12 | 13 | 14 |
| | 6.67 | 5.5 | 5.6 | 6.1 | 6.8 | 7.7 | 8.7 | 9.7 | 11 | 12 | 13 |
| | 5.00 | 4.1 | 4.3 | 4.9 | 5.8 | 6.8 | 7.9 | 9.1 | 10 | 11 | 13 |
| | 3.33 | 2.7 | 3.1 | 3.9 | 4.9 | 6.1 | 7.3 | 8.6 | 9.8 | 11 | 12 |
| | 1.67 | 1.4 | 1.9 | 3.1 | 4.3 | 5.6 | 6.9 | 8.3 | 9.6 | 11 | 12 |
| | 0.00 | 0 | 1.4 | 2.7 | 4.1 | 5.5 | 6.8 | 8.1 | 9.5 | 11 | 12 |

Stage 1 Failure Probability (%)
Fill Count = 5
Fill Count

| | | 1 | 2 | 3 | 4 | 5 | 6 | 7 | 8 | 9 | 10 |
|---|---|---|---|---|---|---|---|---|---|---|---|
| Composite | 15.00 | 7.04 | 7.48 | 8.90 | 11.5 | 15.6 | 21.3 | 28.8 | 37.4 | 46.8 | 56.1 |
| RSD (%) | 13.33 | 1.73 | 1.93 | 2.62 | 4.05 | 6.66 | 11.0 | 17.5 | 26.0 | 36.1 | 46.8 |
| | 11.67 | 0.187 | 0.225 | 0.390 | 0.849 | 1.96 | 4.42 | 9.00 | 16.3 | 26.0 | 37.4 |
| | 10.00 | 0.00444 | 0.00628 | 0.0190 | 0.0751 | 0.333 | 1.25 | 3.77 | 9.00 | 17.5 | 28.7 |
| | 8.33 | <1.00E−04 | <1.00E−04 | <1.00E−04 | 0.00252 | 0.0270 | 0.233 | 1.26 | 4.39 | 11.0 | 21.3 |
| | 6.67 | <1.00E−04 | <1.00E−04 | <1.00E−04 | <1.00E−04 | 0.000898 | 0.0281 | 0.333 | 1.95 | 6.66 | 15.6 |
| | 5.00 | <1.00E−04 | <1.00E−04 | <1.00E−04 | <1.00E−04 | <1.00E−04 | 0.00182 | 0.0786 | 0.842 | 4.06 | 11.5 |
| | 3.33 | <1.00E−04 | <1.00E−04 | <1.00E−04 | <1.00E−04 | <1.00E−04 | 0.000125 | 0.0202 | 0.392 | 2.61 | 8.91 |
| | 1.67 | <1.00E−04 | <1.00E−04 | <1.00E−04 | <1.00E−04 | <1.00E−04 | <1.00E−04 | 0.00668 | 0.226 | 1.92 | 7.48 |
| | 0.00 | <1.00E−04 | <1.00E−04 | <1.00E−04 | <1.00E−04 | <1.00E−04 | <1.00E−04 | 0.00429 | 0.187 | 1.74 | 7.03 |

Stage 2 Failure Probability (%)
Fill Count = 5
Fill Count

| | | 1 | 2 | 3 | 4 | 5 |
|---|---|---|---|---|---|---|
| Composite | 15.00 | <1.00E−04 | <1.00E−04 | <1.00E−04 | <1.00E−04 | 0.000518 |
| RSD (%) | 13.33 | <1.00E−04 | <1.00E−04 | <1.00E−04 | <1.00E−04 | <1.00E−04 |
| | 11.67 | <1.00E−04 | <1.00E−04 | <1.00E−04 | <1.00E−04 | <1.00E−04 |
| | 10.00 | <1.00E−04 | <1.00E−04 | <1.00E−04 | <1.00E−04 | <1.00E−04 |
| | 8.33 | <1.00E−04 | <1.00E−04 | <1.00E−04 | <1.00E−04 | <1.00E−04 |
| | 6.67 | <1.00E−04 | <1.00E−04 | <1.00E−04 | <1.00E−04 | <1.00E−04 |
| | 5.00 | <1.00E−04 | <1.00E−04 | <1.00E−04 | <1.00E−04 | <1.00E−04 |
| | 3.33 | <1.00E−04 | <1.00E−04 | <1.00E−04 | <1.00E−04 | <1.00E−04 |
| | 1.67 | <1.00E−04 | <1.00E−04 | <1.00E−04 | <1.00E−04 | <1.00E−04 |
| | 0.00 | <1.00E−04 | <1.00E−04 | <1.00E−04 | <1.00E−04 | <1.00E−04 |
| | | 6 | 7 | 8 | 9 | 10 |
| Composite | 15.00 | 0.00188 | 0.00742 | 0.0240 | 0.0700 | 0.188 |
| RSD (%) | 13.33 | 0.000173 | 0.00139 | 0.00534 | 0.0198 | 0.0632 |
| | 11.67 | <1.00E−04 | 0.000141 | 0.000860 | 0.00564 | 0.0239 |
| | 10.00 | <1.00E−04 | <1.00E−04 | <1.00E−04 | 0.00208 | 0.00742 |
| | 8.33 | <1.00E−04 | <1.00E−04 | <1.00E−04 | 0.000137 | 0.00138 |
| | 6.67 | <1.00E−04 | <1.00E−04 | <1.00E−04 | <1.00E−04 | 0.000478 |
| | 5.00 | <1.00E−04 | <1.00E−04 | <1.00E−04 | <1.00E−04 | 0.000104 |
| | 3.33 | <1.00E−04 | <1.00E−04 | <1.00E−04 | <1.00E−04 | <1.00E−04 |
| | 1.67 | <1.00E−04 | <1.00E−04 | <1.00E−04 | <1.00E−04 | <1.00E−04 |
| | 0.00 | <1.00E−04 | <1.00E−04 | <1.00E−04 | <1.00E−04 | <1.00E−04 |

Stage 1 Acceptance Value (%)
Fill Count = 5
Fill Count

| | | 1 | 2 | 3 | 4 | 5 | 6 | 7 | 8 | 9 | 10 |
|---|---|---|---|---|---|---|---|---|---|---|---|
| Composite | 15.00 | 11 | 11 | 11 | 12 | 12 | 13 | 13 | 14 | 15 | 16 |
| RSD (%) | 13.33 | 9.9 | 10 | 10 | 11 | 11 | 12 | 12 | 13 | 14 | 15 |
| | 11.67 | 8.7 | 8.8 | 9.1 | 9.5 | 10 | 11 | 11 | 12 | 13 | 14 |
| | 10.00 | 7.5 | 7.6 | 7.9 | 8.4 | 9.0 | 9.7 | 11 | 11 | 12 | 13 |
| | 8.33 | 6.3 | 6.5 | 6.8 | 7.3 | 8.0 | 8.8 | 9.7 | 11 | 12 | 13 |
| | 6.67 | 5.1 | 5.3 | 5.7 | 6.3 | 7.1 | 8.0 | 9.0 | 10 | 11 | 12 |
| | 5.00 | 3.9 | 4.1 | 4.6 | 5.4 | 6.3 | 7.3 | 8.4 | 9.5 | 11 | 12 |
| | 3.33 | 2.6 | 2.9 | 3.6 | 4.6 | 5.7 | 6.8 | 7.9 | 9.1 | 10 | 11 |
| | 1.67 | 1.3 | 1.8 | 2.9 | 4.1 | 5.3 | 6.5 | 7.6 | 8.8 | 10 | 11 |
| | 0.00 | 0 | 1.3 | 2.6 | 3.9 | 5.1 | 6.3 | 7.5 | 8.7 | 9.9 | 11 |

Stage 2 Acceptance Value (%)
Fill Count = 6
Fill Count

| | | 1 | 2 | 3 | 4 | 5 | 6 | 7 | 8 | 9 | 10 |
|---|---|---|---|---|---|---|---|---|---|---|---|
| Composite | 15.00 | 9.4 | 9.5 | 9.6 | 9.9 | 10 | 11 | 11 | 12 | 13 | 13 |
| RSD (%) | 13.33 | 8.4 | 8.5 | 8.7 | 9.0 | 9.4 | 9.9 | 10 | 11 | 12 | 13 |
| | 11.67 | 7.4 | 7.5 | 7.7 | 8.0 | 8.5 | 9.0 | 9.7 | 10 | 11 | 12 |
| | 10.00 | 6.3 | 6.4 | 6.7 | 7.1 | 7.6 | 8.2 | 8.9 | 9.7 | 10 | 11 |
| | 8.33 | 5.3 | 5.4 | 5.7 | 6.2 | 6.8 | 7.5 | 8.2 | 9.0 | 9.9 | 11 |
| | 6.67 | 4.2 | 4.4 | 4.7 | 5.3 | 6.0 | 6.8 | 7.6 | 8.5 | 9.4 | 10 |
| | 5.00 | 3.2 | 3.3 | 3.8 | 4.5 | 5.3 | 6.2 | 7.1 | 8.0 | 9.0 | 9.9 |
| | 3.33 | 2.1 | 2.4 | 3.0 | 3.8 | 4.7 | 5.7 | 6.7 | 7.7 | 8.7 | 9.6 |
| | 1.67 | 1.1 | 1.5 | 2.4 | 3.3 | 4.4 | 5.4 | 6.4 | 7.5 | 8.5 | 9.5 |
| | 0.00 | 0 | 1.1 | 2.1 | 3.2 | 4.2 | 5.3 | 6.3 | 7.4 | 8.4 | 9.4 |

Stage 1 Failure Probability (%)
Fill Count = 10
Fill Count

| | | 1 | 2 | 3 | 4 | 5 |
|---|---|---|---|---|---|---|
| Composite | 15.00 | 0.0215 | 0.0245 | 0.0410 | 0.0781 | 0.173 |
| RSD (%) | 13.33 | 0.000848 | 0.000972 | 0.00242 | 0.00623 | 0.0197 |
| | 11.67 | <1.00E−04 | <1.00E−04 | <1.00E−04 | <1.00E−04 | 0.00110 |
| | 10.00 | <1.00E−04 | <1.00E−04 | <1.00E−04 | <1.00E−04 | <1.00E−04 |
| | 8.33 | <1.00E−04 | <1.00E−04 | <1.00E−04 | <1.00E−04 | <1.00E−04 |
| | 6.67 | <1.00E−04 | <1.00E−04 | <1.00E−04 | <1.00E−04 | <1.00E−04 |
| | 5.00 | <1.00E−04 | <1.00E−04 | <1.00E−04 | <1.00E−04 | <1.00E−04 |
| | 3.33 | <1.00E−04 | <1.00E−04 | <1.00E−04 | <1.00E−04 | <1.00E−04 |
| | 1.67 | <1.00E−04 | <1.00E−04 | <1.00E−04 | <1.00E−04 | <1.00E−04 |
| | 0.00 | <1.00E−04 | <1.00E−04 | <1.00E−04 | <1.00E−04 | <1.00E−04 |

| | | 6 | 7 | 8 | 9 | 10 |
|---|---|---|---|---|---|---|
| Composite | 15.00 | 0.395 | 0.926 | 2.00 | 3.97 | 7.23 |
| RSD (%) | 13.33 | 0.0679 | 0.234 | 0.698 | 1.79 | 3.99 |
| | 11.67 | 0.00688 | 0.0412 | 0.199 | 0.699 | 1.99 |
| | 10.00 | 0.000299 | 0.00481 | 0.0411 | 0.231 | 0.918 |
| | 8.33 | <1.00E−04 | 0.000374 | 0.00686 | 0.0718 | 0.399 |
| | 6.67 | <1.00E−04 | <1.00E−04 | 0.00102 | 0.0197 | 0.169 |
| | 5.00 | <1.00E−04 | <1.00E−04 | 0.000199 | 0.00566 | 0.0776 |
| | 3.33 | <1.00E−04 | <1.00E−04 | <1.00E−04 | 0.00167 | 0.0382 |
| | 1.67 | <1.00E−04 | <1.00E−04 | <1.00E−04 | 0.000972 | 0.0255 |
| | 0.00 | <1.00E−04 | <1.00E−04 | <1.00E−04 | 0.000524 | 0.0224 |

Stage 2 Failure Probability (%)
Fill Count = 10
Fill Count

| | | 1 | 2 | 3 | 4 | 5 |
|---|---|---|---|---|---|---|
| Composite | 15.00 | <1.00E−04 | <1.00E−04 | <1.00E−04 | <1.00E−04 | <1.00E−04 |
| RSD (%) | 13.33 | <1.00E−04 | <1.00E−04 | <1.00E−04 | <1.00E−04 | <1.00E−04 |
| | 11.67 | <1.00E−04 | <1.00E−04 | <1.00E−04 | <1.00E−04 | <1.00E−04 |
| | 10.00 | <1.00E−04 | <1.00E−04 | <1.00E−04 | <1.00E−04 | <1.00E−04 |
| | 8.33 | <1.00E−04 | <1.00E−04 | <1.00E−04 | <1.00E−04 | <1.00E−04 |
| | 6.67 | <1.00E−04 | <1.00E−04 | <1.00E−04 | <1.00E−04 | <1.00E−04 |
| | 5.00 | <1.00E−04 | <1.00E−04 | <1.00E−04 | <1.00E−04 | <1.00E−04 |
| | 3.33 | <1.00E−04 | <1.00E−04 | <1.00E−04 | <1.00E−04 | <1.00E−04 |
| | 1.67 | <1.00E−04 | <1.00E−04 | <1.00E−04 | <1.00E−04 | <1.00E−04 |
| | 0.00 | <1.00E−04 | <1.00E−04 | <1.00E−04 | <1.00E−04 | <1.00E−04 |
| | | 6 | 7 | 8 | 9 | 10 |
| Composite | 15.00 | <1.00E−04 | <1.00E−04 | <1.00E−04 | <1.00E−04 | <1.00E−04 |
| RSD (%) | 13.33 | <1.00E−04 | <1.00E−04 | <1.00E−04 | <1.00E−04 | <1.00E−04 |
| | 11.67 | <1.00E−04 | <1.00E−04 | <1.00E−04 | <1.00E−04 | <1.00E−04 |
| | 10.00 | <1.00E−04 | <1.00E−04 | <1.00E−04 | <1.00E−04 | <1.00E−04 |
| | 8.33 | <1.00E−04 | <1.00E−04 | <1.00E−04 | <1.00E−04 | <1.00E−04 |
| | 6.67 | <1.00E−04 | <1.00E−04 | <1.00E−04 | <1.00E−04 | <1.00E−04 |
| | 5.00 | <1.00E−04 | <1.00E−04 | <1.00E−04 | <1.00E−04 | <1.00E−04 |
| | 3.33 | <1.00E−04 | <1.00E−04 | <1.00E−04 | <1.00E−04 | <1.00E−04 |
| | 1.67 | <1.00E−04 | <1.00E−04 | <1.00E−04 | <1.00E−04 | <1.00E−04 |
| | 0.00 | <1.00E−04 | <1.00E−04 | <1.00E−04 | <1.00E−04 | <1.00E−04 |

Stage 1 Acceptance Value (%)
Fill Count = 10
Fill Count

| | | 1 | 2 | 3 | 4 | 5 | 6 | 7 | 8 | 9 | 10 |
|---|---|---|---|---|---|---|---|---|---|---|---|
| Com- | 15.00 | 8.0 | 8.0 | 8.2 | 8.4 | 8.7 | 9.1 | 9.5 | 10 | 11 | 11 |
| posite | 13.33 | 7.1 | 7.2 | 7.3 | 7.6 | 7.9 | 8.4 | 8.8 | 9.4 | 10 | 11 |
| RSD | 11.67 | 6.3 | 6.3 | 6.5 | 6.8 | 7.2 | 7.7 | 8.2 | 8.8 | 9.4 | 10 |
| (%) | 10.00 | 5.4 | 5.5 | 5.7 | 6.0 | 6.5 | 7.0 | 7.6 | 8.2 | 8.8 | 9.5 |
| | 8.33 | 4.5 | 4.6 | 4.9 | 5.3 | 5.8 | 6.3 | 7.0 | 7.7 | 8.4 | 9.1 |
| | 6.67 | 3.6 | 3.7 | 4.1 | 4.5 | 5.1 | 5.8 | 6.5 | 7.2 | 7.9 | 8.7 |
| | 5.00 | 2.7 | 2.9 | 3.3 | 3.9 | 4.5 | 5.3 | 6.0 | 6.8 | 7.6 | 8.4 |
| | 3.33 | 1.8 | 2.0 | 2.6 | 3.3 | 4.1 | 4.9 | 5.7 | 6.5 | 7.3 | 8.2 |
| | 1.67 | 0.91 | 1.3 | 2.0 | 2.9 | 3.7 | 4.6 | 5.5 | 6.3 | 7.2 | 8.0 |
| | 0.00 | 0 | 0.91 | 1.8 | 2.7 | 3.6 | 4.5 | 5.4 | 6.3 | 7.1 | 8.0 |

Stage 2 Acceptance Value (%)
Fill Count = 10
Fill Count

| | | 1 | 2 | 3 | 4 | 5 | 6 | 7 | 8 | 9 | 10 |
|---|---|---|---|---|---|---|---|---|---|---|---|
| Composite | 15.00 | 6.7 | 6.8 | 6.9 | 7.1 | 7.3 | 7.7 | 8.1 | 8.5 | 8.9 | 9.4 |
| RSD (%) | 13.33 | 6.0 | 6.0 | 6.2 | 6.4 | 6.7 | 7.0 | 7.5 | 7.9 | 8.4 | 8.9 |
| | 11.67 | 5.2 | 5.3 | 5.4 | 5.7 | 6.0 | 6.4 | 6.9 | 7.4 | 7.9 | 8.5 |
| | 10.00 | 4.5 | 4.5 | 4.7 | 5.0 | 5.4 | 5.8 | 6.3 | 6.9 | 7.5 | 8.1 |
| | 8.33 | 3.7 | 3.8 | 4.0 | 4.4 | 4.8 | 5.3 | 5.8 | 6.4 | 7.0 | 7.7 |
| | 6.67 | 3.0 | 3.1 | 3.3 | 3.7 | 4.2 | 4.8 | 5.4 | 6.0 | 6.7 | 7.3 |
| | 5.00 | 2.2 | 2.4 | 2.7 | 3.2 | 3.7 | 4.4 | 5.0 | 5.7 | 6.4 | 7.1 |
| | 3.33 | 1.5 | 1.7 | 2.1 | 2.7 | 3.3 | 4.0 | 4.7 | 5.4 | 6.2 | 6.9 |
| | 1.67 | 0.75 | 1.1 | 1.7 | 2.4 | 3.1 | 3.8 | 4.5 | 5.3 | 6.0 | 6.8 |
| | 0.00 | 0 | 0.75 | 1.5 | 2.2 | 3.0 | 3.7 | 4.5 | 5.2 | 6.0 | 6.7 |

### Supplementary Information Section 2.2—Tables of Calculated Values Corresponding to FIG. 13

Stage 1 Failure Probability (%)
Fill Error Probability Per Mini-tablet Filled = 0%
Fill Count

| | | 1 | 2 | 3 | 4 | 5 |
|---|---|---|---|---|---|---|
| Composite | 15.00 | 99.9 | 97.8 | 91.0 | 79.4 | 65.2 |
| RSD (%) | 13.33 | 99.6 | 94.9 | 82.2 | 64.1 | 45.9 |
| | 11.67 | 98.9 | 88 | 65.8 | 42.0 | 24.0 |
| | 10.00 | 96.6 | 72.4 | 40.3 | 18.1 | 7.06 |
| | 8.33 | 88.6 | 43.8 | 13.6 | 3.23 | 0.653 |
| | 6.67 | 64.2 | 11.5 | 1.09 | 0.0754 | 0.00476 |
| | 5.00 | 18.1 | 0.250 | 0.00170 | <1.00E−04 | <1.00E−04 |
| | 3.33 | 0.0766 | <1.00E−04 | <1.00E−04 | <1.00E−04 | <1.00E−04 |
| | 1.67 | <1.00E−04 | <1.00E−04 | <1.00E−04 | <1.00E−04 | <1.00E−04 |
| | 0.00 | <1.00E−04 | <1.00E−04 | <1.00E−04 | <1.00E−04 | <1.00E−04 |
| | | 6 | 7 | 8 | 9 | 10 |
| Composite | 15.00 | 50.5 | 37.2 | 26.5 | 18.1 | 12.1 |
| RSD (%) | 13.33 | 30.5 | 19.1 | 11.5 | 6.61 | 3.70 |
| | 11.67 | 12.5 | 6.09 | 2.84 | 1.27 | 0.543 |
| | 10.00 | 2.48 | 0.811 | 0.252 | 0.0749 | 0.0221 |
| | 8.33 | 0.117 | 0.0188 | 0.00284 | 0.000449 | <1.00E−04 |
| | 6.67 | 0.000224 | <1.00E−04 | <1.00E−04 | <1.00E−04 | <1.00E−04 |
| | 5.00 | <1.00E−04 | <1.00E−04 | <1.00E−04 | <1.00E−04 | <1.00E−04 |
| | 3.33 | <1.00E−04 | <1.00E−04 | <1.00E−04 | <1.00E−04 | <1.00E−04 |
| | 1.67 | <1.00E−04 | <1.00E−04 | <1.00E−04 | <1.00E−04 | <1.00E−04 |
| | 0.00 | <1.00E−04 | <1.00E−04 | <1.00E−04 | <1.00E−04 | <1.00E−04 |

Stage 2 Failure Probability (%)
Fill Error Probability Per Mini-tablet Filled = 0%
Fill Count

| | | 1 | 2 | 3 | 4 | 5 |
|---|---|---|---|---|---|---|
| Composite | 15.00 | 97.0 | 41.9 | 9.54 | 1.95 | 0.390 |
| RSD (%) | 13.33 | 88.1 | 19.4 | 2.68 | 0.356 | 0.0430 |
| | 11.67 | 64.2 | 5.88 | 0.406 | 0.0309 | 0.00208 |
| | 10.00 | 29.6 | 0.851 | 0.0206 | 0.000646 | <1.00E−04 |
| | 8.33 | 6.47 | 0.0323 | 0.000324 | <1.00E−04 | <1.00E−04 |
| | 6.67 | 0.351 | <1.00E−04 | <1.00E−04 | <1.00E−04 | <1.00E−04 |
| | 5.00 | 0.000478 | <1.00E−04 | <1.00E−04 | <1.00E−04 | <1.00E−04 |
| | 3.33 | <1.00E−04 | <1.00E−04 | <1.00E−04 | <1.00E−04 | <1.00E−04 |
| | 1.67 | <1.00E−04 | <1.00E−04 | <1.00E−04 | <1.00E−04 | <1.00E−04 |
| | 0.00 | <1.00E−04 | <1.00E−04 | <1.00E−04 | <1.00E−04 | <1.00E−04 |
| | | 6 | 7 | 8 | 9 | 10 |
| Composite | 15.00 | 0.0748 | 0.0181 | 0.00455 | 0.000860 | 0.000218 |
| RSD (%) | 13.33 | 0.00762 | 0.000796 | <1.00E−04 | <1.00E−04 | <1.00E−04 |
| | 11.67 | 0.000218 | <1.00E−04 | <1.00E−04 | <1.00E−04 | <1.00E−04 |
| | 10.00 | <1.00E−04 | <1.00E−04 | <1.00E−04 | <1.00E−04 | <1.00E−04 |
| | 8.33 | <1.00E−04 | <1.00E−04 | <1.00E−04 | <1.00E−04 | <1.00E−04 |
| | 6.67 | <1.00E−04 | <1.00E−04 | <1.00E−04 | <1.00E−04 | <1.00E−04 |
| | 5.00 | <1.00E−04 | <1.00E−04 | <1.00E−04 | <1.00E−04 | <1.00E−04 |
| | 3.33 | <1.00E−04 | <1.00E−04 | <1.00E−04 | <1.00E−04 | <1.00E−04 |
| | 1.67 | <1.00E−04 | <1.00E−04 | <1.00E−04 | <1.00E−04 | <1.00E−04 |
| | 0.00 | <1.00E−04 | <1.00E−04 | <1.00E−04 | <1.00E−04 | <1.00E−04 |

Stage 1 Acceptance Value (%)
Fill Error Probability Per Mini-tablet Filled = 0%
Fill Count

| | | 1 | 2 | 3 | 4 | 5 |
|---|---|---|---|---|---|---|
| Composite | 15.00 | 38 | 26 | 22 | 19 | 17 |
| RSD (%) | 13.33 | 33 | 23 | 19 | 17 | 15 |
| | 11.67 | 29 | 20 | 17 | 14 | 13 |
| | 10.00 | 25 | 18 | 14 | 12 | 11 |
| | 8.33 | 21 | 15 | 12 | 10 | 9.3 |
| | 6.67 | 17 | 12 | 9.6 | 8.4 | 7.5 |
| | 5.00 | 12 | 8.9 | 7.3 | 6.4 | 5.7 |
| | 3.33 | 8.4 | 6.0 | 5.0 | 4.3 | 3.9 |
| | 1.67 | 4.3 | 3.0 | 2.5 | 2.2 | 1.9 |
| | 0.00 | <1.00E−04 | <1.00E−04 | <1.00E−04 | <1.00E−04 | <1.00E−04 |
| | | 6 | 7 | 8 | 9 | 10 |
| Composite | 15.00 | 15 | 14 | 13 | 12 | 12 |
| RSD (%) | 13.33 | 14 | 13 | 12 | 11 | 11 |
| | 11.67 | 12 | 11 | 10 | 9.7 | 9.2 |
| | 10.00 | 10 | 9.5 | 8.9 | 8.4 | 8.0 |
| | 8.33 | 8.6 | 7.9 | 7.5 | 7.1 | 6.7 |
| | 6.67 | 6.9 | 6.4 | 6.0 | 5.7 | 5.4 |
| | 5.00 | 5.3 | 4.9 | 4.6 | 4.3 | 4.1 |
| | 3.33 | 3.5 | 3.3 | 3.0 | 2.9 | 2.7 |
| | 1.67 | 1.8 | 1.6 | 1.5 | 1.4 | 1.4 |
| | 0.00 | <1.00E−04 | <1.00E−04 | <1.00E−04 | <1.00E−04 | <1.00E−04 |

Stage 2 Acceptance Value (%)
Fill Error Probability Per Mini-tablet Filled = 0%
Fill Count

| | | 1 | 2 | 3 | 4 | 5 |
|---|---|---|---|---|---|---|
| Composite | 15.00 | 31 | 22 | 18 | 16 | 14 |
| RSD (%) | 13.33 | 28 | 19 | 16 | 14 | 12 |
| | 11.67 | 24 | 17 | 14 | 12 | 11 |
| | 10.00 | 21 | 15 | 12 | 10 | 9.4 |
| | 8.33 | 17 | 12 | 10 | 8.8 | 7.9 |
| | 6.67 | 14 | 9.9 | 8.1 | 7.1 | 6.3 |
| | 5.00 | 10 | 7.5 | 6.1 | 5.3 | 4.8 |
| | 3.33 | 7.1 | 5.0 | 4.1 | 3.5 | 3.2 |
| | 1.67 | 3.5 | 2.5 | 2.0 | 1.8 | 1.6 |
| | 0.00 | <1.00E−04 | <1.00E−04 | <1.00E−04 | <1.00E−04 | <1.00E−04 |
| | | 6 | 7 | 8 | 9 | 10 |
| Composite | 15.00 | 13 | 12 | 11 | 10 | 10 |
| RSD (%) | 13.33 | 11 | 11 | 9.9 | 9.4 | 8.9 |
| | 11.67 | 10 | 9.3 | 8.7 | 8.2 | 7.8 |
| | 10.00 | 8.6 | 8.0 | 7.5 | 7.1 | 6.7 |
| | 8.33 | 7.2 | 6.7 | 6.3 | 5.9 | 5.6 |
| | 6.67 | 5.8 | 5.4 | 5.0 | 4.7 | 4.5 |
| | 5.00 | 4.3 | 4.0 | 3.8 | 3.5 | 3.4 |
| | 3.33 | 2.9 | 2.7 | 2.5 | 2.4 | 2.2 |
| | 1.67 | 1.4 | 1.3 | 1.3 | 1.2 | 1.1 |
| | 0.00 | <1.00E−04 | <1.00E−04 | <1.00E−04 | <1.00E−04 | <1.00E−04 |

Stage 1 Failure Probability (%)
Fill Error Probability Per Mini-tablet Filled = 0.0001%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 99.9 | 97.8 | 91.1 | 79.5 | 65.1 | 50.5 | 37.1 | 26.4 | 18.1 | 12.1 |
| RSD (%) | 13.33 | 99.6 | 94.9 | 82.1 | 64.2 | 45.8 | 30.5 | 19.1 | 11.5 | 6.62 | 3.70 |
| | 11.67 | 98.9 | 88.00 | 65.7 | 42.00 | 23.9 | 12.5 | 6.09 | 2.84 | 1.27 | 0.549 |
| | 10.00 | 96.6 | 72.5 | 40.3 | 18.1 | 7.06 | 2.48 | 0.813 | 0.259 | 0.0782 | 0.0237 |
| | 8.33 | 88.7 | 43.8 | 13.5 | 3.24 | 0.653 | 0.120 | 0.0209 | 0.00434 | 0.000648 | 0.000125 |
| | 6.67 | 64.2 | 11.5 | 1.07 | 0.0755 | 0.00772 | 0.00197 | 0.000823 | 9.97E−05 | <1.00E−06 | <1.00E−06 |
| | 5.00 | 18.1 | 0.244 | 0.00396 | 0.00317 | 0.00295 | 0.00115 | 0.000374 | 2.49E−05 | <1.00E−06 | <1.00E−06 |
| | 3.33 | 0.0759 | 0.00129 | 0.00158 | 0.00297 | 0.00332 | 0.000399 | <1.00E−06 | <1.00E−06 | <1.00E−06 | <1.00E−06 |
| | 1.67 | 0.000432 | 0.000794 | 0.00208 | 0.00386 | 0.00319 | 7.48E−05 | <1.00E−06 | <1.00E−06 | <1.00E−06 | <1.00E−06 |
| | 0.00 | 0.000860 | 0.00129 | 0.00257 | 0.00279 | 0.00292 | <1.00E−06 | <1.00E−06 | <1.00E−06 | <1.00E−06 | <1.00E−06 |

Stage 2 Failure Probability (%)
Fill Error Probability Per Mini-tablet Filled = 0.0001%
Fill Count

| | | 1 | 2 | 3 | 4 | 5 | 6 | 7 | 8 | 9 | 10 |
|---|---|---|---|---|---|---|---|---|---|---|---|
| Com- | 15.00 | 97.1 | 42.0 | 9.48 | 1.93 | 0.386 | 0.0756 | 0.0153 | 0.00356 | 0.000696 | 0.000120 |
| posite | 13.33 | 88.1 | 19.5 | 2.74 | 0.350 | 0.0461 | 0.00564 | 0.000927 | 0.000130 | <1.00E−04 | <1.00E−04 |
| RSD | 11.67 | 64.2 | 5.86 | 0.419 | 0.0293 | 0.00336 | 0.000239 | <1.00E−04 | <1.00E−04 | <1.00E−04 | <1.00E−04 |
| (%) | 10.00 | 29.5 | 0.874 | 0.0267 | 0.00218 | 0.000342 | <1.00E−04 | <1.00E−04 | <1.00E−04 | <1.00E−04 | <1.00E−04 |
| | 8.33 | 6.50 | 0.0397 | 0.00257 | 0.00148 | 0.000374 | <1.00E−04 | <1.00E−04 | <1.00E−04 | <1.00E−04 | <1.00E−04 |
| | 6.67 | 0.347 | 0.00168 | 0.00227 | 0.00168 | 0.000133 | <1.00E−04 | <1.00E−04 | <1.00E−04 | <1.00E−04 | <1.00E−04 |
| | 5.00 | 0.00106 | 0.00119 | 0.00198 | 0.00129 | <1.00E−04 | <1.00E−04 | <1.00E−04 | <1.00E−04 | <1.00E−04 | <1.00E−04 |
| | 3.33 | 0.000796 | 0.00129 | 0.00158 | 0.00168 | <1.00E−04 | <1.00E−04 | <1.00E−04 | <1.00E−04 | <1.00E−04 | <1.00E−04 |
| | 1.67 | 0.000432 | 0.000794 | 0.00208 | 0.00158 | <1.00E−04 | <1.00E−04 | <1.00E−04 | <1.00E−04 | <1.00E−04 | <1.00E−04 |
| | 0.00 | 0.000860 | 0.00129 | 0.00257 | <1.00E−04 | <1.00E−04 | <1.00E−04 | <1.00E−04 | <1.00E−04 | <1.00E−04 | <1.00E−04 |

Stage 1 Acceptance Value (%)
Fill Error Probability Per Mini-tablet Filled = 0.0001%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 38 | 26 | 22 | 19 | 17 | 15 | 14 | 13 | 12 | 12 |
| RSD (%) | 13.33 | 33 | 23 | 19 | 17 | 15 | 14.0 | 13 | 12 | 11 | 11 |
| | 11.67 | 29 | 20 | 17 | 14 | 13 | 12 | 11 | 10 | 9.7 | 9.2 |
| | 10.00 | 25 | 18 | 14 | 12 | 11 | 10 | 9.5 | 8.9 | 8.4 | 8 |
| | 8.33 | 21 | 15 | 12 | 10 | 9.3 | 8.6 | 7.9 | 7.5 | 7.1 | 6.7 |
| | 6.67 | 17 | 12 | 9.6 | 8.4 | 7.5 | 6.9 | 6.4 | 6 | 5.70 | 5.4 |
| | 5.00 | 12 | 8.9 | 7.3 | 6.4 | 5.7 | 5.3 | 4.9 | 4.6 | 4.3 | 4.1 |
| | 3.33 | 8.4 | 6.0 | 5.0 | 4.3 | 3.9 | 3.5 | 3.3 | 3 | 2.9 | 2.7 |
| | 1.67 | 4.3 | 3.1 | 2.5 | 2.2 | 1.9 | 1.8 | 1.6 | 1.5 | 1.4 | 1.4 |
| | 0.00 | 0.00073 | 0.00053 | 0.00070 | 0.00056 | 0.00046 | 0.00053 | 0.00061 | 0.00056 | 0.00058 | 0.00065 |

Stage 2 Acceptance Value (%)
Fill Error Probability Per Mini-tablet Filled = 0.0001%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 31 | 22 | 18 | 16 | 14 | 13 | 12 | 11 | 10 | 10 |
| RSD (%) | 13.33 | 28 | 19 | 16 | 14 | 12 | 11 | 11 | 9.9 | 9.4 | 8.9 |
| | 11.67 | 24 | 17 | 14 | 12 | 11 | 10 | 9.3 | 8.7 | 8.2 | 7.8 |
| | 10.00 | 21 | 15 | 12 | 10 | 9.4 | 8.6 | 8 | 7.5 | 7.1 | 6.7 |
| | 8.33 | 17 | 12 | 10 | 8.8 | 7.9 | 7.2 | 6.7 | 6.3 | 5.9 | 5.6 |
| | 6.67 | 14 | 9.9 | 8.1 | 7.1 | 6.3 | 5.8 | 5.4 | 5.0 | 4.7 | 4.5 |
| | 5.00 | 10 | 7.5 | 6.1 | 5.3 | 4.8 | 4.3 | 4.0 | 3.8 | 3.5 | 3.4 |
| | 3.33 | 7.1 | 5.0 | 4.1 | 3.5 | 3.2 | 2.9 | 2.7 | 2.5 | 2.4 | 2.2 |
| | 1.67 | 3.5 | 2.5 | 2.0 | 1.8 | 1.6 | 1.4 | 1.3 | 1.3 | 1.2 | 1.1 |
| | 0.00 | 0.00094 | 0.00067 | 0.00083 | 0.00077 | 0.00071 | 0.00078 | 0.00080 | 0.00077 | 0.00078 | 0.00074 |

Stage 1 Failure Probability (%)
Fill Error Probability Per Mini-tablet Filled = 0.001%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 99.9 | 97.8 | 91.0 | 79.4 | 65 | 50.4 | 37.2 | 26.4 | 18.1 | 12.1 |
| RSD (%) | 13.33 | 99.6 | 94.9 | 82.2 | 64.2 | 45.9 | 30.5 | 19.2 | 11.5 | 6.62 | 3.71 |
| | 11.67 | 98.9 | 87.9 | 65.7 | 42.1 | 24.0 | 12.5 | 6.11 | 2.85 | 1.29 | 0.556 |
| | 10.00 | 96.6 | 72.4 | 40.3 | 18.2 | 7.06 | 2.50 | 0.834 | 0.268 | 0.0821 | 0.0249 |
| | 8.33 | 88.6 | 43.8 | 13.6 | 3.22 | 0.675 | 0.144 | 0.0336 | 0.00895 | 0.00289 | 0.000773 |
| | 6.67 | 64.2 | 11.5 | 1.11 | 0.0972 | 0.0330 | 0.0190 | 0.00743 | 0.00142 | 0.000349 | <1.00E−04 |
| | 5.00 | 18.2 | 0.273 | 0.0233 | 0.0259 | 0.0299 | 0.0129 | 0.00247 | 0.000175 | <1.00E−04 | <1.00E−04 |
| | 3.33 | 0.0835 | 0.0134 | 0.0224 | 0.0265 | 0.0285 | 0.00641 | <1.00E−04 | <1.00E−04 | <1.00E−04 | <1.00E−04 |
| | 1.67 | 0.00702 | 0.0135 | 0.0193 | 0.0269 | 0.0306 | 0.000598 | <1.00E−04 | <1.00E−04 | <1.00E−04 | <1.00E−04 |
| | 0.00 | 0.00722 | 0.0150 | 0.0200 | 0.0274 | 0.0332 | <1.00E−04 | <1.00E−04 | <1.00E−04 | <1.00E−04 | <1.00E−04 |

Stage 2 Failure Probability (%)
Fill Error Probability Per Mini-tablet Filled = 0.001%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 97.1 | 42.1 | 9.51 | 1.99 | 0.402 | 0.0838 | 0.0155 | 0.00376 | 0.00129 | 0.000218 |
| RSD (%) | 13.33 | 88.1 | 19.4 | 2.75 | 0.369 | 0.0515 | 0.0114 | 0.00237 | 0.000370 | <1.00E−04 | <1.00E−04 |
| | 11.67 | 64.3 | 5.89 | 0.452 | 0.0516 | 0.00989 | 0.00208 | 0.000310 | 0.000124 | <1.00E−04 | <1.00E−04 |
| | 10.00 | 29.5 | 0.896 | 0.0541 | 0.0171 | 0.00465 | 0.000746 | <1.00E−04 | <1.00E−04 | <1.00E−04 | <1.00E−04 |
| | 8.33 | 6.53 | 0.0615 | 0.0254 | 0.0144 | 0.00317 | 0.000342 | <1.00E−04 | <1.00E−04 | <1.00E−04 | <1.00E−04 |
| | 6.67 | 0.368 | 0.0172 | 0.0218 | 0.0121 | 0.00119 | <1.00E−04 | <1.00E−04 | <1.00E−04 | <1.00E−04 | <1.00E−04 |
| | 5.00 | 0.0104 | 0.0140 | 0.0217 | 0.0118 | 0.000597 | <1.00E−04 | <1.00E−04 | <1.00E−04 | <1.00E−04 | <1.00E−04 |
| | 3.33 | 0.00791 | 0.0134 | 0.0224 | 0.0112 | <1.00E−04 | <1.00E−04 | <1.00E−04 | <1.00E−04 | <1.00E−04 | <1.00E−04 |
| | 1.67 | 0.00702 | 0.0135 | 0.0193 | 0.0140 | <1.00E−04 | <1.00E−04 | <1.00E−04 | <1.00E−04 | <1.00E−04 | <1.00E−04 |
| | 0.00 | 0.00722 | 0.0150 | 0.0200 | <1.00E−04 | <1.00E−04 | <1.00E−04 | <1.00E−04 | <1.00E−04 | <1.00E−04 | <1.00E−04 |

Stage 1 Acceptance Value (%)
Fill Error Probability Per Mini-tablet Filled = 0.001%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 38 | 26 | 22 | 19 | 17 | 15 | 14 | 13 | 12 | 12 |
| RSD (%) | 13.33 | 33 | 23 | 19 | 17 | 15 | 14 | 13 | 12 | 11 | 11 |
| | 11.67 | 29 | 20 | 17 | 14 | 13 | 12 | 11 | 10 | 9.7 | 9.2 |
| | 10.00 | 25 | 18 | 14 | 12 | 11 | 10 | 9.5 | 8.9 | 8.4 | 8.0 |
| | 8.33 | 21 | 15 | 12 | 10 | 9.3 | 8.6 | 8.0 | 7.5 | 7.1 | 6.7 |
| | 6.67 | 17 | 12 | 9.6 | 8.4 | 7.5 | 6.9 | 6.4 | 6.0 | 5.7 | 5.4 |
| | 5.00 | 12 | 8.9 | 7.3 | 6.4 | 5.7 | 5.3 | 4.9 | 4.6 | 4.3 | 4.1 |
| | 3.33 | 8.4 | 6.0 | 5.0 | 4.3 | 3.9 | 3.5 | 3.3 | 3.1 | 2.9 | 2.7 |
| | 1.67 | 4.3 | 3.1 | 2.5 | 2.2 | 1.9 | 1.8 | 1.6 | 1.5 | 1.4 | 1.4 |
| | 0.00 | 0.00610 | 0.00620 | 0.00540 | 0.00550 | 0.00520 | 0.00520 | 0.00560 | 0.00560 | 0.00560 | 0.00580 |

Stage 2 Acceptance Value (%)
Fill Error Probability Per Mini-tablet Filled = 0.001%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 31 | 22 | 18 | 16 | 14 | 13 | 12 | 11 | 10 | 10 |
| RSD (%) | 13.33 | 28 | 19 | 16 | 14 | 12 | 11 | 11 | 9.9 | 9.4 | 8.9 |
| | 11.67 | 24 | 17 | 14 | 12 | 11 | 10 | 9.3 | 8.7 | 8.2 | 7.8 |
| | 10.00 | 21 | 15 | 12 | 10 | 9.4 | 8.6 | 8.0 | 7.5 | 7.1 | 6.7 |
| | 8.33 | 17 | 12 | 10 | 8.8 | 7.9 | 7.2 | 6.7 | 6.3 | 5.9 | 5.6 |
| | 6.67 | 14 | 9.9 | 8.1 | 7.1 | 6.3 | 5.8 | 5.4 | 5.0 | 4.7 | 4.5 |
| | 5.00 | 10 | 7.5 | 6.1 | 5.3 | 4.8 | 4.3 | 4.0 | 3.8 | 3.6 | 3.4 |
| | 3.33 | 7.1 | 5.0 | 4.1 | 3.6 | 3.2 | 2.9 | 2.7 | 2.5 | 2.4 | 2.2 |
| | 1.67 | 3.6 | 2.5 | 2.1 | 1.8 | 1.6 | 1.5 | 1.3 | 1.3 | 1.2 | 1.1 |
| | 0.00 | 0.00850 | 0.00740 | 0.00780 | 0.00820 | 0.00810 | 0.00800 | 0.00780 | 0.00780 | 0.00790 | 0.00780 |

Stage 1 Failure Probability (%)
Fill Error Probability Per Mini-tablet Filled = 0.01%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 99.9 | 97.8 | 91.0 | 79.5 | 65.1 | 50.5 | 37.4 | 26.5 | 18.3 | 12.2 |
| RSD (%) | 13.33 | 99.6 | 94.9 | 82.2 | 64.3 | 46.0 | 30.7 | 19.3 | 11.7 | 6.81 | 3.84 |
| | 11.67 | 98.9 | 88.0 | 65.8 | 42.3 | 24.2 | 12.7 | 6.36 | 3.02 | 1.40 | 0.628 |
| | 10.00 | 96.6 | 72.5 | 40.4 | 18.4 | 7.28 | 2.76 | 1.02 | 0.378 | 0.144 | 0.0548 |
| | 8.33 | 88.7 | 44.0 | 13.7 | 3.47 | 0.938 | 0.356 | 0.161 | 0.0668 | 0.0233 | 0.00711 |
| | 6.67 | 64.3 | 11.6 | 1.26 | 0.333 | 0.291 | 0.194 | 0.0740 | 0.0186 | 0.00307 | 0.000623 |
| | 5.00 | 18.2 | 0.378 | 0.198 | 0.270 | 0.282 | 0.128 | 0.0215 | 0.00213 | 0.000224 | 0.000183 |
| | 3.33 | 0.141 | 0.132 | 0.198 | 0.270 | 0.28 | 0.0531 | 0.00238 | 0.000322 | <1.00E−04 | <1.00E−04 |
| | 1.67 | 0.0684 | 0.140 | 0.202 | 0.267 | 0.296 | 0.00552 | 0.00103 | <1.00E−04 | 0.000125 | <1.00E−04 |
| | 0.00 | 0.0700 | 0.127 | 0.208 | 0.263 | 0.332 | 0.000818 | 0.00117 | <1.00E−04 | <1.00E−04 | <1.00E−04 |

Stage 2 Failure Probability (%)
Fill Error Probability Per Mini-tablet Filled = 0.01%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 97.1 | 42.2 | 9.94 | 2.27 | 0.548 | 0.141 | 0.0368 | 0.00890 | 0.00227 | 0.000478 |
| RSD (%) | 13.33 | 88.2 | 19.8 | 3.13 | 0.647 | 0.160 | 0.0423 | 0.0110 | 0.00168 | 0.000478 | 0.000160 |
| | 11.67 | 64.3 | 6.20 | 0.826 | 0.255 | 0.0740 | 0.0183 | 0.00425 | 0.000794 | 0.000126 | <1.00E−04 |
| | 10.00 | 29.7 | 1.20 | 0.351 | 0.177 | 0.0474 | 0.00752 | 0.000993 | 0.000171 | <1.00E−04 | <1.00E−04 |
| | 8.33 | 6.64 | 0.287 | 0.246 | 0.138 | 0.0264 | 0.00267 | 0.000239 | <1.00E−04 | <1.00E−04 | <1.00E−04 |
| | 6.67 | 0.497 | 0.158 | 0.188 | 0.128 | 0.0148 | 0.000558 | <1.00E−04 | <1.00E−04 | <1.00E−04 | <1.00E−04 |
| | 5.00 | 0.0932 | 0.129 | 0.196 | 0.131 | 0.00406 | <1.00E−04 | <1.00E−04 | <1.00E−04 | <1.00E−04 | <1.00E−04 |
| | 3.33 | 0.0645 | 0.132 | 0.198 | 0.131 | 0.000299 | <1.00E−04 | <1.00E−04 | <1.00E−04 | <1.00E−04 | <1.00E−04 |
| | 1.67 | 0.0684 | 0.140 | 0.202 | 0.128 | <1.00E−04 | <1.00E−04 | <1.00E−04 | <1.00E−04 | <1.00E−04 | <1.00E−04 |
| | 0.00 | 0.0700 | 0.127 | 0.208 | <1.00E−04 | <1.00E−04 | <1.00E−04 | <1.00E−04 | <1.00E−04 | <1.00E−04 | <1.00E−04 |

Stage 1 Acceptance Value (%)
Fill Error Probability Per Mini-tablet Filled = 0.01%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 38 | 26 | 22 | 19 | 17 | 15 | 14 | 13 | 12 | 12 |
| RSD (%) | 13.33 | 33 | 23 | 19 | 17 | 15 | 14 | 13 | 12 | 11 | 11 |
| | 11.67 | 29 | 21 | 17 | 14 | 13 | 12 | 11 | 10 | 9.7 | 9.3 |
| | 10.00 | 25 | 18 | 14 | 12 | 11 | 10 | 9.5 | 8.9 | 8.4 | 8.0 |
| | 8.33 | 21 | 15 | 12 | 10 | 9.4 | 8.6 | 8.0 | 7.5 | 7.1 | 6.7 |
| | 6.67 | 17 | 12 | 9.7 | 8.4 | 7.6 | 6.9 | 6.5 | 6.1 | 5.7 | 5.4 |
| | 5.00 | 12 | 8.9 | 7.4 | 6.4 | 5.8 | 5.3 | 4.9 | 4.6 | 4.3 | 4.1 |
| | 3.33 | 8.4 | 6.1 | 5.0 | 4.3 | 3.9 | 3.6 | 3.3 | 3.1 | 2.9 | 2.8 |
| | 1.67 | 4.4 | 3.1 | 2.5 | 2.2 | 2.0 | 1.8 | 1.7 | 1.6 | 1.5 | 1.4 |
| | 0.00 | 0.059 | 0.053 | 0.056 | 0.053 | 0.052 | 0.05 | 0.057 | 0.057 | 0.057 | 0.058 |

Stage 2 Acceptance Value (%)
Fill Error Probability Per Mini-tablet Filled = 0.01%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 31 | 22 | 18 | 16 | 14 | 13 | 12 | 11 | 11 | 10 |
| RSD (%) | 13.33 | 28 | 20 | 16 | 14 | 12 | 11 | 11 | 9.9 | 9.4 | 8.9 |
| | 11.67 | 24 | 17 | 14 | 12 | 11 | 10 | 9.3 | 8.7 | 8.2 | 7.8 |
| | 10.00 | 21 | 15 | 12 | 11 | 9.4 | 8.6 | 8.0 | 7.5 | 7.1 | 6.7 |
| | 8.33 | 17 | 12 | 10 | 8.8 | 7.9 | 7.2 | 6.7 | 6.3 | 5.9 | 5.6 |
| | 6.67 | 14 | 10 | 8.2 | 7.1 | 6.4 | 5.8 | 5.4 | 5.0 | 4.8 | 4.5 |
| | 5.00 | 11 | 7.5 | 6.2 | 5.4 | 4.8 | 4.4 | 4.1 | 3.8 | 3.6 | 3.4 |
| | 3.33 | 7.1 | 5.1 | 4.2 | 3.6 | 3.2 | 2.9 | 2.7 | 2.6 | 2.4 | 2.3 |
| | 1.67 | 3.6 | 2.6 | 2.1 | 1.8 | 1.7 | 1.5 | 1.4 | 1.3 | 1.2 | 1.2 |
| | 0.00 | 0.078 | 0.074 | 0.080 | 0.079 | 0.080 | 0.079 | 0.079 | 0.080 | 0.079 | 0.079 |

Stage 1 Failure Probability (%)
Fill Error Probability Per Mini-tablet Filled = 0.1%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 99.9 | 97.8 | 91.2 | 79.9 | 66.1 | 51.9 | 39.1 | 28.4 | 20.1 | 13.9 |
| RSD (%) | 13.33 | 99.6 | 94.9 | 82.5 | 65.0 | 47.5 | 32.6 | 21.5 | 13.6 | 8.41 | 5.10 |
| | 11.67 | 98.9 | 88.2 | 66.4 | 43.6 | 26.3 | 15.1 | 8.50 | 4.72 | 2.59 | 1.43 |
| | 10.00 | 96.6 | 72.8 | 41.4 | 20.3 | 9.79 | 5.20 | 2.90 | 1.57 | 0.796 | 0.381 |
| | 8.33 | 88.7 | 44.5 | 15.2 | 5.72 | 3.52 | 2.52 | 1.47 | 0.684 | 0.278 | 0.103 |
| | 6.67 | 64.4 | 12.6 | 3.03 | 2.70 | 2.83 | 1.90 | 0.760 | 0.234 | 0.0724 | 0.0269 |
| | 5.00 | 18.7 | 1.56 | 1.99 | 2.63 | 2.79 | 1.29 | 0.299 | 0.0771 | 0.0254 | 0.0118 |
| | 3.33 | 0.737 | 1.32 | 1.97 | 2.62 | 2.77 | 0.604 | 0.109 | 0.0403 | 0.0115 | 0.0101 |
| | 1.67 | 0.669 | 1.32 | 1.97 | 2.63 | 2.93 | 0.123 | 0.0985 | 0.0128 | 0.00967 | 0.0103 |
| | 0.00 | 0.661 | 1.33 | 1.98 | 2.61 | 3.29 | 0.0751 | 0.103 | 0.00733 | 0.00937 | 0.00947 |

Stage 2 Failure Probability (%)
Fill Error Probability Per Mini-tablet Filled = 0.1%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 97.1 | 44.1 | 13.5 | 5.09 | 1.98 | 0.723 | 0.237 | 0.0735 | 0.0251 | 0.00851 |
| RSD (%) | 13.33 | 88.4 | 22.5 | 6.92 | 3.18 | 1.20 | 0.373 | 0.105 | 0.0263 | 0.00821 | 0.00257 |
| | 11.67 | 64.8 | 9.19 | 4.38 | 2.32 | 0.775 | 0.184 | 0.0398 | 0.0105 | 0.00267 | 0.00129 |
| | 10.00 | 30.9 | 4.05 | 3.27 | 1.73 | 0.458 | 0.091 | 0.0158 | 0.00366 | 0.000927 | 0.000498 |
| | 8.33 | 8.23 | 2.49 | 2.38 | 1.35 | 0.283 | 0.0317 | 0.00495 | 0.00277 | 0.00198 | 0.000324 |
| | 6.67 | 1.85 | 1.63 | 1.98 | 1.29 | 0.152 | 0.00742 | 0.00396 | 0.00198 | 0.000927 | 0.000299 |
| | 5.00 | 0.907 | 1.31 | 1.98 | 1.30 | 0.0433 | 0.00366 | 0.00504 | 0.00346 | 0.000173 | <1.00E−04 |
| | 3.33 | 0.663 | 1.32 | 1.97 | 1.32 | 0.00435 | 0.00346 | 0.00435 | 0.00198 | <1.00E−04 | <1.00E−04 |
| | 1.67 | 0.669 | 1.32 | 1.97 | 1.31 | 0.00297 | 0.00356 | 0.00633 | 0.00366 | <1.00E−04 | <1.00E−06 |
| | 0.00 | 0.661 | 1.33 | 1.98 | 0.00138 | 0.00218 | 0.00287 | 0.00584 | <1.00E−04 | <1.00E−04 | <1.00E−04 |

Stage 1 Acceptance Value (%)
Fill Error Probability Per Mini-tablet Filled = 0.1%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 38 | 27 | 22 | 19 | 17 | 15 | 14 | 13 | 13 | 12 |
| RSD (%) | 13.33 | 34 | 24 | 19 | 17 | 15 | 14 | 13 | 12 | 11 | 11 |
| | 11.67 | 30 | 21 | 17 | 15 | 13 | 12 | 11 | 11 | 9.9 | 9.4 |
| | 10.00 | 25 | 18 | 15 | 13 | 11 | 10 | 9.7 | 9.1 | 8.6 | 8.2 |
| | 8.33 | 21 | 15 | 12 | 11 | 9.6 | 8.8 | 8.2 | 7.7 | 7.3 | 7.0 |
| | 6.67 | 17 | 12 | 10 | 8.7 | 7.9 | 7.2 | 6.7 | 6.3 | 6.0 | 5.7 |
| | 5.00 | 13 | 9.3 | 7.7 | 6.8 | 6.1 | 5.6 | 5.2 | 4.9 | 4.6 | 4.4 |
| | 3.33 | 8.9 | 6.5 | 5.4 | 4.7 | 4.3 | 3.9 | 3.7 | 3.5 | 3.3 | 3.1 |
| | 1.67 | 4.8 | 3.6 | 3.0 | 2.6 | 2.4 | 2.2 | 2.1 | 2.0 | 1.9 | 1.8 |
| | 0.00 | 0.56 | 0.55 | 0.54 | 0.52 | 0.52 | 0.51 | 0.57 | 0.56 | 0.56 | 0.56 |

Stage 2 Acceptance Value (%)
Fill Error Probability Per Mini-tablet Filled = 0.1%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 31 | 22 | 18 | 16 | 14 | 13 | 12 | 11 | 11 | 10 |
| RSD (%) | 13.33 | 28 | 20 | 16 | 14 | 13 | 12 | 11 | 10 | 9.5 | 9.1 |
| | 11.67 | 25 | 17 | 14 | 12 | 11 | 10 | 9.5 | 8.9 | 8.4 | 8.0 |
| | 10.00 | 21 | 15 | 12 | 11 | 9.7 | 8.9 | 8.2 | 7.7 | 7.3 | 6.9 |
| | 8.33 | 18 | 13 | 10 | 9.1 | 8.2 | 7.5 | 7.0 | 6.5 | 6.2 | 5.8 |
| | 6.67 | 14 | 10 | 8.6 | 7.5 | 6.7 | 6.1 | 5.7 | 5.3 | 5.0 | 4.8 |
| | 5.00 | 11 | 8.0 | 6.6 | 5.8 | 5.2 | 4.8 | 4.4 | 4.1 | 3.9 | 3.7 |
| | 3.33 | 7.7 | 5.6 | 4.7 | 4.1 | 3.7 | 3.4 | 3.2 | 3.0 | 2.8 | 2.7 |
| | 1.67 | 4.2 | 3.2 | 2.7 | 2.4 | 2.2 | 2.1 | 1.9 | 1.8 | 1.8 | 1.7 |
| | 0.00 | 0.77 | 0.73 | 0.78 | 0.78 | 0.77 | 0.76 | 0.76 | 0.76 | 0.75 | 0.75 |

Stage 1 Failure Probability (%)
Fill Error Probability Per Mini-tablet Filled = 1%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 99.9 | 98.0 | 92.7 | 84.2 | 74.0 | 63.5 | 53.6 | 44.5 | 36.1 | 28.9 |
| RSD (%) | 13.33 | 99.7 | 95.6 | 85.4 | 72.4 | 59.8 | 49.0 | 39.7 | 31.5 | 24.6 | 18.7 |
| | 11.67 | 99.0 | 89.5 | 71.9 | 55.4 | 43.7 | 35.3 | 28.1 | 21.6 | 16.0 | 11.6 |
| | 10.00 | 96.8 | 76.0 | 51.1 | 37.0 | 31.1 | 26.5 | 20.8 | 15.1 | 10.4 | 7.02 |
| | 8.33 | 89.4 | 50.9 | 29.2 | 25.6 | 26.0 | 22.2 | 15.7 | 10.4 | 6.66 | 4.24 |
| | 6.67 | 66.5 | 22.6 | 19.0 | 23.3 | 25.1 | 18.7 | 11.3 | 7.04 | 4.30 | 2.68 |
| | 5.00 | 23.4 | 12.7 | 18.2 | 23.3 | 24.6 | 14.5 | 8.09 | 5.13 | 2.89 | 1.89 |
| | 3.33 | 6.57 | 12.5 | 18.1 | 23.4 | 24.5 | 9.41 | 7.05 | 3.75 | 2.19 | 1.64 |
| | 1.67 | 6.44 | 12.6 | 18.1 | 23.3 | 25.7 | 6.13 | 7.35 | 2.18 | 2.13 | 1.47 |
| | 0.00 | 6.49 | 12.5 | 18.2 | 23.4 | 28.3 | 5.80 | 7.53 | 1.82 | 2.04 | 1.17 |

Stage 2 Failure Probability (%)
Fill Error Probability Per Mini-tablet Filled = 1%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 97.6 | 60.5 | 42.8 | 29.5 | 15.9 | 7.15 | 3.06 | 1.30 | 0.582 | 0.280 |
| RSD (%) | 13.33 | 90.2 | 44.9 | 37.4 | 25.7 | 12.2 | 4.68 | 1.75 | 0.756 | 0.360 | 0.163 |
| | 11.67 | 70.6 | 34.4 | 33.0 | 21.6 | 8.80 | 2.76 | 1.00 | 0.477 | 0.231 | 0.0962 |
| | 10.00 | 42.0 | 27.9 | 27.2 | 17.3 | 5.99 | 1.51 | 0.635 | 0.383 | 0.176 | 0.0598 |
| | 8.33 | 22.2 | 21.5 | 21.1 | 14.6 | 3.96 | 0.813 | 0.523 | 0.333 | 0.128 | 0.0338 |
| | 6.67 | 14.3 | 14.9 | 18.2 | 14.1 | 2.20 | 0.501 | 0.498 | 0.320 | 0.0829 | 0.0190 |
| | 5.00 | 8.56 | 12.6 | 18.1 | 13.9 | 0.876 | 0.413 | 0.487 | 0.298 | 0.0436 | 0.00930 |
| | 3.33 | 6.51 | 12.5 | 18.1 | 13.5 | 0.350 | 0.365 | 0.524 | 0.290 | 0.0108 | 0.0112 |
| | 1.67 | 6.44 | 12.6 | 18.1 | 12.0 | 0.326 | 0.371 | 0.509 | 0.285 | 0.00633 | 0.00732 |
| | 0.00 | 6.49 | 12.5 | 18.2 | 0.504 | 0.343 | 0.361 | 0.530 | 0.00455 | 0.00682 | 0.00732 |

Stage 1 Acceptance Value (%)
Fill Error Probability Per Mini-tablet Filled = 1%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 41 | 29 | 24 | 21 | 19 | 17 | 16 | 15 | 14 | 13 |
| RSD (%) | 13.33 | 37 | 27 | 22 | 19 | 17 | 16 | 14 | 14 | 13 | 12 |
| | 11.67 | 33 | 24 | 20 | 17 | 15 | 14 | 13 | 12 | 12 | 11 |
| | 10.00 | 29 | 21 | 17 | 15 | 14 | 13 | 12 | 11 | 10 | 10 |
| | 8.33 | 25 | 18 | 15 | 13 | 12 | 11 | 10 | 9.9 | 9.4 | 8.9 |
| | 6.67 | 21 | 16 | 13 | 12 | 11 | 9.9 | 9.3 | 8.8 | 8.3 | 8 |
| | 5.00 | 17 | 13 | 11 | 10 | 9.2 | 8.6 | 8.1 | 7.7 | 7.3 | 7.0 |
| | 3.33 | 13 | 11 | 9.2 | 8.3 | 7.7 | 7.2 | 6.9 | 6.6 | 6.4 | 6.2 |
| | 1.67 | 9.5 | 8.0 | 7.2 | 6.6 | 6.2 | 5.9 | 5.8 | 5.7 | 5.5 | 5.3 |
| | 0.00 | 5.5 | 5.3 | 5.1 | 4.9 | 4.8 | 4.6 | 4.9 | 4.8 | 4.7 | 4.6 |

Stage 2 Acceptance Value (%)
Fill Error Probability Per Mini-tablet Filled = 1%
Fill Count

| | | 1 | 2 | 3 | 4 | 5 | 6 | 7 | 8 | 9 | 10 |
|---|---|---|---|---|---|---|---|---|---|---|---|
| Composite | 15.00 | 35 | 25 | 20 | 18 | 16 | 14 | 13 | 13 | 12 | 11 |
| RSD (%) | 13.33 | 31 | 22 | 18 | 16 | 14 | 13 | 12 | 12 | 11 | 10 |
| | 11.67 | 28 | 20 | 17 | 15 | 13 | 12 | 11 | 10 | 9.9 | 9.4 |
| | 10.00 | 25 | 18 | 15 | 13 | 12 | 11 | 10 | 9.5 | 9 | 8.5 |
| | 8.33 | 22 | 16 | 13 | 12 | 11 | 9.8 | 9.1 | 8.6 | 8.1 | 7.7 |
| | 6.67 | 19 | 14 | 12 | 11 | 9.5 | 8.8 | 8.2 | 7.7 | 7.3 | 6.9 |
| | 5.00 | 16 | 12 | 10 | 9.3 | 8.5 | 7.8 | 7.3 | 6.9 | 6.5 | 6.2 |
| | 3.33 | 13 | 10 | 9.1 | 8.2 | 7.5 | 7 | 6.6 | 6.2 | 5.9 | 5.6 |
| | 1.67 | 10 | 8.5 | 7.8 | 7.1 | 6.7 | 6.3 | 6 | 5.7 | 5.4 | 5.2 |
| | 0.00 | 7.3 | 6.7 | 6.6 | 6.3 | 6.1 | 5.8 | 5.6 | 5.3 | 5.1 | 5.0 |

### Supplementary Information Section 2.3—Tables of Calculated Values Corresponding to FIG. 14

Stage 1 Failure Probability (%)
Composite RSD = 0%
Fill Count

| | | 1 | 2 | 3 | 4 | 5 | 6 | 7 | 8 | 9 | 10 |
|---|---|---|---|---|---|---|---|---|---|---|---|
| Log | 1.00 | 49.8 | 74.3 | 86.4 | 92.6 | 95.9 | 88.0 | 92.1 | 83.9 | 85.0 | 79.0 |
| Fill | 0.44 | 17.1 | 31.2 | 42.7 | 52.1 | 60.1 | 28.8 | 35.1 | 17.0 | 18.3 | 11.6 |
| Error | −0.11 | 5.03 | 9.85 | 14.3 | 18.6 | 22.7 | 3.70 | 4.85 | 0.985 | 1.11 | 0.653 |
| Proba- | −0.67 | 1.41 | 2.83 | 4.24 | 5.57 | 6.91 | 0.337 | 0.432 | 0.0452 | 0.0543 | 0.0472 |
| bility | −1.22 | 0.394 | 0.814 | 1.19 | 1.59 | 1.98 | 0.0272 | 0.0374 | 0.00257 | 0.00344 | 0.00371 |
| Per | −1.78 | 0.115 | 0.225 | 0.324 | 0.444 | 0.558 | 0.00215 | 0.00252 | 0.000299 | 0.000274 | 0.000374 |
| Mini- | −2.33 | 0.0273 | 0.0652 | 0.0900 | 0.122 | 0.156 | 0.000224 | <1.00E−04 | <1.00E−04 | <1.00E−04 | <1.00E−04 |
| tablet | −2.89 | 0.00712 | 0.0147 | 0.0249 | 0.0355 | 0.0427 | <1.00E−04 | <1.00E−04 | <1.00E−04 | <1.00E−04 | <1.00E−04 |
| Filled | −3.44 | 0.00277 | 0.00504 | 0.00584 | 0.00888 | 0.0121 | <1.00E−04 | <1.00E−04 | <1.00E−04 | <1.00E−04 | <1.00E−04 |
| (%) | −4.00 | 0.000860 | 0.00129 | 0.00257 | 0.00279 | 0.00292 | <1.00E−04 | <1.00E−04 | <1.00E−04 | <1.00E−04 | <1.00E−04 |

Stage 2 Failure Probability (%)
Composite RSD = 0%
Fill Count

| | | 1 | 2 | 3 | 4 | 5 | 6 |
|---|---|---|---|---|---|---|---|
| Log | 1.00 | 49.8 | 74.3 | 86.4 | 76.1 | 48.3 | 50.8 |
| Fill | 0.44 | 17.1 | 31.2 | 42.7 | 8.16 | 3.53 | 3.64 |
| Error | −0.11 | 5.03 | 9.85 | 14.3 | 0.228 | 0.194 | 0.211 |
| Probability | −0.67 | 1.41 | 2.83 | 4.24 | 0.00762 | 0.0118 | 0.0171 |
| Per | −1.22 | 0.394 | 0.814 | 1.19 | 0.000597 | 0.000993 | 0.00126 |
| Mini-tablet | −1.78 | 0.115 | 0.225 | 0.324 | 5.00E−05 | 0.000114 | <1.00E−04 |
| Filled | −2.33 | 0.0273 | 0.0652 | 0.0900 | <1.00E−04 | <1.00E−04 | <1.00E−04 |
| (%) | −2.89 | 0.00712 | 0.0147 | 0.0249 | <1.00E−04 | <1.00E−04 | <1.00E−04 |
| | −3.44 | 0.00277 | 0.00504 | 0.00584 | <1.00E−04 | <1.00E−04 | <1.00E−04 |
| | −4.00 | 0.000860 | 0.00129 | 0.00257 | <1.00E−04 | <1.00E−04 | <1.00E−04 |

| | | 7 | 8 | 9 | 10 |
|---|---|---|---|---|---|
| Log | 1.00 | 62.0 | 15.7 | 11.2 | 14.0 |
| Fill | 0.44 | 5.38 | 0.150 | 0.161 | 0.211 |
| Error | −0.11 | 0.302 | 0.00208 | 0.00257 | 0.00396 |
| Probability | −0.67 | 0.0205 | <1.00E−04 | <1.00E−04 | <1.00E−04 |
| Per | −1.22 | 0.00168 | <1.00E−04 | <1.00E−04 | <1.00E−04 |
| Mini-tablet | −1.78 | 0.000126 | <1.00E−04 | <1.00E−04 | <1.00E−04 |
| Filled | −2.33 | <1.00E−04 | <1.00E−04 | <1.00E−04 | <1.00E−04 |
| (%) | −2.89 | <1.00E−04 | <1.00E−04 | <1.00E−04 | <1.00E−04 |
| | −3.44 | <1.00E−04 | <1.00E−04 | <1.00E−04 | <1.00E−04 |
| | −4.00 | <1.00E−04 | <1.00E−04 | <1.00E−04 | <1.00E−04 |

Stage 1 Acceptance Value (%)
Composite RSD = 0%
Fill Count

| | | 1 | 2 | 3 | 4 | 5 | 6 | 7 | 8 | 9 | 10 |
|---|---|---|---|---|---|---|---|---|---|---|---|
| Log | 1.00 | 47 | 40 | 34 | 30 | 28 | 25 | 24 | 22 | 21 | 20 |
| Fill | 0.44 | 15 | 14 | 13 | 12 | 11 | 11 | 11 | 11 | 10 | 9.7 |
| Error | −0.11 | 4.3 | 4.2 | 4 | 3.9 | 3.8 | 3.7 | 3.9 | 3.9 | 3.8 | 3.7 |
| Probability | −0.67 | 1.2 | 1.2 | 1.2 | 1.1 | 1.1 | 1.1 | 1.2 | 1.2 | 1.2 | 1.2 |
| Per | −1.22 | 0.33 | 0.34 | 0.32 | 0.32 | 0.31 | 0.30 | 0.34 | 0.34 | 0.34 | 0.34 |
| Mini-tablet | −1.78 | 0.097 | 0.093 | 0.088 | 0.089 | 0.088 | 0.085 | 0.095 | 0.094 | 0.095 | 0.095 |
| Filled | −2.33 | 0.023 | 0.027 | 0.024 | 0.024 | 0.025 | 0.024 | 0.027 | 0.027 | 0.027 | 0.027 |
| (%) | −2.89 | 0.0060 | 0.0061 | 0.0068 | 0.0071 | 0.0067 | 0.0066 | 0.0075 | 0.0072 | 0.0077 | 0.0075 |
| | −3.44 | 0.0023 | 0.0021 | 0.0016 | 0.0018 | 0.0019 | 0.0018 | 0.0020 | 0.0020 | 0.0020 | 0.0020 |
| | −4.00 | 0.00073 | 0.00053 | 0.00070 | 0.00056 | 0.00046 | 0.00053 | 0.00061 | 0.00056 | 0.00058 | 0.00065 |

Stage 2 Acceptance Value (%)
Composite RSD = 0%
Fill Count

| | | 1 | 2 | 3 | 4 | 5 | 6 | 7 | 8 | 9 | 10 |
|---|---|---|---|---|---|---|---|---|---|---|---|
| Log | 1.00 | 49 | 36 | 30 | 26 | 24 | 22 | 20 | 19 | 18 | 17 |
| Fill | 0.44 | 18 | 16 | 14 | 13 | 12 | 11 | 10 | 9.8 | 9.3 | 8.9 |
| Error | −0.11 | 5.7 | 5.3 | 5.3 | 5.1 | 5.0 | 4.8 | 4.6 | 4.5 | 4.3 | 4.2 |
| Probability | −0.67 | 1.6 | 1.6 | 1.6 | 1.6 | 1.6 | 1.6 | 1.6 | 1.6 | 1.5 | 1.5 |
| Per | −1.22 | 0.46 | 0.44 | 0.47 | 0.47 | 0.47 | 0.46 | 0.47 | 0.46 | 0.46 | 0.46 |
| Mini-tablet | −1.78 | 0.13 | 0.12 | 0.13 | 0.13 | 0.13 | 0.13 | 0.13 | 0.13 | 0.13 | 0.13 |
| Filled | −2.33 | 0.031 | 0.035 | 0.036 | 0.037 | 0.037 | 0.037 | 0.037 | 0.037 | 0.037 | 0.037 |
| (%) | −2.89 | 0.0096 | 0.0093 | 0.010 | 0.010 | 0.010 | 0.010 | 0.010 | 0.010 | 0.010 | 0.010 |
| | −3.44 | 0.0024 | 0.0029 | 0.0026 | 0.0028 | 0.0029 | 0.0028 | 0.0029 | 0.0029 | 0.0029 | 0.0028 |
| | −4.00 | 0.00094 | 0.00067 | 0.00083 | 0.00077 | 0.00071 | 0.00078 | 0.00080 | 0.00077 | 0.00078 | 0.00074 |

Stage 1 Failure Probability (%)
Composite RSD = 2%
Fill Count

| | | 1 | 2 | 3 | 4 | 5 | 6 | 7 | 8 | 9 | 10 |
|---|---|---|---|---|---|---|---|---|---|---|---|
| Log | 1.00 | 49.8 | 74.2 | 86.4 | 92.6 | 94.1 | 88.2 | 91.5 | 85 | 86.1 | 81.5 |
| Fill | 0.44 | 17.1 | 31.1 | 42.7 | 52.2 | 55.4 | 29.7 | 34.1 | 19.2 | 19.2 | 14.4 |
| Error | −0.11 | 5.05 | 9.79 | 14.4 | 18.7 | 20.2 | 4.29 | 4.67 | 1.42 | 1.16 | 0.839 |
| Proba- | −0.67 | 1.43 | 2.82 | 4.19 | 5.6 | 6.07 | 0.539 | 0.435 | 0.0842 | 0.0569 | 0.0497 |
| bility | −1.22 | 0.400 | 0.781 | 1.19 | 1.59 | 1.73 | 0.0819 | 0.0387 | 0.00742 | 0.00277 | 0.00337 |
| Per | −1.78 | 0.108 | 0.224 | 0.330 | 0.453 | 0.485 | 0.019 | 0.00299 | 0.000366 | 0.000150 | 0.000175 |
| Mini- | −2.33 | 0.0315 | 0.0605 | 0.0916 | 0.121 | 0.133 | 0.00541 | 0.00028 | <1.00E−04 | <1.00E−04 | <1.00E−04 |
| tablet | −2.89 | 0.00989 | 0.0150 | 0.0277 | 0.0352 | 0.0377 | 0.00117 | <1.00E−04 | <1.00E−04 | <1.00E−04 | <1.00E−04 |
| Filled | −3.44 | 0.00227 | 0.00475 | 0.00831 | 0.00900 | 0.00910 | 0.000299 | <1.00E−04 | <1.00E−04 | <1.00E−04 | <1.00E−04 |
| (%) | −4.00 | 0.000860 | 0.00129 | 0.00257 | 0.00251 | 0.00309 | 0.000249 | <1.00E−04 | <1.00E−04 | <1.00E−04 | <1.00E−04 |

Stage 2 Failure Probability (%)
Composite RSD = 2%
Fill Count

| | | 1 | 2 | 3 | 4 | 5 | 6 | 7 | 8 | 9 | 10 |
|---|---|---|---|---|---|---|---|---|---|---|---|
| Log | 1.00 | 49.8 | 74.2 | 86.4 | 89.3 | 48.2 | 51.0 | 61.6 | 38.0 | 11.7 | 14.3 |
| Fill | 0.44 | 17.1 | 31.1 | 42.7 | 34.7 | 3.39 | 3.71 | 5.29 | 2.32 | 0.172 | 0.223 |
| Error | −0.11 | 5.05 | 9.79 | 14.4 | 9.72 | 0.178 | 0.218 | 0.298 | 0.171 | 0.00218 | 0.00386 |
| Proba- | −0.67 | 1.43 | 2.82 | 4.19 | 2.80 | 0.0122 | 0.0143 | 0.0222 | 0.0120 | 0.000113 | <1.00E−04 |
| bility | −1.22 | 0.400 | 0.781 | 1.19 | 0.796 | 0.000597 | 0.000794 | 0.00198 | 0.00129 | <1.00E−04 | <1.00E−04 |
| Per | −1.78 | 0.108 | 0.224 | 0.330 | 0.229 | <1.00E−04 | <1.00E−04 | 0.000133 | <1.00E−04 | <1.00E−04 | <1.00E−04 |
| Mini- | −2.33 | 0.0315 | 0.0605 | 0.0916 | 0.0592 | <1.00E−04 | <1.00E−04 | <1.00E−04 | <1.00E−04 | <1.00E−04 | <1.00E−04 |
| tablet | −2.89 | 0.00989 | 0.0150 | 0.0277 | 0.0169 | <1.00E−04 | <1.00E−04 | <1.00E−04 | <1.00E−04 | <1.00E−04 | <1.00E−04 |
| Filled | −3.44 | 0.00227 | 0.00475 | 0.00831 | 0.00406 | <1.00E−04 | <1.00E−04 | <1.00E−04 | <1.00E−04 | <1.00E−04 | <1.00E−04 |
| (%) | −4.00 | 0.000860 | 0.00129 | 0.00257 | 0.00152 | <1.00E−04 | <1.00E−04 | <1.00E−04 | <1.00E−04 | <1.00E−04 | <1.00E−04 |

Stage 1 Acceptance Value (%)
Composite RSD = 2%
Fill Count

| | | 1 | 2 | 3 | 4 | 5 | 6 | 7 | 8 | 9 | 10 |
|---|---|---|---|---|---|---|---|---|---|---|---|
| Log | 1.00 | 50 | 41 | 35 | 31 | 28 | 26 | 24 | 22 | 21 | 20 |
| Fill | 0.44 | 19 | 16 | 15 | 13 | 13 | 12 | 11 | 11 | 10 | 10 |
| Error | −0.11 | 9.2 | 7.5 | 6.6 | 6.0 | 5.6 | 5.3 | 5.2 | 5.1 | 4.9 | 4.7 |
| Probability | −0.67 | 6.3 | 4.7 | 4.0 | 3.6 | 3.3 | 3.1 | 2.9 | 2.8 | 2.7 | 2.6 |
| Per | −1.22 | 5.5 | 4.0 | 3.3 | 2.9 | 2.6 | 2.4 | 2.2 | 2.1 | 2.0 | 1.9 |
| Mini-tablet | −1.78 | 5.2 | 3.7 | 3.1 | 2.7 | 2.4 | 2.2 | 2.0 | 1.9 | 1.8 | 1.7 |
| Filled | −2.33 | 5.2 | 3.7 | 3.0 | 2.6 | 2.3 | 2.1 | 2.0 | 1.9 | 1.7 | 1.7 |
| (%) | −2.89 | 5.2 | 3.7 | 3.0 | 2.6 | 2.3 | 2.1 | 2.0 | 1.8 | 1.7 | 1.6 |
| | −3.44 | 5.1 | 3.7 | 3.0 | 2.6 | 2.3 | 2.1 | 2.0 | 1.8 | 1.7 | 1.6 |
| | −4.00 | 5.1 | 3.7 | 3.0 | 2.6 | 2.3 | 2.1 | 2.0 | 1.8 | 1.7 | 1.6 |

Stage 2 Acceptance Value (%)
Composite RSD = 2%
Fill Count

| | | 1 | 2 | 3 | 4 | 5 | 6 | 7 | 8 | 9 | 10 |
|---|---|---|---|---|---|---|---|---|---|---|---|
| Log | 1.00 | 50 | 37 | 30 | 26 | 24 | 22 | 20 | 19 | 18 | 17 |
| Fill | 0.44 | 21 | 17 | 15 | 13 | 12 | 11 | 11 | 9.9 | 9.4 | 9.0 |
| Error | −0.11 | 9.4 | 7.6 | 6.9 | 6.3 | 5.9 | 5.6 | 5.3 | 5.0 | 4.8 | 4.6 |
| Probability | −0.67 | 5.7 | 4.4 | 3.8 | 3.4 | 3.2 | 3.0 | 2.8 | 2.7 | 2.6 | 2.5 |
| Per | −1.22 | 4.7 | 3.4 | 2.8 | 2.5 | 2.3 | 2.1 | 2.0 | 1.8 | 1.8 | 1.7 |
| Mini-tablet | −1.78 | 4.4 | 3.1 | 2.6 | 2.2 | 2.0 | 1.8 | 1.7 | 1.6 | 1.5 | 1.4 |
| Filled | −2.33 | 4.3 | 3.0 | 2.5 | 2.2 | 1.9 | 1.8 | 1.6 | 1.5 | 1.4 | 1.4 |
| (%) | −2.89 | 4.3 | 3.0 | 2.5 | 2.1 | 1.9 | 1.7 | 1.6 | 1.5 | 1.4 | 1.4 |
| | −3.44 | 4.3 | 3.0 | 2.5 | 2.1 | 1.9 | 1.7 | 1.6 | 1.5 | 1.4 | 1.3 |
| | −4.00 | 4.3 | 3.0 | 2.5 | 2.1 | 1.9 | 1.7 | 1.6 | 1.5 | 1.4 | 1.3 |

Stage 1 Failure Probability (%)
Composite RSD = 4%
Fill Count

| | | 1 | 2 | 3 | 4 | 5 | 6 | 7 | 8 | 9 | 10 |
|---|---|---|---|---|---|---|---|---|---|---|---|
| Log | 1.00 | 50.8 | 74.2 | 86.4 | 92.7 | 93.7 | 90.0 | 90.5 | 87.4 | 85.6 | 82.1 |
| Fill | 0.44 | 18.6 | 31.1 | 42.7 | 52.2 | 54.3 | 36.7 | 33.0 | 25.0 | 19.5 | 15.7 |
| Error | −0.11 | 6.89 | 9.77 | 14.4 | 18.7 | 19.6 | 8.47 | 4.69 | 2.67 | 1.33 | 0.949 |
| Probability | −0.67 | 3.28 | 2.83 | 4.24 | 5.59 | 5.91 | 1.98 | 0.500 | 0.222 | 0.0746 | 0.0520 |
| Per | −1.22 | 2.27 | 0.795 | 1.19 | 1.57 | 1.70 | 0.513 | 0.0655 | 0.0189 | 0.00513 | 0.00362 |
| Mini-tablet | −1.78 | 1.99 | 0.225 | 0.332 | 0.448 | 0.474 | 0.141 | 0.0117 | 0.00167 | 0.000249 | 0.000175 |
| Filled | −2.33 | 1.94 | 0.0613 | 0.0948 | 0.127 | 0.135 | 0.0390 | 0.00297 | 0.000199 | <1.00E−04 | <1.00E−04 |
| (%) | −2.89 | 1.88 | 0.0169 | 0.0269 | 0.0365 | 0.0375 | 0.0107 | 0.000848 | <1.00E−04 | <1.00E−04 | <1.00E−04 |
| | −3.44 | 1.87 | 0.00603 | 0.00831 | 0.00900 | 0.00992 | 0.00334 | 0.000249 | <1.00E−04 | <1.00E−04 | <1.00E−04 |
| | −4.00 | 1.88 | 0.00247 | 0.00257 | 0.00251 | 0.00287 | 0.000997 | <1.00E−04 | <1.00E−04 | <1.00E−04 | <1.00E−04 |

Stage 2 Failure Probability (%)
Composite RSD = 4%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 50.5 | 74.2 | 86.4 | 90.0 | 50.5 | 51.8 | 59.8 | 41.1 | 14.0 | 14.3 |
| Error | 0.44 | 17.6 | 31.1 | 42.7 | 38.3 | 3.86 | 4.05 | 5.08 | 2.74 | 0.287 | 0.231 |
| Proba- | −0.11 | 5.26 | 9.77 | 14.4 | 10.6 | 0.272 | 0.235 | 0.297 | 0.179 | 0.0120 | 0.00445 |
| bility | −0.67 | 1.49 | 2.83 | 4.24 | 2.85 | 0.0351 | 0.0156 | 0.0201 | 0.0145 | 0.000696 | <1.00E−04 |
| Per | −1.22 | 0.406 | 0.794 | 1.19 | 0.780 | 0.00851 | 0.000993 | 0.00208 | 0.00138 | <1.00E−04 | <1.00E−04 |
| Mini- | −1.78 | 0.116 | 0.224 | 0.332 | 0.219 | 0.00218 | <1.00E−04 | <1.00E−04 | <1.00E−04 | <1.00E−04 | <1.00E−04 |
| tablet | −2.33 | 0.0318 | 0.0603 | 0.0948 | 0.0627 | 0.000597 | <1.00E−04 | <1.00E−04 | <1.00E−04 | <1.00E−04 | <1.00E−04 |
| Filled | −2.89 | 0.00861 | 0.0159 | 0.0269 | 0.0180 | 0.000239 | <1.00E−04 | <1.00E−04 | <1.00E−04 | <1.00E−04 | <1.00E−04 |
| (%) | −3.44 | 0.00227 | 0.00475 | 0.00831 | 0.00406 | <1.00E−04 | <1.00E−04 | <1.00E−04 | <1.00E−04 | <1.00E−04 | <1.00E−04 |
| | −4.00 | 0.000860 | 0.00129 | 0.00247 | 0.00146 | <1.00E−04 | <1.00E−04 | <1.00E−04 | <1.00E−04 | <1.00E−04 | <1.00E−04 |

Stage 1 Acceptance Value (%)
Composite RSD = 4%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 53 | 42 | 36 | 31 | 28 | 26 | 24 | 23 | 21 | 20 |
| Error | 0.44 | 23 | 19 | 17 | 15 | 14 | 13 | 12 | 12 | 11 | 11 |
| Probability | −0.11 | 14 | 11 | 9.2 | 8.2 | 7.5 | 7.0 | 6.6 | 6.3 | 6.1 | 5.9 |
| Per | −0.67 | 11 | 8.2 | 6.8 | 6.0 | 5.5 | 5.0 | 4.7 | 4.5 | 4.2 | 4.1 |
| Mini-tablet | −1.22 | 10 | 7.5 | 6.2 | 5.4 | 4.9 | 4.4 | 4.1 | 3.9 | 3.7 | 3.5 |
| Filled | −1.78 | 10 | 7.3 | 6.0 | 5.2 | 4.7 | 4.3 | 4.0 | 3.7 | 3.5 | 3.3 |
| (%) | −2.33 | 10 | 7.2 | 5.9 | 5.2 | 4.6 | 4.2 | 3.9 | 3.7 | 3.5 | 3.3 |
| | −2.89 | 10 | 7.2 | 5.9 | 5.2 | 4.6 | 4.2 | 3.9 | 3.7 | 3.5 | 3.3 |
| | −3.44 | 10 | 7.2 | 5.9 | 5.1 | 4.6 | 4.2 | 3.9 | 3.7 | 3.4 | 3.3 |
| | −4.00 | 10 | 7.2 | 5.9 | 5.1 | 4.6 | 4.2 | 3.9 | 3.7 | 3.4 | 3.3 |

Stage 2 Acceptance Value (%)
Composite RSD = 4%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 51 | 37 | 31 | 27 | 24 | 22 | 20 | 19 | 18 | 17 |
| Error | 0.44 | 24 | 18 | 16 | 14 | 13 | 12 | 11 | 10 | 9.7 | 9.3 |
| Probability | −0.11 | 13 | 10 | 8.6 | 7.8 | 7.1 | 6.6 | 6.2 | 5.8 | 5.5 | 5.3 |
| Per | −0.67 | 9.8 | 7.2 | 6 | 5.3 | 4.8 | 4.4 | 4.1 | 3.9 | 3.7 | 3.5 |
| Mini-tablet | −1.22 | 8.8 | 6.3 | 5.2 | 4.6 | 4.1 | 3.8 | 3.5 | 3.3 | 3.1 | 2.9 |
| Filled | −1.78 | 8.6 | 6.1 | 5.0 | 4.3 | 3.9 | 3.6 | 3.3 | 3.1 | 2.9 | 2.8 |
| (%) | −2.33 | 8.5 | 6.0 | 4.9 | 4.3 | 3.8 | 3.5 | 3.2 | 3.0 | 2.9 | 2.7 |
| | −2.89 | 8.5 | 6.0 | 4.9 | 4.3 | 3.8 | 3.5 | 3.2 | 3.0 | 2.8 | 2.7 |
| | −3.44 | 8.5 | 6.0 | 4.9 | 4.3 | 3.8 | 3.5 | 3.2 | 3.0 | 2.8 | 2.7 |
| | −4.00 | 8.5 | 6.0 | 4.9 | 4.3 | 3.8 | 3.5 | 3.2 | 3.0 | 2.8 | 2.7 |

Stage 1 Failure Probability (%)
Composite RSD = 6%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 73.4 | 75.3 | 86.4 | 92.5 | 93.9 | 91.9 | 90.9 | 88.9 | 86.4 | 83.3 |
| Error | 0.44 | 56.0 | 33.9 | 42.7 | 52.0 | 54.7 | 44.5 | 36.1 | 29.4 | 23.0 | 18.0 |
| Probability | −0.11 | 49.6 | 13.4 | 14.5 | 18.5 | 19.9 | 13.2 | 6.97 | 3.98 | 2.21 | 1.30 |
| Per | −0.67 | 47.8 | 6.69 | 4.37 | 5.57 | 6.01 | 3.59 | 1.35 | 0.457 | 0.187 | 0.0870 |
| Mini-tablet | −1.22 | 47.1 | 4.74 | 1.37 | 1.58 | 1.70 | 0.999 | 0.323 | 0.0713 | 0.0185 | 0.00649 |
| Filled | −1.78 | 47.0 | 4.19 | 0.501 | 0.443 | 0.478 | 0.277 | 0.0830 | 0.0160 | 0.00254 | 0.000648 |
| (%) | −2.33 | 47.0 | 4.02 | 0.253 | 0.127 | 0.132 | 0.0796 | 0.0240 | 0.00414 | 0.000648 | 0.000199 |
| | −2.89 | 47.0 | 4.04 | 0.198 | 0.0402 | 0.0342 | 0.0222 | 0.00723 | 0.00102 | <1.00E−04 | <1.00E−04 |
| | −3.44 | 46.9 | 3.97 | 0.187 | 0.0133 | 0.0104 | 0.00566 | 0.00194 | 0.000299 | <1.00E−04 | <1.00E−04 |
| | −4.00 | 47.0 | 4.01 | 0.173 | 0.00807 | 0.00294 | 0.00145 | 0.000524 | <1.00E−04 | <1.00E−04 | <1.00E−04 |

Stage 2 Failure Probability (%)
Composite RSD = 6%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 67.5 | 75.2 | 86.4 | 90.2 | 58.4 | 53.1 | 58.2 | 43.2 | 19.5 | 15.0 |
| Error | 0.44 | 29.2 | 32.6 | 42.6 | 39.5 | 7.70 | 4.47 | 4.95 | 3.01 | 0.708 | 0.259 |
| Probability | −0.11 | 9.42 | 10.5 | 14.2 | 10.7 | 1.09 | 0.267 | 0.293 | 0.175 | 0.0379 | 0.00653 |
| Per | −0.67 | 2.80 | 3.05 | 4.17 | 2.83 | 0.235 | 0.0179 | 0.0202 | 0.0149 | 0.00297 | 0.000432 |
| Mini-tablet | −1.22 | 0.814 | 0.854 | 1.19 | 0.762 | 0.0612 | 0.00227 | 0.00168 | 0.000927 | 0.000184 | <1.00E−04 |
| Filled | −1.78 | 0.262 | 0.232 | 0.329 | 0.208 | 0.0175 | 0.000299 | 0.000120 | <1.00E−04 | <1.00E−04 | <1.00E−04 |
| (%) | −2.33 | 0.113 | 0.0684 | 0.0885 | 0.0599 | 0.00465 | 0.000153 | <1.00E−04 | <1.00E−04 | <1.00E−04 | <1.00E−04 |
| | −2.89 | 0.0650 | 0.0204 | 0.0271 | 0.0174 | 0.00119 | <1.00E−04 | <1.00E−04 | <1.00E−04 | <1.00E−04 | <1.00E−04 |
| | −3.44 | 0.0604 | 0.00613 | 0.00801 | 0.00475 | 0.000342 | <1.00E−04 | <1.00E−04 | <1.00E−04 | <1.00E−04 | <1.00E−04 |
| | −4.00 | 0.0494 | 0.00129 | 0.00178 | 0.000927 | 0.000109 | <1.00E−04 | <1.00E−04 | <1.00E−04 | <1.00E−04 | <1.00E−04 |

Stage 1 Acceptance Value (%)
Composite RSD = 6%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 55 | 43 | 36 | 32 | 29 | 26 | 25 | 23 | 22 | 21 |
| Error | 0.44 | 27 | 22 | 18 | 16 | 15 | 14 | 13 | 12 | 12 | 11 |
| Probability | −0.11 | 18 | 14 | 12 | 10 | 9.4 | 8.7 | 8.2 | 7.7 | 7.3 | 7.0 |
| Per | −0.67 | 16 | 11 | 9.5 | 8.4 | 7.6 | 7 | 6.5 | 6.1 | 5.8 | 5.5 |
| Mini-tablet | −1.22 | 15 | 11 | 8.9 | 7.8 | 7 | 6.5 | 6 | 5.6 | 5.3 | 5.1 |
| Filled | −1.78 | 15 | 11 | 8.8 | 7.6 | 6.9 | 6.3 | 5.9 | 5.5 | 5.2 | 4.9 |
| (%) | −2.33 | 15 | 11 | 8.7 | 7.6 | 6.8 | 6.3 | 5.8 | 5.5 | 5.2 | 4.9 |
| | −2.89 | 15 | 11 | 8.7 | 7.6 | 6.8 | 6.3 | 5.8 | 5.5 | 5.2 | 4.9 |
| | −3.44 | 15 | 11 | 8.7 | 7.6 | 6.8 | 6.3 | 5.8 | 5.4 | 5.1 | 4.9 |
| | −4.00 | 15 | 11 | 8.7 | 7.6 | 6.8 | 6.3 | 5.8 | 5.4 | 5.1 | 4.9 |

Stage 2 Acceptance Value (%)
Composite RSD = 6%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 52 | 38 | 31 | 27 | 24 | 22 | 21 | 19 | 18 | 17 |
| Error | 0.44 | 26 | 20 | 17 | 15 | 13 | 12 | 12 | 11 | 10 | 9.8 |
| Probability | −0.11 | 17 | 12 | 10 | 9.3 | 8.4 | 7.8 | 7.2 | 6.8 | 6.4 | 6.1 |
| Per | −0.67 | 14 | 10 | 8.3 | 7.2 | 6.5 | 6 | 5.6 | 5.2 | 4.9 | 4.7 |
| Mini-tablet | −1.22 | 13 | 9.2 | 7.6 | 6.6 | 5.9 | 5.4 | 5 | 4.7 | 4.5 | 4.2 |
| Filled | −1.78 | 13 | 9.0 | 7.4 | 6.4 | 5.8 | 5.3 | 4.9 | 4.6 | 4.3 | 4.1 |
| (%) | −2.33 | 13 | 9.0 | 7.4 | 6.4 | 5.7 | 5.2 | 4.8 | 4.5 | 4.3 | 4.1 |
| | −2.89 | 13 | 9.0 | 7.4 | 6.4 | 5.7 | 5.2 | 4.8 | 4.5 | 4.3 | 4.0 |
| | −3.44 | 13 | 9.0 | 7.3 | 6.4 | 5.7 | 5.2 | 4.8 | 4.5 | 4.3 | 4.0 |
| | −4.00 | 13 | 9.0 | 7.3 | 6.4 | 5.7 | 5.2 | 4.8 | 4.5 | 4.3 | 4.0 |

Stage 1 Failure Probability (%)
Composite RSD = 8%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 92.7 | 83.6 | 87.6 | 92.6 | 94.1 | 93.3 | 92.1 | 90.4 | 88.0 | 85.0 |
| Error | 0.44 | 88.1 | 56.5 | 48.2 | 52.7 | 55.7 | 50.6 | 42.4 | 35.0 | 28.3 | 22.5 |
| Probability | −0.11 | 86.3 | 43.0 | 22.6 | 20.0 | 20.5 | 17.0 | 11.3 | 6.80 | 4.02 | 2.40 |
| Per | −0.67 | 85.8 | 38.7 | 13.3 | 7.31 | 6.44 | 4.98 | 2.89 | 1.35 | 0.575 | 0.250 |
| Mini-tablet | −1.22 | 85.6 | 37.4 | 10.7 | 3.45 | 2.07 | 1.43 | 0.783 | 0.330 | 0.119 | 0.0393 |
| Filled | −1.78 | 85.6 | 36.9 | 9.83 | 2.33 | 0.802 | 0.446 | 0.219 | 0.086 | 0.0284 | 0.00718 |
| (%) | −2.33 | 85.6 | 36.9 | 9.62 | 2.00 | 0.448 | 0.160 | 0.0675 | 0.0257 | 0.00777 | 0.00189 |
| | −2.89 | 85.6 | 36.8 | 9.65 | 1.94 | 0.346 | 0.0794 | 0.0236 | 0.00733 | 0.00212 | 0.000673 |
| | −3.44 | 85.6 | 36.8 | 9.57 | 1.92 | 0.334 | 0.0573 | 0.0114 | 0.00309 | 0.000798 | 0.000175 |
| | −4.00 | 85.6 | 36.8 | 9.62 | 1.89 | 0.322 | 0.0500 | 0.00815 | 0.00157 | 0.000224 | 0.000199 |

Stage 2 Failure Probability (%)
Composite RSD = 8%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 82.5 | 83 | 87.6 | 90.5 | 68.6 | 55.6 | 56.7 | 44.8 | 25.4 | 16.9 |
| Error | 0.44 | 41.6 | 44.4 | 45.7 | 40.5 | 14.2 | 5.56 | 5.1 | 3.32 | 1.23 | 0.426 |
| Proba- | −0.11 | 16.6 | 16 | 16 | 11 | 2.58 | 0.453 | 0.288 | 0.197 | 0.0642 | 0.0171 |
| bility | −0.67 | 7.8 | 4.84 | 4.75 | 2.91 | 0.579 | 0.0714 | 0.0207 | 0.0138 | 0.00673 | 0.00138 |
| Per | −1.22 | 5.27 | 1.39 | 1.36 | 0.788 | 0.157 | 0.0135 | 0.00237 | 0.00086 | 0.000646 | <1.00E−04 |
| Mini- | −1.78 | 4.48 | 0.403 | 0.391 | 0.22 | 0.0409 | 0.00396 | 0.000288 | <1.00E−04 | <1.00E−04 | <1.00E−04 |
| tablet | −2.33 | 4.3 | 0.119 | 0.106 | 0.0544 | 0.0114 | 0.000696 | <1.00E−04 | <1.00E−04 | <1.00E−04 | <1.00E−04 |
| Filled | −2.89 | 4.21 | 0.0474 | 0.0276 | 0.0178 | 0.00425 | 0.000239 | <1.00E−04 | <1.00E−04 | <1.00E−04 | <1.00E−04 |
| (%) | −3.44 | 4.21 | 0.0218 | 0.00752 | 0.00425 | 0.00148 | <1.00E−04 | <1.00E−04 | <1.00E−04 | <1.00E−04 | <1.00E−04 |
| | −4.00 | 4.19 | 0.0166 | 0.00218 | 0.000927 | 0.000218 | <1.00E−04 | <1.00E−04 | <1.00E−04 | <1.00E−04 | <1.00E−04 |

Stage 1 Acceptance Value (%)
Composite RSD = 8%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 58 | 45 | 37 | 33 | 29 | 27 | 25 | 23 | 22 | 21 |
| Error | 0.44 | 32 | 24 | 20 | 18 | 16 | 15 | 14 | 13 | 13 | 12 |
| Probability | −0.11 | 23 | 17 | 14 | 12 | 11 | 10 | 9.7 | 9.1 | 8.7 | 8.3 |
| Per | −0.67 | 21 | 15 | 12 | 11 | 9.6 | 8.8 | 8.2 | 7.7 | 7.3 | 7.0 |
| Mini-tablet | −1.22 | 20 | 14 | 12 | 10 | 9.2 | 8.4 | 7.8 | 7.3 | 6.9 | 6.6 |
| Filled | −1.78 | 20 | 14 | 12 | 10 | 9.0 | 8.3 | 7.7 | 7.2 | 6.8 | 6.5 |
| (%) | −2.33 | 20 | 14 | 12 | 10 | 9.0 | 8.2 | 7.7 | 7.2 | 6.8 | 6.5 |
| | −2.89 | 20 | 14 | 11 | 10 | 9.0 | 8.2 | 7.6 | 7.2 | 6.8 | 6.5 |
| | −3.44 | 20 | 14 | 11 | 10 | 9.0 | 8.2 | 7.6 | 7.2 | 6.8 | 6.5 |
| | −4.00 | 20 | 14 | 11 | 10 | 9.0 | 8.2 | 7.6 | 7.2 | 6.8 | 6.5 |

Stage 2 Acceptance Value (%)
Composite RSD = 8%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 54 | 39 | 32 | 28 | 25 | 23 | 21 | 20 | 19 | 18 |
| Error | 0.44 | 29 | 22 | 18 | 16 | 14 | 13 | 12 | 12 | 11 | 10 |
| Probability | −0.11 | 20 | 15 | 12 | 11 | 9.8 | 9.0 | 8.4 | 7.9 | 7.5 | 7.1 |
| Per | −0.67 | 18 | 13 | 11 | 9.2 | 8.3 | 7.6 | 7.0 | 6.6 | 6.2 | 5.9 |
| Mini-tablet | −1.22 | 17 | 12 | 9.9 | 8.7 | 7.8 | 7.1 | 6.6 | 6.2 | 5.8 | 5.5 |
| Filled | −1.78 | 17 | 12 | 9.8 | 8.5 | 7.6 | 7 | 6.5 | 6.1 | 5.7 | 5.4 |
| (%) | −2.33 | 17 | 12 | 9.7 | 8.5 | 7.6 | 6.9 | 6.4 | 6.0 | 5.7 | 5.4 |
| | −2.89 | 17 | 12 | 9.7 | 8.5 | 7.6 | 6.9 | 6.4 | 6.0 | 5.7 | 5.4 |
| | −3.44 | 17 | 12 | 9.7 | 8.5 | 7.6 | 6.9 | 6.4 | 6.0 | 5.7 | 5.4 |
| | −4.00 | 17 | 12 | 9.7 | 8.5 | 7.6 | 6.9 | 6.4 | 6.0 | 5.7 | 5.4 |

Stage 1 Failure Probability (%)
Composite RSD = 10%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 98.3 | 92.9 | 91.8 | 93.7 | 94.9 | 94.5 | 93.4 | 91.9 | 89.7 | 87.2 |
| Error | 0.44 | 97.2 | 81.1 | 65.8 | 60.5 | 59.4 | 55.9 | 49.7 | 42.4 | 35.3 | 29.1 |
| Probability | −0.11 | 96.8 | 75.2 | 48.9 | 33.1 | 26.3 | 21.5 | 16.4 | 11.5 | 7.59 | 4.88 |
| Per | −0.67 | 96.6 | 73.2 | 42.8 | 22.7 | 12.9 | 8.17 | 5.22 | 3.14 | 1.74 | 0.918 |
| Mini-tablet | −1.22 | 96.6 | 72.7 | 41.0 | 19.4 | 8.71 | 4.11 | 2.07 | 1.04 | 0.498 | 0.228 |
| Filled | −1.78 | 96.6 | 72.5 | 40.6 | 18.5 | 7.52 | 2.96 | 1.17 | 0.469 | 0.191 | 0.0772 |
| (%) | −2.33 | 96.6 | 72.5 | 40.3 | 18.2 | 7.18 | 2.59 | 0.908 | 0.313 | 0.108 | 0.037 |
| | −2.89 | 96.6 | 72.5 | 40.3 | 18.2 | 7.09 | 2.49 | 0.843 | 0.269 | 0.0827 | 0.0272 |
| | −3.44 | 96.6 | 72.4 | 40.3 | 18.1 | 7.05 | 2.48 | 0.821 | 0.264 | 0.0781 | 0.0230 |
| | −4.00 | 96.6 | 72.4 | 40.3 | 18.1 | 7.05 | 2.49 | 0.814 | 0.256 | 0.0766 | 0.0228 |

Stage 2 Failure Probability (%)
Composite RSD = 10%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 89.8 | 91.7 | 91.6 | 91.7 | 76.8 | 60.4 | 56.5 | 46.1 | 30.4 | 20.4 |
| Error | 0.44 | 58.9 | 57.6 | 56.5 | 44.7 | 21.0 | 8.25 | 5.62 | 3.69 | 1.79 | 0.746 |
| Probability | −0.11 | 39.4 | 22.6 | 22.0 | 13.4 | 4.42 | 1.03 | 0.396 | 0.224 | 0.0996 | 0.0346 |
| Per | −0.67 | 32.4 | 7.54 | 6.85 | 3.74 | 1.04 | 0.197 | 0.0470 | 0.0191 | 0.00732 | 0.00287 |
| Mini-tablet | −1.22 | 30.4 | 2.75 | 1.99 | 1.02 | 0.268 | 0.0500 | 0.00791 | 0.00178 | 0.000796 | 0.000266 |
| Filled | −1.78 | 29.7 | 1.40 | 0.576 | 0.293 | 0.0788 | 0.0119 | 0.00188 | 0.000288 | <1.00E−04 | <1.00E−04 |
| (%) | −2.33 | 29.6 | 1.04 | 0.174 | 0.0813 | 0.0193 | 0.00336 | 0.000746 | <1.00E−04 | <1.00E−04 | <1.00E−04 |
| | −2.89 | 29.7 | 0.913 | 0.0592 | 0.0220 | 0.00554 | 0.000993 | 0.000160 | <1.00E−04 | <1.00E−04 | <1.00E−04 |
| | −3.44 | 29.5 | 0.876 | 0.0382 | 0.00910 | 0.00148 | 0.000324 | <1.00E−04 | <1.00E−04 | <1.00E−04 | <1.00E−04 |
| | −4.00 | 29.6 | 0.863 | 0.0255 | 0.00148 | 0.000427 | 0.000133 | <1.00E−04 | <1.00E−04 | <1.00E−04 | <1.00E−04 |

Stage 1 Acceptance Value (%)
Composite RSD = 10%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 61 | 46 | 39 | 34 | 30 | 28 | 26 | 24 | 23 | 22 |
| Error | 0.44 | 36 | 27 | 23 | 20 | 18 | 16 | 15 | 14 | 14 | 13 |
| Probability | −0.11 | 28 | 20 | 17 | 15 | 13 | 12 | 11 | 11 | 10 | 9.6 |
| Per | −0.67 | 26 | 18 | 15 | 13 | 12 | 11 | 10 | 9.4 | 8.9 | 8.4 |
| Mini-tablet | −1.22 | 25 | 18 | 15 | 13 | 11 | 10 | 9.6 | 9.0 | 8.5 | 8.1 |
| Filled | −1.78 | 25 | 18 | 14 | 12 | 11 | 10 | 9.5 | 8.9 | 8.4 | 8.0 |
| (%) | −2.33 | 25 | 18 | 14 | 12 | 11 | 10 | 9.5 | 8.9 | 8.4 | 8.0 |
| | −2.89 | 25 | 18 | 14 | 12 | 11 | 10 | 9.5 | 8.9 | 8.4 | 8.0 |
| | −3.44 | 25 | 18 | 14 | 12 | 11 | 10 | 9.5 | 8.9 | 8.4 | 8.0 |
| | −4.00 | 25 | 18 | 14 | 12 | 11 | 10 | 9.5 | 8.9 | 8.4 | 8.0 |

Stage 2 Acceptance Value (%)
Composite RSD = 10%

| | | Fill Count | | | | | | | | | |
|---|---|---|---|---|---|---|---|---|---|---|---|
| | | 1 | 2 | 3 | 4 | 5 | 6 | 7 | 8 | 9 | 10 |
| Log Fill | 1.00 | 55 | 40 | 33 | 28 | 25 | 23 | 22 | 20 | 19 | 18 |
| Error | 0.44 | 32 | 24 | 20 | 17 | 15 | 14 | 13 | 12 | 12 | 11 |
| Probability | −0.11 | 24 | 17 | 14 | 13 | 11 | 10 | 9.7 | 9.1 | 8.6 | 8.2 |
| Per | −0.67 | 22 | 15 | 13 | 11 | 10 | 9.1 | 8.5 | 8.0 | 7.5 | 7.1 |
| Mini-tablet | −1.22 | 21 | 15 | 12 | 11 | 9.6 | 8.8 | 8.1 | 7.6 | 7.2 | 6.8 |
| Filled | −1.78 | 21 | 15 | 12 | 11 | 9.5 | 8.7 | 8.0 | 7.5 | 7.1 | 6.8 |
| (%) | −2.33 | 21 | 15 | 12 | 11 | 9.4 | 8.6 | 8.0 | 7.5 | 7.1 | 6.7 |
| | −2.89 | 21 | 15 | 12 | 10 | 9.4 | 8.6 | 8.0 | 7.5 | 7.1 | 6.7 |
| | −3.44 | 21 | 15 | 12 | 10 | 9.4 | 8.6 | 8.0 | 7.5 | 7.1 | 6.7 |
| | −4.00 | 21 | 15 | 12 | 10 | 9.4 | 8.6 | 8.0 | 7.5 | 7.1 | 6.7 |

### Optional Dose Error Rate Feature

As described above, embodiments of the present invention calculate and use the probability of content uniformity failure to automatically adjust operating parameters of mini-tablet manufacturing machines, such as mini-tablet presses and mini-tablet sachet filling machines. In addition to those features, however, embodiments of the present invention also may be adapted to calculate and use the probability that a patient receives a defective drug product containing too little or too much drug content in order to adjust the operating parameters of mini-tablet manufacturing machines. These adjusted may be made automatically when the controller application determines that the expected error rates of drug doses exceed a specified maximum acceptable dose error rate and magnitude.

For example, suppose it is known that if a mini-tablet is missing 25% of the intended drug dose, a patient taking that mini-tablet would not be protected from their condition. Under these circumstances, there is a considerable need for a apparatus and method for preventing the patient from receiving the defective mini-tablet. Beneficially, embodiments of the present invention may be adapted to calculate the probability that mini-tablets in a batch of mini-tablets will be defective in this way. Armed with this information about the probability of failing a regulatory standard based on dose errors in the sachets of mini-tablets, a manufacturer can use the present invention to dial in their machine settings to minimize the risk of a 25% defect.

The algorithms performed by an embodiment of the present invention that calculates the probability that a batch would have unacceptably high dose errors are substantially the same as the algorithms performed by embodiments described above with reference to FIGS. 4-7, with two important exceptions. First, the input values received by the controller application program would include, among other things, a two-dimensional array of numbers indicating the maximum acceptable percentage and magnitude of such dose errors. Second, the multi-dimensional matrix built by the controller application (or a subroutine thereof) typically has many more dimensions than the 5D matrix built and searched in the examples described above. Indeed, the controller application is capable of generating a matrix with an infinite number of columns and rows, depending on the ranges and intervals for the selected by the user for the matrix. For ease of reference the matrix created and searched in this embodiment is hereinafter referred to as an “N-dimensional” or “ND” matrix.

The following scenario illustrates the utility and benefits of using the probabilities dose errors, in addition to using the probability of failing the USP <905> content uniformity testing standard, to set and control the operating parameters of a mini-tablet manufacturing machine. Suppose, for example, a user would like to ensure a sufficiently low incidence of 1) content uniformity failure according to USP <905>, 2) sachets with assay error greater than 10%, and 3) sachets with assay error greater than 25% during manufacturing of a batch of mini-tablets on a sachet filling machine. Because the consequences for each of these three potential failures have different severities, a user might wish to simultaneously exercise some control over their respective probabilities of occurrence. For example, since a 25% dose error is more impactful to a patient's health and safety than is a 10% dose error, which is more impactful than a USP <905> failure, the user may wish for the algorithm to keep the probabilities of occurrence for these three failures below 0.0001%, 0.01%, and 0.1%, respectively.

In cases where a user wishes to specify constraints for multiple outcomes such as in the aforementioned scenario, the user must specify which probability constraint the algorithm should prioritize to avoid the possibility that all constraints may not be met within a single row of the N-dimensional matrix created by the matrix generator. Accordingly, in some embodiments of the present invention, users may rank-order the probability constraints by preference such that the algorithm searches the rows of the N-D matrix to find the subset of rows which satisfy the top rank ordered constraint, followed then by searching for subset of rows to find a second subset (within the first subset) which satisfy both the first and second constraint, and so on. In this way, the algorithm seeks to find parameters for controlling the equipment which satisfy the constraints in order of the user-determined prioritization.

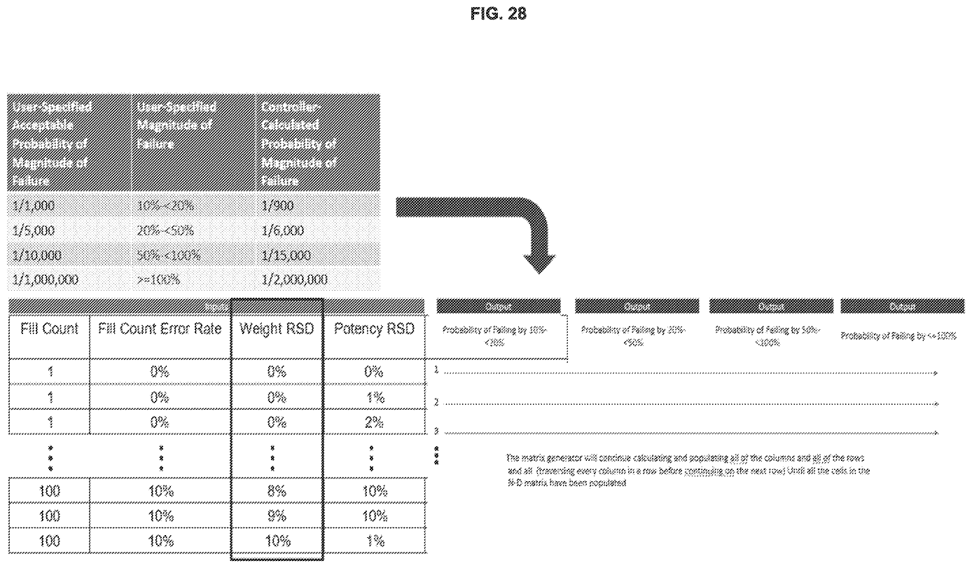

FIG. 28 contains a table illustrating, by way of example, the inputs and outputs for an N-dimensional matrix generator according to an embodiment of the invention configured to calculate and use the probabilities of occurrence for a list of specified dose error rates and specified dose error magnitudes. As shown in FIG. 28, a user can, for example, specify any maximum probability (risk) of failing a regulatory testing standard (e.g., a 1 in 1000 chance, a 1 in 5000 chance, a 1 in 10,000 chance, a 1 in 1,000,000 chance, etc.) for a batch of mini-tablets, as well as a magnitude of failure for each one of those probabilities (e.g., 10%, 20%, 50%, 100%, etc.), and embodiments of the present invention builds an N-D matrix by calculating the probability of failure for each and every one of the specified tuples of maximum acceptable probability and magnitude. The reason it is possible for the matrix in this embodiment to have an infinite number of columns (limited only on available computing power) is because the user may specify an infinite number of input pairings (where a “pairing” comprises an acceptable probability of failure vs. the magnitude of the failure).

The above-described embodiments are intended to illustrate the principles of the invention, but not to limit its scope. Various other embodiments, modifications and equivalents to these preferred embodiments may occur to those skilled in the art upon reading the present disclosure or practicing the claimed invention. Such variations, modifications and equivalents are intended to come within the scope of the invention.

What is claimed is:

1. A control apparatus for a mini-tablet pressing machine, comprising:
(a) a computer system comprising a microprocessor, a primary memory and a secondary memory storage area;
(b) a process equipment driver on the computer system, the process equipment driver being communicatively coupled to the mini-tablet pressing machine and the microprocessor, the process equipment driver being configured to send a signal to the mini-tablet pressing machine to change an operating parameter on the mini-tablet pressing machine;
(c) a mini-tablet measuring device communicatively connected to both the computer system and the mini-tablet pressing machine;
(d) a controller application in the primary memory of the computer system, the controller application comprising program instructions that, when executed by the microprocessor, will cause the microprocessor to
(i) import a set of input values, including a specified maximum acceptable failure probability for a batch of mini-tablets produced by the mini-tablet pressing machine,
(ii) calculate a target fill count and a target individual mini-tablet potency for the batch based on the input values,
(iii) activate the mini-tablet measuring device to measure and provide to the computer system a set of measured individual weights for the mini-tablets produced by the mini-tablet pressing machine,
(iv) use the set of measured individual weights to calculate a current mini-tablet weight RSD and a current mini-tablet mean weight,
(v) build in the secondary memory storage area a matrix of rows and values for a set of key variables, the set of key variables including a fill count, a fill count error rate, a weight RSD, a potency RSD and a probability of failing a regulatory specification, the matrix comprising a separate record for every possible combination of key variable values,
(vi) determine a system-recommended weight RSD for the batch by searching the matrix to identify a row having a probability of failing value that is closest to, but does not exceed, the value of the specified maximum acceptable failure probability, and designating the weight RSD value in that row as the system-recommended weight RSD,
(vii) compare the system-recommended weight RSD to the current weight RSD, and
(viii) activate the process equipment driver to cause the process equipment driver to send a signal to the mini-tablet pressing machine to change the operating parameter on the mini-tablet pressing machine based on a result of the comparison step.

2. The apparatus of claim 1, wherein the set of input values includes:
(a) a target drug dose;
(b) a target individual mini-tablet potency;
(c) a measured blend potency RSD;
(d) a measured blend potency;
(e) a predicted sachet filling error rate; and
(f) a maximum acceptable failure probability.

3. The apparatus of claim 1, wherein the operating parameter is:
(a) a compression depth setting; or
(b) a turret speed setting; or
(c) a feeder speed setting.

4. The apparatus of claim 1, wherein the mini-tablet measuring device is a scale or a balance.

5. The apparatus of claim 1, wherein:
(a) the secondary memory storage area stores an equipment profile defining a set of operating limits for the mini-tablet pressing machine; and
(b) the controller application further comprises programming instructions that, when executed by the microprocessor, will cause the microprocessor to
(i) compare the system-recommended weight RSD to an operating limit in the set of operating limits prior to activating the process equipment driver, and
(ii) activate the process equipment driver to send the signal to change the operating parameter on the mini-tablet pressing machine only if the change will permit the mini-tablet pressing machine to continue to operate within the operating limit.

6. The apparatus of claim 1, wherein the controller application further comprises program instructions that, when executed by the microprocessor, will cause the microprocessor to build the matrix in the secondary memory storage area by:
(a) importing or defining a set of ranges and a set of intervals for the set of key variables for the mini-tablets in the batch;
(b) creating a data structure in the secondary memory storage area;
(c) building in the secondary memory storage area a matrix of rows, each row comprising values for a set of key variables associated with the batch of mini-tablets, the set of key variables including a fill count, a fill count error rate, a weight RSD, a potency RSD and a probability of failing a regulatory testing standard, wherein the matrix includes a separate row of key variable values for every possible combination of key variable values;
(d) selecting a row of key variable values in the matrix;
(e) using a first Monte Carlo simulation on the values for the fill count, the fill count error rate, the weight RSD and the potency RSD to generate a random binomially distributed sachet fill count;
(f) using a second Monte Carlo simulation to generate a random normally distributed weight value and potency value for each random binomially distributed sachet fill count;
(g) producing an assay for a sachet in the batch by calculating the sum of the product of the weight and potency of every mini-tablet in the sachet;
(h) invoking a regulatory testing subroutine to determine a pass or fail condition for a specified subset of the sachets in the batch in accordance with the regulatory testing standard;
(i) determining the probability of failing the regulatory testing standard for the batch based on the pass or fail condition of the subset of sachets; and
(j) storing the probability of failing in the selected row of the matrix; and
(k) repeating steps (d) through (j) above for each row in the matrix until all of the rows in the matrix includes a value for the probability of failure.

7. A method for controlling a mini-tablet pressing machine, comprising:
(a) providing a computer system comprising a microprocessor, a primary memory and a secondary memory storage area;
(b) providing a process equipment driver on the computer system, the process equipment driver being communicatively coupled to the mini-tablet pressing machine and the microprocessor, the process equipment driver being configured to send a signal to the mini-tablet pressing machine to change an operating parameter on the mini-tablet pressing machine;
(c) connecting a mini-tablet measuring device to both the computer system and the mini-tablet pressing machine;
(d) importing into the primary memory a set of input values, including a specified maximum acceptable failure probability for a batch of mini-tablets produced by the mini-tablet pressing machine;
(e) using the microprocessor to calculate a target fill count and a target individual mini-tablet potency for the batch based on the input values;
(f) using the microprocessor to activate the mini-tablet measuring device to measure and provide to the computer system a set of measured individual weights for the mini-tablets produced by the mini-tablet pressing machine;
(g) with the microprocessor, using the set of measured individual weights to calculate a current mini-tablet weight RSD and a current mini-tablet mean weight;
(h) with the microprocessor, building in the secondary memory storage area a matrix of rows, each row comprising values for a set of key variables associated with the batch of mini-tablets, the set of key variables including a fill count, a fill count error rate, a weight RSD, a potency RSD and a probability of failing a regulatory specification, wherein the matrix includes a separate row of key variable values for every possible combination of key variable values;
(i) determining with the microprocessor a system-recommended weight RSD for the batch by searching the matrix to identify a row having a probability of failing value that is closest to, but does not exceed, the value of the specified maximum acceptable failure probability, and designating the weight RSD value in that row as the system-recommended weight RSD;
(j) with the microprocessor, comparing the system-recommended weight RSD to the current weight RSD; and
(k) causing the microprocessor to activate the process equipment driver to cause the process equipment driver to send a signal to the mini-tablet pressing machine to change the operating parameter on the mini-tablet pressing machine based on a result of the comparison step.

8. The method of claim 7, wherein the set of input values includes:
(a) a target drug dose;
(b) a target individual mini-tablet potency;
(c) a measured blend potency RSD;
(d) a measured blend potency;
(e) a predicted sachet filling error rate; and
(f) a maximum acceptable failure probability.

9. The method of claim 7, wherein the operating parameter is:
(a) a compression depth setting; or
(b) a turret speed setting; or
(c) a feeder speed setting.

10. The method of claim 7, wherein the mini-tablet measuring device is a scale or a balance.

11. The method of claim 7, wherein:
(a) the secondary memory storage area stores an equipment profile defining a set of operating limits for the mini-tablet pressing machine;
(b) with the microprocessor, comparing the system-recommended weight RSD to an operating limit in the set of operating limits prior to activating the process equipment driver; and
(c) with the microprocessor, activating the process equipment driver to send the signal to change the operating parameter on the mini-tablet pressing machine only if the change will permit the mini-tablet pressing machine to continue to operate within the operating limit.

12. The method of claim 1, further comprising:
(a) importing into or defining within the primary memory a set of ranges and a set of intervals for the set of key variables for the mini-tablets in the batch;
(b) with the microprocessor, creating a data structure in the secondary memory storage area;
(c) with the microprocessor, building in the secondary memory storage area a matrix of rows, each row comprising values for a set of key variables associated with the batch of mini-tablets, the set of key variables including a fill count, a fill count error rate, a weight RSD, a potency RSD and a probability of failing a regulatory testing standard, wherein the matrix includes a separate row of key variable values for every possible combination of key variable values;
(d) selecting a row in the matrix;
(e) with the microprocessor, running a first Monte Carlo simulation on the values for the fill count, the fill count error rate, the weight RSD and the potency RSD to generate a random binomially distributed sachet fill count;
(f) with the microprocessor, running a second Monte Carlo simulation to generate a random normally distributed weight value and potency value for each random binomially distributed sachet fill count;
(g) producing an assay for a sachet in the batch by calculating the sum of the product of the weight and potency of every mini-tablet in the sachet;
(h) executing a regulatory testing subroutine with the microprocessor, the regulatory testing subroutine comprising program instructions that, when executed by the microprocessor, will cause the microprocessor to determine a pass or fail condition for a specified subset of the sachets in the batch in accordance with the regulatory testing standard;
(i) with the microprocessor, determining the probability of failing the regulatory testing standard based on the pass or fail condition of the subset of sachets; and
(j) storing the probability of failing in the selected row of the matrix; and
(k) repeating steps (d) through (j) above for each row in the matrix until all of the rows in the matrix includes a value for the probability of failure.

13. A control apparatus for a mini-tablet sachet filling machine, comprising:
(a) a computer system comprising a microprocessor, a primary memory and a secondary memory storage area;
(b) a process equipment driver on the computer system, the process equipment driver being communicatively coupled to the mini-tablet sachet filling machine and the microprocessor, the process equipment driver being configured to send a signal to the mini-tablet sachet filling machine to change an operating parameter on the mini-tablet sachet filling machine;
(c) a mini-tablet measuring device communicatively connected to both the computer system and the mini-tablet sachet filling machine;
(d) a controller application in the primary memory of the computer system, the controller application comprising program instructions that, when executed by the microprocessor, will cause the microprocessor to
(i) import a set of input values, including a specified maximum acceptable failure probability for a batch of mini-tablets produced by the mini-tablet sachet filling machine,
(ii) calculate a target fill count and a target individual mini-tablet potency for the batch based on the input values,
(iii) activate the mini-tablet measuring device to measure and provide to the computer system a set of measured individual weights, mean weights and fill errors for the mini-tablets produced by the mini-tablet sachet filling machine,
(iv) use the set of measured individual weights to calculate a current mini-tablet weight RSD, a current mini-tablet mean weight and a sachet fill error rate,
(v) build in the secondary memory storage area a matrix of rows and values for a set of key variables, the set of key variables including a fill count, a fill count error rate, a weight RSD, a potency RSD and a probability of failing a regulatory specification, the matrix comprising a separate row for every possible combination of key variable values,
(vi) determine a system-recommended sachet fill error rate and system-recommended fill count for the batch by searching the matrix to identify a row having a probability of failing value that is closest to, but does not exceed, the value of the specified maximum acceptable failure probability, and designating the weight RSD value in that row as the system-recommended weight RSD,
(vii) compare the system-recommended sachet fill error rate and the system-recommended fill count to the measured sachet fill error rate and the target fill count, respectively, and
(viii) activate the process equipment driver to cause the process equipment driver to send a signal to the mini-tablet sachet filling machine to change the operating parameter on the mini-tablet sachet filling machine based on a result of the comparison step.

14. The apparatus of claim 13, wherein the set of input values includes:
(a) a target drug dose;
(b) a target individual mini-tablet potency;
(c) a measured blend potency RSD;
(d) a measured blend potency;
(e) a measured sachet filling error rate; and
(f) a maximum acceptable failure probability.

15. The apparatus of claim 1, wherein the operating parameter is:
(a) a fill count setting; or
(b) a filling speed setting.

16. The apparatus of claim 13, wherein the mini-tablet measuring device is an x-ray machine or a balance.

17. The apparatus of claim 13, wherein:
(a) the secondary memory storage area stores an equipment profile defining a set of operating limits for the mini-tablet sachet filling machine; and
(b) the controller application further comprises programming instructions that, when executed by the microprocessor, will cause the microprocessor to
(i) compare the system-recommended weight RSD to an operating limit in the set of operating limits prior to activating the process equipment driver, and
(ii) activate the process equipment driver to send the signal to change the operating parameter on the mini-tablet sachet filling machine only if the change will permit the mini-tablet sachet filling machine to continue to operate within the operating limit.

18. The apparatus of claim 13, wherein the controller application further comprises program instructions that, when executed by the microprocessor, will cause the microprocessor to build the matrix in the secondary memory storage area by:
(a) importing or defining a set of ranges and a set of intervals for the set of key variables for the mini-tablets in the batch;
(b) creating a data structure in the secondary memory storage area;
(c) building in the secondary memory storage area a matrix of rows and values, each row comprising values for a set of key variables associated with the batch of mini-tablets, the set of key variables including a fill count, a fill count error rate, a weight RSD, a potency RSD and a probability of failing a regulatory testing standard, wherein the matrix includes a separate row of key variable values for every possible combination of key variable values;
(d) selecting a row of key variable values in the matrix;
(e) using a first Monte Carlo simulation on the values for the fill count, the fill count error rate, the weight RSD and the potency RSD to generate a random binomially distributed sachet fill count;
(f) using a second Monte Carlo simulation to generate a random normally distributed weight value and potency value for each random binomially distributed sachet fill count;
(g) producing an assay for a sachet in the batch by calculating the sum of the product of the weight and potency of every mini-tablet in the sachet;
(h) invoking a regulatory testing subroutine to determine a pass or fail condition for a specified subset of the sachets in the batch in accordance with the regulatory testing standard;
(i) determining the probability of failing the regulatory testing standard for the batch based on the pass or fail condition of the subset of sachets; and
(j) storing the probability of failing in the selected row of the matrix; and
(k) repeating steps (d) through (j) above for each row in the matrix until all of the rows in the matrix includes a value for the probability of failure.

19. A method for controlling a mini-tablet sachet filling machine, comprising:
(a) providing a computer system comprising a microprocessor, a primary memory and a secondary memory storage area;
(b) providing a process equipment driver on the computer system, the process equipment driver being communicatively coupled to the mini-tablet sachet filling machine and the microprocessor, the process equipment driver being configured to send a signal to the mini-tablet sachet filling machine to change an operating parameter on the mini-tablet sachet filling machine;
(c) connecting a mini-tablet measuring device to both the computer system and the mini-tablet sachet filling machine;
(d) importing into the primary memory a set of input values, including a specified maximum acceptable failure probability for a batch of mini-tablets produced by the mini-tablet sachet filling machine;
(e) using the microprocessor to calculate a target fill count and a target individual mini-tablet potency for the batch based on the input values;
(f) using the microprocessor to activate the mini-tablet measuring device to measure and provide to the computer system a set of measured individual weights, mean weights and fill errors for the mini-tablets produced by the mini-tablet sachet filling machine;
(g) with the microprocessor, using the set of measured individual weights to calculate a current mini-tablet weight RSD, a current mini-tablet mean weight and a sachet fill error rate;
(h) with the microprocessor, building in the secondary memory storage area a matrix of rows and values, each row comprising values for a set of key variables associated with the batch of mini-tablets, the set of key variables including a fill count, a fill count error rate, a weight RSD, a potency RSD and a probability of failing a regulatory specification, wherein the matrix includes a separate row of key variable values for every possible combination of key variable values;
(i) determining with the microprocessor a system-recommended sachet fill error rate and system-recommended fill count for the batch by searching the matrix to identify a row having a probability of failing value that is closest to, but does not exceed, the value of the specified maximum acceptable failure probability, and designating the weight RSD value in that row as the system-recommended weight RSD;
(j) with the microprocessor, comparing the system-recommended sachet fill error rate and the system-recommended fill count to the measured sachet fill error rate and the target fill count, respectively; and
(k) causing the microprocessor to activate the process equipment driver to cause the process equipment driver to send a signal to the mini-tablet sachet filling machine to change the operating parameter on the mini-tablet sachet filling machine based on a result of the comparison step.

20. The method of claim 19, wherein the set of input values includes:
(a) a target drug dose;
(b) a target individual mini-tablet potency;
(c) a measured blend potency RSD;
(d) a measured blend potency;
(e) a measured sachet filling error rate; and
(f) a maximum acceptable failure probability.

21. The method of claim 19, wherein the operating parameter is:
(a) a fill count setting; or
(b) a filling speed setting.

22. The method of claim 19, wherein the mini-tablet measuring device is a scale or a balance.

23. The method of claim 19, wherein:
(a) the secondary memory storage area stores an equipment profile defining a set of operating limits for the mini-tablet sachet filling machine;
(b) with the microprocessor, comparing the system-recommended weight RSD to an operating limit in the set of operating limits prior to activating the process equipment driver; and
(c) with the microprocessor, activating the process equipment driver to send the signal to change the operating parameter on the mini-tablet sachet filling machine only if the change will permit the mini-tablet sachet filling machine to continue to operate within the operating limit.

24. The method of claim 19, further comprising:
(a) importing into or defining within the primary memory a set of ranges and a set of intervals for the set of key variables for the mini-tablets in the batch;
(b) with the microprocessor, creating a data structure in the secondary memory storage area;
(c) with the microprocessor, building in the secondary memory storage area a matrix of rows and values, each row comprising values for a set of key variables associated with the batch of mini-tablets, the set of key variables including a fill count, a fill count error rate, a weight RSD, a potency RSD and a probability of failing a regulatory testing standard, wherein the matrix includes a separate row of key variable values for every possible combination of key variable values;
(d) selecting a row in the matrix;
(e) with the microprocessor, running a first Monte Carlo simulation on the values for the fill count, the fill count error rate, the weight RSD and the potency RSD to generate a random binomially distributed sachet fill count;
(f) with the microprocessor, running a second Monte Carlo simulation to generate a random normally distributed weight value and potency value for each random binomially distributed sachet fill count;
(g) producing an assay for a sachet in the batch by calculating the sum of the product of the weight and potency of every mini-tablet in the sachet;
(h) executing a regulatory testing subroutine with the microprocessor, the regulatory testing subroutine comprising program instructions that, when executed by the microprocessor, will cause the microprocessor to determine a pass or fail condition for a specified subset of the sachets in the batch in accordance with the regulatory testing standard;
(i) with the microprocessor, determining the probability of failing the regulatory testing standard based on the pass or fail condition of the subset of sachets; and
(j) storing the probability of failing in the selected row of the matrix; and
(k) repeating steps (d) through (j) above for each row in the matrix until all of the rows in the matrix includes a value for the probability of failure.
